(19) United States
(12) Patent Application Publication
(10) Pub. No.: US 2025/0321361 A1
(43) Pub. Date: Oct. 16, 2025

(54) STACKED BODY FOR DISPLAY DEVICE AND DISPLAY DEVICE

(71) Applicant: DAI NIPPON PRINTING CO., LTD., Tokyo (JP)

(72) Inventors: Jun SATO, Tokyo (JP); Saori KAWAGUCHI, Tokyo (JP); Kiyohiro TAKACHI, Tokyo (JP)

(21) Appl. No.: 18/552,797

(22) PCT Filed: Mar. 29, 2022
(86) PCT No.: PCT/JP2022/015494

§ 371 Date: Feb. 22, 2024

(30) Foreign Application Priority Data
Mar. 31, 2021 (JP) 2021-059576
Apr. 19, 2021 (JP) 2021-070288

(51) Int. Cl. G02B 1/115; G02B 1/14; G06F 1/16

(52) U.S. Cl. CPC G02B 1/115; G02B 1/14; G06F 1/1616; G06F 1/1652

(57) ABSTRACT

The present disclosure provides a stacked body for a display device comprising a substrate layer, a first layer, and a second layer, in this order; wherein a luminous reflectance of regular reflection light, when light is entered to a second layer side surface of the stacked body for a display device with incident angle of 60°, is 10.0% or less; and an absolute value of a difference, between yellowness YI1 of transmitted light in 60° direction with respect to a normal line to the second layer side surface of the stacked body for a display device and yellowness YI2 of transmitted light in 15° direction with respect to a normal line to the second layer side surface of the stacked body for a display device, is 3.0 or less.

### TECHNICAL FIELD

The present disclosure relates to a stacked body for a display device, and a display device using the same.

### BACKGROUND ART

For example, a stacked body provided with a functional layer having various properties such as a hard coating property, a scratch resistance, antireflection property, an antiglare property, an antistatic property, and an antifouling property, is placed on the surface of a display device.

Recently, flexible displays such as foldable displays, rollable displays, and bendable displays have been attracting attention, and the development of the stacked body placed on the surface of the flexible displays has been actively promoted.

Flexible displays are required that a display defect does not occur even if they are bent repeatedly, and bending resistance is required.

For a flexible display, for example, usage mode where an image is observed in a folded state, is assumed. For example, FIG. 3 is a schematic cross-sectional view illustrating an example of a usage mode of a foldable display. As shown in FIG. 3, in the usage mode where an image is observed with the foldable display 20 folded, the foldable display 20 will have the first display region 22 and the second display region 23 with the bent portion 21 on the boundary thereof. In this case, images and characters displayed in the second display region 23 may be reflected in the first display region 22, and images and characters displayed in the first display region 22 may be reflected in the second display region 23, resulting in a decrease in the visibility of images and characters. This is not limited to foldable displays, and the same problem occurs when an image is observed in a folded state of a flexible display.

Also, in the display device, there is a problem that the color of the image changes according to the observation direction. Also, as shown in FIG. 3, in the usage mode where an image is observed with the foldable display 20 folded, the observer 25 tends to observe the image displayed in the first display region 22 and the second display region 23 by moving only the line of sight without changing the observation position. In such a usage mode, the position of observer 25 is constant, as shown in FIG. 3, so the angle of the observation direction with respect to the normal line of the observer 25 side surface of the foldable display 20 is different between the first display region 22 and the second display region 23. Therefore, there is a problem that the color of the image differs between the first display region 22 and the second display region 23. This is not limited to foldable displays, and the same problem occurs when an image is observed in a folded state of a flexible display.

As a means to improve the visibility of flexible displays, for example, in order to solve the problem of reduced visibility due to interference fringes caused by a hard coating film, Patent Document 1 proposes a hard coating film comprising a substrate film and a hard coating layer stacked on at least one main surface of the substrate film; wherein the substrate film is a polyimide film; the difference between the refractive index of the polyimide film and the refractive index of the hard coating layer is 0.04 or less in absolute value; the thickness of the polyimide film is 5 μm or more and 50 μm or less; and the thickness of the hard coating layer is 0.5 μm or more and 10 μm or less.

Also, in a display device provided with an antireflection film, for example, in order to solve the problem that the visible color changes according to the viewing angle, Patent Document 2 proposes an antireflection film comprising a transparent substrate film and an antireflection layer formed on at least one side of the transparent substrate film; wherein the luminous reflectance relating to the regular reflection light of the antireflection film, when incident angle of 5° is 0.6% or less; the difference between the maximum value and the minimum value of the reflection (%) relating to the regular reflection light, in a wavelength range of 450 nm or more and 750 nm or less when incident angle of 5°, is 0.75 or less; and the difference between the maximum value and the minimum value of the reflection (%) relating to the regular reflection light, in a wavelength range of 400 nm or more and 700 nm or less when incident angle of 45°, is 1.5 or less.

### CITATION LIST

### Patent Documents

Patent Document 1: Japanese Patent Application Laid-Open (JP-A) No. 2018-109773
Patent Document 2: JP-A No. 2019-70756

### SUMMARY OF DISCLOSURE

### Technical Problem

However, in Patent Documents 1 to 2, the visibility in the usage mode where an image is observed with the display device folded, is not considered, and the reality is that a stacked body that may improve visibility in such usage mode is not proposed.

Also, in the case of flexible displays, there is room for improvement in the visibility of images and characters in the bent portion.

The first embodiment of the present disclosure has been made in view of the above circumstances, and an object is to provide a stacked body for a display device capable of improving the visibility in the usage mode where an image is observed with the display device folded.

Also, the second embodiment of the present disclosure has been made in view of the above circumstances, and an object is to provide a stacked body for a display device capable of improving the visibility of images and characters in the bent portion, and capable of improving the visibility in the usage mode where an image is observed with the display device folded.

### Solution to Problem

The first embodiment of the present disclosure provides a stacked body for a display device comprising a substrate layer, a first layer, and a second layer, in this order; wherein a luminous reflectance of regular reflection light, when light is entered to a second layer side surface of the stacked body for a display device with incident angle of 60°, is 10.0% or less; and an absolute value of a difference, between yellowness YI1 of transmitted light in 60° direction with respect to a normal line to the second layer side surface of the stacked body for a display device and yellowness YI2 of transmitted light in 15° direction with respect to a normal line to the second layer side surface of the stacked body for a display device, is 3.0 or less.

In the stacked body for a display device according to the present aspect, a thickness of the second layer is preferably 1 μm or more and 10 μm or less; and a refractive index of the second layer is preferably 1.40 or more and 1.50 or less.

In the stacked body for a display device according to the present aspect, a thickness of the second layer is preferably 50 nm or more and 1 μm or less; and a ratio of a refractive index of the first layer with respect to a refractive index of the second layer is preferably 1.05 or more and 1.20 or less.

Also, in the stacked body for a display device according to the present aspect, the substrate layer may double as the first layer.

Also, in the stacked body for a display device according to the present aspect, a hard coating layer may be included between the substrate layer and the first layer.

Also, in the stacked body for a display device according to the present aspect, an impact absorbing layer may be included on the substrate layer, on an opposite surface side to the first layer, or between the substrate layer and the first layer.

Also, in the stacked body for a display device according to the present aspect, an adhesive layer for adhesion may be included on the substrate layer, on an opposite surface side to the first layer.

Another aspect of the present embodiment provides a display device comprising: a display panel, and the stacked body for a display device described above placed on an observer side of the display panel.

The second embodiment of the present disclosure provides a stacked body for a display device comprising a substrate layer; and a functional layer, wherein a luminous reflectance of regular reflection light, when light is entered to a functional layer side surface of the stacked body for a display device with incident angle of 60°, is 10.0% or less; and after a surface modification of a functional layer side surface of the stacked body for a display device, a maximum load at which the functional layer is not peeled off, when a steel wool test is carried out, is 1.0 kg/cm² or more and 2.0 kg/cm² or less, wherein, in the steel wool test, the functional layer side surface of the stacked body for a display device is rubbed with a #0000 steel wool, for 100 strokes, applying a predetermined load.

In the stacked body for a display device according to the present aspect, the functional layer is preferably an inorganic film.

In the above case, the inorganic film preferably includes silicon dioxide.

Also, in the stacked body for a display device according to the present aspect, a thickness of the functional layer is preferably 50 nm or more and 140 nm or less.

Also, the display device in the present aspect, a refractive index of the functional layer is preferably 1.40 or more and 1.50 or less.

In the stacked body for a display device according to the present aspect, a second functional layer may be included between the substrate layer and the functional layer; and in this case, the second functional layer preferably includes resin and an inorganic particle.

In the above case, a thickness of the second functional layer is preferably 50 nm or more and 10 μm or less.

Also, in the above case, the refractive index of the second functional layer is preferably 1.55 or more and 2.00 or less.

Also, in the stacked body for a display device in the present aspect, a hard coating layer may be included between the substrate layer and the functional layer.

Also, in the stacked body for a display device in the present aspect, an impact absorbing layer may be included on the substrate layer, on an opposite surface side to the functional layer.

Also, in the stacked body for a display device in the present aspect, an adhesive layer for adhesion may be included on the substrate layer, on an opposite surface side to the functional layer.

Another aspect of the present embodiment provides a display device comprising: a display panel, and the stacked body for a display device described above placed on an observer side of the display panel.

### Advantageous Effects of Disclosure

The first embodiment of the present disclosure has an effect that a stacked body for a display device capable of improving the visibility in the usage mode where an image is observed with the display device folded, may be provided.

Also, the second embodiment of the present disclosure has an effect that a stacked body for a display device capable of improving the visibility of images and characters in the bent portion, and capable of improving the visibility in the usage mode where an image is observed with the display device folded, may be provided.

### BRIEF DESCRIPTION OF DRAWINGS

FIG. 1 is a schematic cross-sectional view illustrating an example of a stacked body for a display device in the first embodiment.

FIGS. 2A and 2B are schematic cross-sectional views illustrating an example of a stacked body for a display device in the first embodiment.

FIG. 3 is a schematic cross-sectional view illustrating an example of a foldable display in the first embodiment.

FIGS. 4A to 4C are schematic views explaining a dynamic bending test.

FIG. 5 is a schematic cross-sectional view illustrating an example of a stacked body for a display device in the first embodiment.

FIG. 6 is a schematic cross-sectional view illustrating an example of a stacked body for a display device in the first embodiment.

FIG. 7 is a schematic cross-sectional view illustrating an example of a stacked body for a display device in the first embodiment.

FIG. 8 is a schematic cross-sectional view illustrating an example of a stacked body for a display device in the first embodiment.

FIG. 9 is a schematic cross-sectional view illustrating an example of a display device in the first embodiment.

FIG. 10 is a schematic cross-sectional view illustrating an example of a stacked body for a display device in the second embodiment.

FIGS. 11A and 11B are schematic cross-sectional views illustrating an example of a stacked body for a display device in the second embodiment.

FIG. 12 is a schematic cross-sectional view illustrating an example of a foldable display in the second embodiment.

FIG. 13 is a schematic cross-sectional view illustrating an example of a stacked body for a display device in the second embodiment.

FIG. 14 is a schematic cross-sectional view illustrating an example of a stacked body for a display device in the second embodiment.

FIG. 15 is a schematic cross-sectional view illustrating an example of a stacked body for a display device in the second embodiment.

FIG. 16 is a schematic cross-sectional view illustrating an example of a stacked body for a display device in the second embodiment.

FIG. 17 is a schematic cross-sectional view illustrating an example of a stacked body for a display device in the second embodiment.

FIG. 18 is a schematic cross-sectional view illustrating an example of a display device in the second embodiment.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present description and each drawing, for the factor same as that described in the figure already explained, the same reference sign is indicated and the detailed explanation thereof may be omitted.

In the present descriptions, in expressing an aspect wherein some member is placed on the other member, when described as merely “on” or “below”, unless otherwise stated, it includes both of the following cases: a case wherein some member is placed directly on or directly below the other member so as to be in contact with the other member, and a case wherein some member is placed on the upper side or the lower side of the other member via yet another member. Also, in the present descriptions, on the occasion of expressing an aspect wherein some member is placed on the surface of the other member, when described as merely “on the surface side” or “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

The first embodiment and the second embodiment of the stacked body for a display device and a display device in the present disclosure are hereinafter described separately.

### I. First Embodiment

Firstly, a stacked body for a display device and a display device in the first embodiment are described.

### A. Stacked Body for Display Device

The stacked body for a display device in the present embodiment comprises a substrate layer, a first layer, and a second layer, in this order; wherein a luminous reflectance of regular reflection light, when light is entered to a second layer side surface of the stacked body for a display device with incident angle of 60°, is 10.0% or less; and an absolute value of a difference, between yellowness YI1 of transmitted light in 60° direction with respect to a normal line to the second layer side surface of the stacked body for a display device and yellowness YI2 of transmitted light in 15° direction with respect to a normal line to the second layer side surface of the stacked body for a display device, is 3.0 or less.

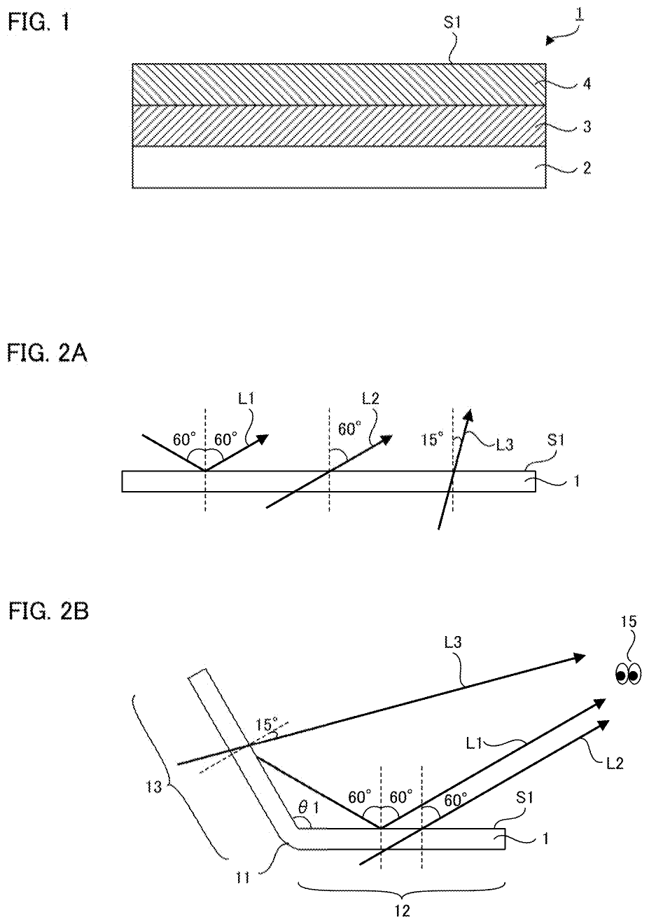

FIG. 1 is a schematic cross-sectional view illustrating an example of a stacked body for a display device in the present embodiment. As shown in FIG. 1, the stacked body for a display device 1 comprises a substrate layer 2, a first layer 3, and a second layer 4, in this order. Also, as illustrated in FIG. 2A, the luminous reflectance of regular reflection light L1, when light is entered to a second layer side surface S1 of the stacked body for a display device 1 with incident angle of 60°, is a predetermined value or less. Also, as illustrated in FIG. 2A, the difference between yellowness YI1 of transmitted light L2 in 60° direction with respect to a normal line to the second layer side surface S1 of the stacked body for a display device 1 and yellowness YI2 of transmitted light L3 in 15° direction with respect to a normal line to the second layer side surface S1 of the stacked body for a display device 1, is a predetermined value or less.

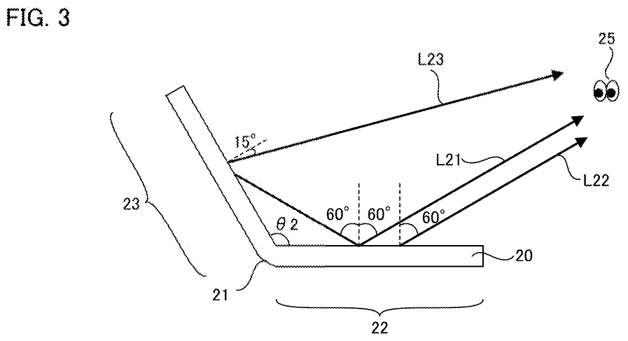

Here, for a flexible display, for example, usage mode where an image is observed in a folded state, is assumed. As shown in FIG. 3 for example, in such the usage mode, the foldable display 20 will have the first display region 22 and the second display region 23 with the bent portion 21 on the boundary thereof. In such case, images and characters displayed in the second display region 23 may be reflected in the first display region 22, and images and characters displayed in the first display region 22 may be reflected in the second display region 23, resulting in a decrease in the visibility of images and characters. This is not limited to foldable displays, and the same problem occurs when an image is observed in a folded state on a flexible display.

Meanwhile, in the present embodiment, since the luminous reflectance of the regular reflection light L1 when light is entered to the second layer side surface S1 of the stacked body for a display device 1 with an incident angle of 60° is a predetermined value or less, when the stacked body for a display device is used for a flexible display, images and characters displayed in one display region may be suppressed from being reflected in the other display region, when an image is observed in a folded state on a flexible display.

For example, when an image is observed in a folded state on a foldable display, the angle θ2, between the first display region 22 and the second display region 23 illustrated in FIG. 3, is likely to be set to be greater than 90° and less than 180° from the viewpoint of the visibility of the displayed images and characters, and specifically, it may be set to approximately 120°. When the stacked body for a display device is placed on the observer 25 side surface of such a foldable display 20, for example, as shown in FIG. 2B, the stacked body for a display device 1 will have the first region 12 and the second region 13 with the bent portion 11 on the boundary thereof, and the angle θ1 between the first region 12 and the second region 13 will be similar to the angle θ2.

For example, in FIG. 2B, when the luminous reflectance of the regular reflection light L1 when light is entered to the second layer side surface S1 of the stacked body for a display device 1 with an incident angle of 60° is a predetermined value or less, in the foldable display 20 illustrated in FIG. 3, the light from the second display region 23 corresponding to the second region 13 of the stacked body for a display device 1 may be suppressed from being reflected in the first display region 22 corresponding to the first region 12 of the stacked body for a display device 1. Therefore, when the stacked body for a display device in the present embodiment is used for a flexible display, images and characters displayed in one display region may be suppressed from being reflected in the other display region, when the image is observed in a folded state on a flexible display.

Incidentally, in the present embodiment, as shown in FIG. 3 for example, when an image is observed in a folded state on the flexible display 20, as described above, the luminous reflectance of regular reflection light, when the incident angle is 60°, is employed in view of the followings: the angle θ2 between the first display region 22 and the second display region 23 is likely to be set to be greater than 90° and less than 180° from the viewpoint of the visibility of the displayed images and characters, and specifically, it may be set to approximately 120°; when an image is observed with the foldable display 20 folded, the observer 25 tends to observe the image displayed in the first display region 22 and the second display region 23 by moving only the line of sight without changing the observation position; and even on an identical surface, the reflection increases as the incident angle increases. The luminous reflectance of regular reflection light, when the incident angle is 60°, represents the luminous reflectance when light from one display region is reflected in the other display region, when an image is observed with the flexible display folded.

Also, in the display device, there is a problem that the color of the image changes according to the observation direction. Also, as described above, when an image is observed with the foldable display folded, the observer tends to observe the image displayed in the first display region and the second display region by moving only the line of sight without changing the observation position. In such a case, the position of observer 25 is constant, as shown in FIG. 3, so the angle of the observation direction with respect to the normal line of the observer 25 side surface of the foldable display 20 is different between the first display region 22 and the second display region 23. Therefore, there is a problem that the color of the image differs between the first display region 22 and the second display region 23. This is not limited to foldable displays, and the same problem occurs when an image is observed in a folded state on a flexible display.

Meanwhile, in the present embodiment, since the absolute value of a difference, between yellowness YI1 of transmitted light in 60° direction with respect to a normal line to the second layer side surface of the stacked body for a display device and yellowness YI2 of transmitted light in 15° direction with respect to a normal line to the second layer side surface of the stacked body for a display device, is a predetermined value or less, when the stacked body for a display device is used for a flexible display, the difference of the image color in one display region and the other display region may be decreased so that the color change may be suppressed, when an image is observed in a folded state on a flexible display.

For example, in FIG. 2B, when the absolute value of a difference, between yellowness YI1 of transmitted light L2 in 60° direction with respect to a normal line to the second layer side surface S1 of the stacked body for a display device 1 and yellowness YI2 of transmitted light L3 in 15° direction with respect to a normal line to the second layer side surface S1 of the stacked body for a display device 1, is a predetermined value or less, in the foldable display 20 illustrated in FIG. 3, the difference of the image color in the first display region 22 corresponding to the first region 12 of the stacked body for a display device 1 and in the second display region 23 corresponding to the second region 13 of the stacked body for a display device 1 may be decreased so that the color change may be suppressed. Therefore, when the stacked body for a display device in the present embodiment is used for a flexible display, the color change of the image in one display region and the other display region may be suppressed, when an image is observed in a folded state on a flexible display.

Incidentally, in the present embodiment, as shown in FIG. 3 for example, when an image is observed in a folded state on the foldable display 20, as described above, the yellowness of transmitted light in 60° direction and the yellowness of transmitted light in 15° direction are employed in view of the followings: the angle θ2 between the first display region 22 and the second display region 23 is likely to be set to be greater than 90° and less than 180° from the viewpoint of the visibility of the displayed images and characters, and specifically, it may be set to approximately 120°; and when an image is observed with the foldable display 20 folded, the observer 25 tends to observe the image displayed in the first display region 22 and the second display region 23 by moving only the line of sight without changing the observation position, and in such a case, the observation direction range is limited. The yellowness of transmitted light in 60° direction and the yellowness of transmitted light in 15° direction respectively represent the image color in one display region and the image color in the other display region, when an image is observed with the flexible display folded.

Also, in the present embodiment, the yellowness is employed, assuming the color change of a white image. When the yellowness is close to zero, it indicates white, when the yellowness is a negative value, it indicates blue, and when the yellowness is a positive value, it indicates yellow.

Incidentally, in FIG. 3, the reference sign L21 indicates light emitted from the second display region 23 and reflected on the first display region 22; the reference sign L22 indicates light in 60° direction with respect to the normal line of the observer 25 side surface of the foldable display 20; and the reference sign L23 indicates light in 15° direction with respect to the normal line of the observer 25 side surface of the foldable display 20.

Therefore, when the stacked body for a display device in the present embodiment is used for a display device, among them, for a flexible display, it is possible to improve the visibility in the usage mode where an image is observed with the display device folded.

Each constitution of the stacked body for a display device in the present embodiment is hereinafter described.

### 1. Properties of Stacked Body for Display Device

In the present embodiment, the luminous reflectance of regular reflection light, when light is entered to a second layer side surface of the stacked body for a display device with incident angle of 60°, is 10.0% or less, preferably 9.5% or less, and more preferably 9.0% or less. Since the luminous reflectance of regular reflection light when the incident angle is 60° is in the above range, when the stacked body for a display device in the present embodiment is used for a flexible display, images and characters displayed in one display region may be suppressed from being reflected in the other display region, when the image is observed in a folded state on a flexible display. The lower the luminous reflectance of regular reflection light when the incident angle is 60°, the better, and the lower limit is not particularly limited, and may be, for example, 0.1% or more. The luminous reflectance of regular reflection light when the incident angle is 60° is preferably 0.1% or more and 10.0% or less, more preferably 0.5% or more and 9.5% or less, and further preferably 1.0% or more and 9.0% or less.

Also, the luminous reflectance of regular reflection light, when light is entered to the second layer side surface of the stacked body for a display device with incident angle of 5°, is preferably, for example, 0.1% or more and 4.0% or less, more preferably 0.5% or more and 3.5% or less, and further preferably 1.0% or more and 3.0% or less. Since the luminous reflectance of regular reflection light when the incident angle is 5° is in the above range, when the image is observed in a state where the stacked body for a display device in the present embodiment is not folded, that is, for example, in a state where angle θ2 in FIG. 3 is 180°, the difference of the image color in one display region and the other display region may be decreased so that the color change may be suppressed, while suppressing the observer oneself is reflected in the display region.

Here, the luminous reflectance may be determined according to JIS Z8722:2009. For the luminous reflectance, the tristimulus values X, Y and Z in the XYZ colorimetric system are determined from the reflected spectrum obtained when light, in a wavelength range of 380 nm or more and 780 nm or less, is incident on the second layer side surface of the stacked body for a display device, in conditions of a viewing angle of 2 degrees, and standard light C, and the value of Y is regarded as the luminous reflectance.

That is, the luminous reflectance refers to the Y value of the CIE1931 standard colorimetric system. The following conditions may be used for measuring the luminous reflectance.

### (Measurement Conditions)

Viewing angle: 2°
Illuminant: C
Light source: tungsten halogen lamp
Measurement wavelength: 0.5 nm interval in the range of 380 nm or more and 780 nm or less
Scan speed: fast
Slit width: 5.0 nm
S/R switch: standard
Auto Zero: carried out at 550 nm after baseline scan

Incidentally, when measuring the luminous reflectance of the stacked body for a display device, black vinyl tape with a width larger than the measured spot area (for example, product name “Yamato Vinyl Tape NO200-19-21” from Yamato Co. Ltd., 19 mm width) is adhered to the substrate layer side surface of the stacked body for a display device, before measuring, in order to prevent backside reflection. For example, a spectrophotometer may be used to as a measurement device to measure the luminous reflectance, and specifically, “UV-2600” spectrophotometer from Shimadzu Corporation may be used. Incidentally, the incident angle refers to the angle of light incident on the second layer side surface of the stacked body for a display device, with respect to the normal line to the second layer side surface of the stacked body for a display device.

Examples of the way to reduce the luminous reflectance of the regular reflection light, when light is entered to the second layer side surface of the stacked body for a display device with incident angle of 60°, may include (1-1) to set the refractive index of the second layer relatively low; and (1-2) to set the ratio of the refractive index of the first layer with respect to the refractive index of the second layer close to 1.

When (1-1) the refractive index of the second layer is set relatively low, the difference between the refractive index of the second layer and the refractive index of air may be reduced by setting the refractive index of the second layer relatively low, so that the reflection of light on the second layer side surface of the stacked body for a display device may be suppressed, and thereby reducing luminous reflectance of regular reflection light when the incident angle is 60°. In this case, it is preferable to make the thickness of the second layer relatively thick. When the thickness of the second layer is relatively thick, interference between the regular reflection light from the interface of the first layer and the second layer and the regular reflection light of the second layer side surface is less likely to occur, and the reflection of light on the second layer side surface of the stacked body for a display device may be effectively suppressed. Examples of the method to set the refractive index of the second layer relatively low may include a method to compound a resin and a low refractive index particle with refractive index lower than the resin into the second layer; or to compound a low refractive index resin with low refractive index into the second layer.

Also, when (1-2) the ratio of the refractive index of the first layer with respect to the refractive index of the second layer is set close to 1, by setting the ratio of the refractive index of the first layer with respect to the refractive index of the second layer close to 1, the reflection of light on the interface of the first layer and the second layer may be suppressed, and thereby reducing luminous reflectance of regular reflection light when the incident angle is 60°. In this case, it is preferable to make the thickness of the second layer relatively thin. When the thickness of the second layer is relatively thin, the light interference caused by the thin film may be controlled by adjusting the refractive index and thickness of the second layer, and the luminous reflectance of regular reflection light when the incident angle is 60° may be controlled. Examples of the way to make the ratio of the refractive index of the first layer with respect to the refractive index of the second layer close to 1 may include a method wherein the refractive index of the first layer and the second layer are adjusted.

Specific ways to reduce the luminous reflectance of regular reflection light when the incident angle is 60° are described in the section describing the first layer and the second layer below.

Also, in the present embodiment, the absolute value of a difference, between yellowness YI1 of transmitted light in 60° direction with respect to a normal line to the second layer side surface of the stacked body for a display device and yellowness YI2 of transmitted light in 15° direction with respect to a normal line to the second layer side surface of the stacked body for a display device, is 3.0 or less, preferably 2.5 or less, and more preferably 2.0 or less. Since the absolute value of the difference between yellowness YI1 and YI2, when the stacked body for a display device in the present embodiment is used for a flexible display, the color change of the image in one display region and the other display region may be suppressed, when the image is observed in a folded state on a flexible display.

Also, the lower the absolute value of the difference between yellowness YI1 and YI2, the better, and the lower limit is not particularly limited, and may be, for example, 0.0 or more. The absolute value of the difference between yellowness YI1 and YI2 is preferably 0.0 or more and 3.0 or less, more preferably 0.2 or more and 2.5 or less, and further preferably 0.5 or more and 2.0 or less.

Here, the yellowness (YI) may be determined according to JIS K7373:2006. Specifically, based on the transmittance measured using an ultraviolet-visible and near-infrared spectrophotometer by a spectrophotometric colorimetry; using a deuterium lamp and a tungsten halogen lamp; with 0.5 nm interval in the range of 300 nm or more and 780 nm or less; in conditions of a viewing angle of 2 degrees, and standard light C, the tristimulus values X, Y and Z in the XYZ colorimetric system are determined, and the yellowness may be calculated from the following formula, from the values of X, Y, and Z.

YI=100(1.2769X−1.0592Z)/Y

The following conditions may be used for measuring the yellowness (YI).

### (Measurement Conditions)

Viewing angle: 2°
Illuminant: C
Light source: deuterium lamp and tungsten halogen lamp
Measurement wavelength: 0.5 nm interval in the range of 300 nm or more and 780 nm or less
Scan speed: fast
Slit width: 5.0 nm
S/R switch: standard
Auto Zero: carried out at 550 nm after baseline scan

As the ultraviolet-visible and near-infrared spectrophotometer, for example, a “V-7100” from JASCO Corporation may be used.

Examples of the way to reduce the absolute value of the difference between yellowness YI1 and YI2 may include (2-1) to set the ratio of the refractive index of the first layer with respect to the refractive index of the second layer close to 1; and (2-2) to set the haze of the second layer relatively low.

When (2-1) the ratio of the refractive index of the first layer with respect to the refractive index of the second layer is set close to 1, by setting the ratio of the refractive index of the first layer with respect to the refractive index of the second layer close to 1, the reflection of light on the interface of the first layer and the second layer may be suppressed, and thereby suppressing the occurrence of interference fringe due to transmitted light. As the result, the change in transmittance due to the change in the angle of transmitted light may be reduced, and the absolute value of the difference between yellowness YI1 and YI2 may be reduced. Meanwhile, when the ratio of the refractive index of the first layer with respect to the refractive index of the second layer is high, interference fringe due to transmitted light occurs. When the Interference fringe occurs, the transmission spectrum may be affected, and the change in transmittance due to the change in the angle of transmitted light may be increased. As the result, the absolute value of the difference between yellowness YI1 and YI2 increases. When the ratio of the refractive index of the first layer with respect to the refractive index of the second layer is set close to 1, the thickness of the second layer is preferably relatively thin. When the thickness of the second layer is relatively thin, the light interference caused by the thin film may be controlled by adjusting the refractive index and thickness of the second layer, and the interference fringe due to transmitted light may be suppressed.

Also, when (2-2) the haze of the second layer is set relatively low, the yellowness YI1 and YI2 tend to decrease as the haze of the second layer decreases, and the absolute value of the difference between yellowness YI1 and YI2 may be reduced. Meanwhile, when the haze of the second layer is high, the yellowness YI1 and YI2 tend to be high, and the absolute value of the difference between yellowness YI1 and YI2 may be increased. When the second layer includes a resin and a low refractive index particle with refractive index lower than the resin, examples of the method to control the haze of the second layer may include a method wherein the content of the low refractive index particle is adjusted.

Specific ways to reduce the absolute value of the difference between yellowness YI1 and YI2 are described in the section describing the first layer and the second layer below.

The total light transmittance of the stacked body for a display device in the present embodiment is preferably, for example, 85% or more, more preferably 88% or more, and further preferably 90% or more. When the total light transmittance is high as described above, the stacked body for a display device may have good transparency.

Here, the total light transmittance of the stacked body for a display device may be measured according to JIS K7361-1:1999, and may be measure with, for example, a haze meter HM150 from Murakami Color Research Laboratory Co., Ltd.

The haze of the stacked body for a display device in the present embodiment is preferably, for example, 5% or less, more preferably 2% or less, and further preferably 1% or less. When the haze is low as described above, the stacked body for a display device may have good transparency.

Here, the haze of the stacked body for a display device may be measured according to JIS K-7136:2000, and may be measure with, for example, a haze meter HM150 from Murakami Color Research Laboratory Co., Ltd.

The stacked body for a display device in the present embodiment preferably has a bending resistance. Specifically, when the dynamic bending test described below is carried out to the stacked body for a display device, it is preferable that a crack or a fracture does not occur in the stacked body for a display device.

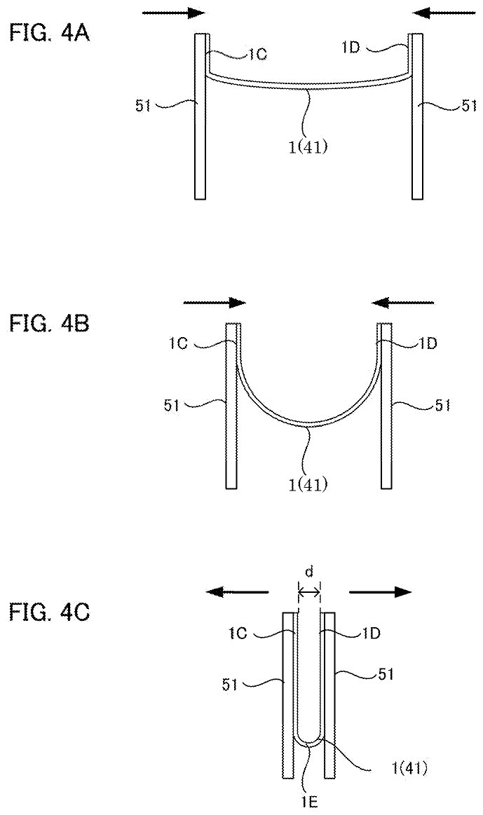

The dynamic bending test is carried out as follows. Firstly, a stacked body for a display device having a size of 50 mm×200 mm is prepared. Then, in the dynamic bending test, as shown in FIG. 4A, short side portion 1C and short side portion 1D opposing to the short side portion 1C of the stacked body for a display device 1 are respectively fixed by parallelly arranged fixing portions 51. Also, as shown in FIG. 4A, the fixing portions 51 are movable by sliding in horizontal direction. Then, as shown in FIG. 4B, by moving the fixing portions 51 so as to be closer to each other, the stacked body for a display device 1 is deformed so as to be folded. Further, as shown in FIG. 4C, after moving the fixing portions 51 to the position wherein distance “d” between the two opposing short side portions 1C and 1D of the stacked body for a display device 1 fixed by the fixing portions 51 is a predetermined value, the deformation of the stacked body for a display device 1 is dissolved by moving the fixing portions 51 in opposite directions. As shown in FIGS. 4A to 4C, by moving the fixing portions 51, the stacked body for a display device 1 may be folded into 180°. Also, by carrying out the dynamic bending test so that bent portion 1E of the stacked body for a display device 1 does not protrude from the lower end edge of the fixing portions 51, and by controlling the distance when the fixing portions 51 are the closest, distance “d” between the two opposing short side portions 1C and 1D of the stacked body for a display device 1 may be a predetermined value. For example, when the distance “d” between the short side portions 1C and 1D is 30 mm, the outer diameter of the bent portion 1E is regarded as 30 mm. For dynamic bending testing, for example, a durability tester (product name “DLDMLH-FS” from Yuasa Co., Ltd.) may be used.

In the stacked body for a display device, it is preferable that a crack or a fracture does not occur when the dynamic bending test wherein the stacked body for a display device 1 is folded into 180° so that the distance “d” between the opposing short side portions 1C and 1D of the stacked body for a display device 1 is 30 mm, is carried out repeatedly for 200,000 times, and it is more preferable that a crack or a fracture does not occur when the dynamic bending test is carried out repeatedly for 500,000 times. Among the above, it is preferable that a crack or a fracture does not occur when the dynamic bending test wherein the stacked body for a display device is folded into 180° so that the distance “d” between the opposing short side portions 1C and 1D of the stacked body for a display device is 20 mm, is carried out repeatedly for 200,000 times; particularly, it is preferable that a crack or a fracture does not occur when the dynamic bending test wherein the stacked body for a display device 1 is folded into 180° so that the distance “d” between the opposing short side portions 1C and 1D of the stacked body for a display device 1 is 10 mm, is carried out repeatedly for 200,000 times.

In the dynamic bending test, the stacked body for a display device may be folded so that the second layer is on the outer side, or the stacked body for a display device may be folded so that the second layer is on the inner side; and in either of these cases, it is preferable that a crack or a fracture does not occur in the stacked body for a display device.

### 2. First Layer and Second Layer

In the present embodiment, a first layer and a second layer are placed on one surface of the substrate layer, in order.

In the present embodiment, in order to keep the luminous reflectance of regular reflection light, when the incident angle is 60°, at a predetermined value or less, and in order to keep the absolute value of the difference between yellowness YI1 and YI2 at a predetermined value or less, as described above, it is preferable that the refractive index of the second layer is relatively low, the refractive index of the second layer is in a predetermined range, and the thickness of the second layer is relatively thick; or the ratio of the refractive index of the first layer with respect to the refractive index of the second layer is relatively low, and the thickness of the second layer is relatively thin. Specifically, it is preferable that the refractive index of the second layer 1.40 or more and 1.50 or less and the thickness of the second layer is 1 μm or more and 10 μm or less; or the ratio of the refractive index of the first layer with respect to the refractive index of the second layer is 1.05 or more and 1.20 or less, and the thickness of the second layer is 50 nm or more and 1 μm or less. These two preferable embodiments are explained separately below.

### (1) First Embodiment

In the present embodiment, the refractive index of the second layer is 1.40 or more and 1.50 or less and the thickness of the second layer is 1 μm or more and 10 μm or less.

In the present embodiment, since the refractive index of the second layer is in the predetermined range, the difference from the refractive index of air may be reduced, the reflection of light on the second layer side surface of the stacked body for a display device may be suppressed. Also, since the thickness of the second layer is in the predetermined value or more so as to be relatively thick, interference between the regular reflection light from the interface of the first layer and the second layer, and the regular reflection light of the second layer side surface is less likely to occur, and the reflection of light on the second layer side surface of the stacked body for a display device may be effectively suppressed.

Therefore, the luminous reflectance of regular reflection light when the incident angle is 60° may be decreased.

Here, the first layer is usually a layer including resin, and the refractive index of general resin is approximately 1.5. Also, when the substrate layer doubles as the first layer as described later, for example, a resin substrate or a glass substrate may be used as the substrate layer; the refractive index of general resin is approximately 1.5 as described above; and the refractive index of general glass is also approximately 1.5.

In the present embodiment, since the refractive index of the second layer is in the predetermined range, the ratio of the refractive index of the first layer with respect to the refractive index of the second layer may be close to 1, so that the absolute value of the difference between yellowness YI1 and YI2 may be reduced, as described above.

Also, in the present embodiment, since the thickness of the second layer is the predetermined value or less, flexibility and bending resistance may be improved.

### (a) Second Layer

### (i) Properties of Second Layer

In the present embodiment, the refractive index of the second layer is preferably, for example, 1.40 or more, more preferably 1.43 or more, and further preferably 1.45 or more.

Since the refractive index of the second layer is in the above range, the ratio of the refractive index of the first layer with respect to the refractive index of the second layer may be close to 1, so that the absolute value of the difference between yellowness YI1 and YI2 may be reduced. Also, the refractive index of the second layer is preferably, for example, 1.50 or less, more preferably 1.49 or less, and further preferably 1.48 or less. Since the refractive index of the second layer is in the above range, the difference from the refractive index of air may be reduced, and the reflection of light on the second layer side surface of the stacked body for a display device may be suppressed. The refractive index of the second layer is preferably 1.40 or more and 1.50 or less, more preferably 1.43 or more and 1.49 or less, and further preferably 1.45 or more and 1.48 or less.

Also, in the present embodiment, the ratio of the refractive index of the first layer with respect to the refractive index of the second layer is preferably, for example, 1.00 or more and 1.18 or less, more preferably 1.01 or more and 1.15 or less, and further preferably 1.02 or more and 1.10 or less. Since the ratio of the refractive index of the first layer with respect to the refractive index of the second layer is close to 1, luminous reflectance of regular reflection light when the incident angle is 60° may be reduced, and the absolute value of the difference between yellowness YI1 and YI2 may be reduced. Also, since the ratio of the refractive index of the first layer with respect to the refractive index of the second layer is in the above range, it is possible to improve the visibility of the flexible display while improving flexibility and bending resistance.

Here, the refractive index of each layer is the refractive index with respect to light with a wavelength of 550 nm. Examples of the method for measuring the refractive index may include a method measuring with an ellipsometer. Examples of the ellipsometer may include “UVSEL” from Jobin Yvon and “DF1030R” from Techno-Synergy, Inc. The same may be applied for the method for measuring the refractive index of the first layer and the substrate layer.

In the present embodiment, the thickness of the second layer is preferably, for example, 1 μm or more, more preferably 3 μm or more, and further preferably 5 μm or more. Since the thickness of the second layer is in the above range, interference between the regular reflection light from the interface of the first layer and the second layer, and the regular reflection light of the second layer side surface is less likely to occur, and the reflection of light on the second layer side surface of the stacked body for a display device may be effectively suppressed. Also, the thickness of the second layer is preferably, for example, 10 μm or less, more preferably 9 μm or less, and further preferably 8 μm or less. When the thickness of the second layer is too thick, the flexibility or the bending resistance may be deteriorated. The thickness of the second layer is preferably 1 μm or more and 10 μm or less, more preferably 3 μm or more and 9 μm or less, and further preferably 5 μm or more and 8 μm or less.

Here, the thickness of the second layer is a value obtained by measuring from the thickness directional cross-section of the stacked body for a display device by observing with a transmission electron microscope (TEM), a scanning electron microscope (SEM) or a scanning transmission electron microscope (STEM), and may be the average value of the thickness of arbitrary selected 10 points. Incidentally, the same may be applied to the measuring methods of the thickness of other layers included in the stacked body for a display device.

### (ii) Material of Second Layer

The material of the second layer is not particularly limited as long as it is material capable of obtaining a second layer that satisfies the above refractive index. For example, the second layer may include resin and low refractive index particles with refractive index lower than the resin; or may include a low refractive index resin with the refractive index described above.

(ii-1) Resin and Low Refractive Index Particles

When the second layer includes resin and low refractive index particles, the low refractive index particles are not particularly limited as long as it has refractive index lower than the refractive index of the resin, and it is capable of obtaining a second layer that satisfies the refractive index described above.

The low refractive index particles may be either inorganic particles or organic particles. Examples of the inorganic particles may include inorganic particles such as silicon dioxide (silica), magnesium fluoride, lithium fluoride, calcium fluoride and barium fluoride. Among the above, the silica particles are preferable.

Also, the low refractive index particles may be any one of, for example, solid particles, hollow particles, and porous particles; and among them hollow particles and porous particles are preferable for their low refractive index. Examples of the hollow and porous particles may include porous silica particles, hollow silica particles, porous polymer particles, and hollow polymer particles.

Also, the low refractive index particles may be subjected to a surface treatment. By subjecting the low refractive index particles to a surface treatment, affinity with resins and solvents is improved, uniform dispersion of the low refractive index particles is improved, and prevents aggregation between the low refractive index particles so that the decrease in transparency, the applicability of the resin composition for a second layer, and the film strength may be suppressed.

Examples of the surface treatment method may include a surface treatment using silane coupling agents. The specific silane coupling agent may be similar to the silane coupling agents disclosed in Japanese Patent Application Laid-Open (JP-A) No. 2013-142817, for example.

Also, the low refractive index particle may be a reactive particle with a polymerizable functional group on its surface.

Examples of the low refractive index particles those are the reactive particles may include those used for the low refractive index layer described in Japanese Patent Application Laid-Open (JP-A) No. 2013-142817.

The average particle size of the low refractive index particles may be the thickness of the second layer or less, and it may be for example, 300 nm or less, may be 200 nm or less, may be 150 nm or less, and may be 100 nm or less. Also, the average particle size of the low refractive index particles may be, for example, 5 nm or more, may be 10 nm or more, may be 30 nm or more, and may be 50 nm or more. When the average particle size of the low refractive index particles is in the above range, good dispersion condition of the low refractive index particles may be obtained without deteriorating the transparency of the second layer. Incidentally, when the average particle size of the low refractive index particles is in the above range, the average particle size may be either the primary particle size or the secondary particle size, and the low refractive index particles may be connected in the form of chain. The average particle size of the low refractive index particles is preferably, for example, 5 nm or more and 300 nm or less, more preferably 10 nm or more and 200 nm or less, further preferably 30 nm or more and 150 nm or less, and most preferably 50 nm or more and 100 nm or less.

Here, the average particle size of the low refractive index particles is the average value of 20 particles observed by transmission electron microscopy (TEM) images of the cross-section of the second layer.

The shape of the low refractive index particles is not particularly limited, and examples thereof may include spherical shape, chain shape, and needle shape.

Also, when the second layer includes the resin and the low refractive index particles, the resin is selected as appropriate from the viewpoint of film formation and film strength. Among them, the resin is preferably a cured resin cured by heat or irradiation of ionizing radiation such as ultraviolet rays or electron beams. Examples of the cured resin may include thermally cured resins and ionizing radiation cured resins. Also, examples of the ionizing radiation cured resin may include ultraviolet cured resins and electron beam cured resins. Among them, ionizing radiation cured resins are preferable. This is because the surface hardness of the second layer may be increased.

Here, “ionizing radiation cured resin” in the present specification means resin cured by irradiation of ionizing radiation. Also, “ionizing radiation” refers to, among electromagnetic waves and charged particle beams, one having energy quantum capable of polymerizing or cross-linking molecules; and examples thereof may include, in addition to ultraviolet rays and electron beams, electromagnetic waves such as X-rays and γ-rays; and charged particle beams such as α-rays and ion rays.

Examples of the ionizing radiation cured resins may include compounds with one or two or more unsaturated bonds such as compounds with an acrylate based functional group. Examples of the compound with one unsaturated bond may include ethyl(meth)acrylate, ethylhexyl(meth)acrylate, styrene, methylstyrene, and N-vinylpyrrolidone. Examples of the compound with two or more unsaturated bonds may include polyfunctional compounds such as polymethylol propanetri(meth)acrylate, hexanediol(meth)acrylate, tripropylene glycoldi(meth)acrylate, diethylene glycol di(meth)acrylate, pentaerythritol tri(meth)acrylate, dipentaerythritol hexa(meth)acrylate, 1,6-hexanediol di(meth)acrylate, neopentylglycol di(meth)acrylate; and reaction products of the above polyfunctional compounds with (meth)acrylates (for example, poly(meth)acrylate esters of polyvalent alcohols). Incidentally, “(meth)acrylate” refers to methacrylate and acrylate.

Also, as the ionizing radiation cured resin, relatively low molecular weight resins with an unsaturated double bond such as polyester resins, polyether resins, acrylic resins, epoxy resins, urethane resins, alkyd resins, spiro acetal resins, polybutadiene resins, and polythiol polyene resins may also be used. Further, the low refractive index resin described later may be used as the resin.

The content of the resin and the low refractive index particles in the second layer is set appropriately so that the refractive index of the second layer as a whole satisfies the above refractive index. The content of the low refractive index particles in the second layer is, for example, preferably 10 parts by mass or more and 300 parts by mass or less, more preferably 30 parts by mass or more and 250 parts by mass or less, and further preferably 50 parts by mass or more and 200 parts by mass or less, with respect to 100 parts by mass of the resin. When the content of the low refractive index particles is too low, the desired refractive index may not be obtained. Also, when the content of the low refractive index particles is too high, the haze of the second layer may be increased, the yellowness YI1 and YI2 may be increased, and the absolute value of the difference between yellowness YI1 and YI2 may be increased.

(ii-2) Low Refractive Index Resin

When the second layer includes the low refractive index resin, the low refractive index resin may be any resin that the second layer including the low refractive index resin is able to satisfy the refractive index described above; and examples thereof may include fluorine resins, silicone resins, acrylic resins, and olefin resins.

(ii-3) Additives

The second layer may include a photopolymerization initiator, when ultraviolet cured resins are used as the resin. Also, the second layer may include various additives according to the desired properties. Examples of the additive may include ultraviolet absorbers, antioxidants, photostabilizers, infrared absorbers, dispersing aids, weather improvement agents, abrasion improvement agents, antistatic agents, polymerization inhibitors, crosslinkers, adhesive enhancers, leveling agents, thixotropy imparting agents, coupling agents, plasticizers, antifoaming agents, and fillers.

(iii) Method for Forming Second Layer

Examples of a method for forming a second layer may include a method wherein the first layer is coated with a resin composition for a second layer, and cured.

### (b) First Layer

### (i) Properties of First Layer

In the present embodiment, as described above, it is preferable that the ratio of the refractive index of the first layer with respect to the refractive index of the second layer is in the predetermined range. Incidentally, the ratio of the refractive index of the first layer with respect to the refractive index of the second layer is described in the second embodiment later, so the explanation is omitted herein.

The refractive index of the first layer is not particularly limited as long as it satisfies the ratio of the refractive index of the first layer with respect to the refractive index of the second layer described above, and is preferably, for example, 1.50 or more and 1.65 or less, more preferably 1.52 or more and 1.63 or less, and further preferably 1.54 or more and 1.60 or less. The refractive index of the first layer is usually higher than the refractive index of the second layer, and when the refractive index of the first layer is in the above range, the ratio of the refractive index of the first layer with respect to the refractive index of the second layer may be close to 1, so that the absolute value of the difference between yellowness YI1 and YI2 may be reduced. Since the refractive index of the first layer is in the above range, the difference from the refractive index of the substrate layer may be reduced, and the reflection of light on the interface of the first layer and the substrate layer may be suppressed.

The thickness of the first layer is preferably, for example, 1 μm or more and 20 μm or less, more preferably 3 μm or more and 15 μm or less, and further preferably 5 μm or more and 10 μm or less. When the thickness of the first layer is in the above range, both flexibility and bending resistance may be exhibited. Also, when the thickness of the first layer is too thick, the flexibility or the bending resistance may be deteriorated.

Incidentally, as will be described later, the substrate layer may double as the first layer, and the thickness of the first layer above is the thickness of the first layer when the substrate layer does not double the first layer.

### (ii) Material of First Layer

The material of the first layer is not particularly limited as long as it is material capable of obtaining a first layer that satisfies the above refractive index. The first layer may include resin. The resin is preferably a cured resin cured by heat or irradiation of ionizing radiation such as ultraviolet rays or electron beams. The cured resin may be similar to the cured resin used for the second layer described above. Among them, in terms of abrasion resistance, ionizing radiation cured resins are preferable. This is because the surface hardness of the low refractive index layer may be increased.

The first layer may include a photopolymerization initiator, when ultraviolet cured resins are used as the resin. Also, the first layer may include various additives according to the desired properties. The additives may be similar to the additives used for the second layer described above.

(iii) Method for Forming First Layer

Examples of a method for forming a first layer may include a method wherein the substrate layer is coated with a resin composition for a first layer, and cured.

### (2) Second Embodiment

In the present embodiment, the ratio of the refractive index of the first layer with respect to the refractive index of the second layer is 1.05 or more and 1.20 or less, and the thickness of the second layer is 50 nm or more and 1 μm or less.

In the present embodiment, since the ratio of the refractive index of the first layer with respect to the refractive index of the second layer is in the predetermined range, the reflection of light at the interface of the first layer and the second layer may be suppressed. Also, when the thickness of the second layer is in the predetermined range and is relatively thin, the light interference caused by the thin film may be controlled by adjusting the refractive index and thickness of the second layer. Therefore, the luminous reflectance of regular reflection light when the incident angle is 60° may be decreased. Furthermore, the occurrence of interference fringe due to transmitted light may be suppressed, and the change in transmittance due to the change in the angle of transmitted light may be reduced. As the result, the absolute value of the difference between yellowness YI1 and YI2 may be reduced.

Also, in the present embodiment, since the thickness of the second layer is in the predetermined range, flexibility and bending resistance may be improved.

### (a) Second Layer

### (i) Properties of Second Layer

In the present embodiment, the ratio of the refractive index of the first layer with respect to the refractive index of the second layer is preferably, for example 1.05 or more and 1.20 or less, more preferably 1.07 or more and 1.18 or less, and further preferably 1.09 or more and 1.15 or less. Since the ratio of the refractive index of the first layer with respect to the refractive index of the second layer is close to 1, luminous reflectance of regular reflection light when the incident angle is 60° may be reduced, and the absolute value of the difference between yellowness YI1 and YI2 may be reduced. Also, since the ratio of the refractive index of the first layer with respect to the refractive index of the second layer is in the above range, it is possible to improve the visibility of the flexible display while improving flexibility and bending resistance.

The refractive index of the second layer is not particularly limited as long as it satisfies the ratio of the refractive index of the first layer with respect to the refractive index of the second layer described above, and is preferably, for example, 1.40 or more, more preferably 1.42 or more, and further preferably 1.44 or more. When the refractive index of the second layer is in the above range, it is easy to adjust the ratio of the refractive index of the first layer with respect to the refractive index of the second layer to be in the predetermined range. Also, the refractive index of the second layer is preferably, for example, 1.50 or less, more preferably 1.49 or less, and further preferably 1.48 or less. Since the refractive index of the second layer is in the above range, the difference from the refractive index of air may be reduced, and the reflection of light on the second layer side surface of the stacked body for a display device may be suppressed. The refractive index of the second layer is preferably, for example, 1.40 or more and 1.50 or less, more preferably 1.42 or more and 1.49 or less, and further preferably 1.44 or more and 1.48 or less.

In the present embodiment, the thickness of the second layer is adjusted appropriately according to the refractive index of the second layer. The thickness of the second layer is preferably, for example 50 nm or more, more preferably 60 nm or more, and further preferably 70 nm or more. When the thickness of the second layer is too thin, the film strength may be deteriorated. Also, the thickness of the second layer is preferably, for example, preferably 1 μm or less, more preferably 700 nm or less, and further preferably 500 nm or less. When the thickness of the second layer is in the above range, reflections may be suppressed by using the light interference effect caused by the thin film and the occurrence of interference fringe due to transmitted light may be suppressed. The thickness of the second layer is preferably, for example, 50 nm or more and 1 μm or less, more preferably 60 nm or more and 700 nm or less, and further preferably 70 nm or more and 500 nm or less.

### (ii) Material of Second Layer

The material of the second layer is not particularly limited as long as it is material capable of obtaining a second layer that satisfies the refractive index and the thickness described above. For example, the second layer may include resin and low refractive index particles with refractive index lower than the resin; may include a low refractive index resin with the refractive index described above; or may include a low refractive index inorganic materials with the refractive index described above.

When the second layer includes the resin and the low refractive index particles, the resin and the low refractive index particles may be similar to the first embodiment.

Also, when the second layer includes the low refractive index resin, the low refractive index resin may be similar to the first embodiment.

Also, when the second layer includes the low refractive index inorganic material, the low refractive index inorganic material may be any inorganic material wherein the second layer including the low refractive index inorganic material is able to satisfy the refractive index described above; and examples thereof may include silicon dioxide (silica), magnesium fluoride, lithium fluoride, calcium fluoride and barium fluoride. Among the above, silicone dioxide (silica) is preferable.

The second layer may include a photopolymerization initiator, when ultraviolet cured resins are used as the resin. Also, the second layer may include various additives according to the desired properties. The additives may be similar to the first embodiment described above.

(iii) Method for Forming Second Layer

The method for forming the second layer is appropriately selected according to the material of the second layer. When the second layer includes the resin and the low refractive index particles, and when the second layer includes the low refractive index resin, examples of a method for forming a second layer may include a method wherein the first layer is coated with a resin composition for a second layer, and cured. Also, when the second layer includes the low refractive index inorganic material, examples of a method for forming a second layer may include vacuum vapor deposition, and sputtering method.

### (b) First Layer

### (i) Properties of First Layer

The refractive index of the first layer is not particularly limited as long as it satisfies the ratio of the refractive index of the first layer with respect to the refractive index of the second layer described above, and is preferably, for example, 1.47 or more and 1.80 or less, more preferably 1.50 or more and 1.75 or less, and further preferably 1.53 or more and 1.70 or less. The refractive index of the first layer is usually higher than the refractive index of the second layer, and when the refractive index of the first layer is in the above range, the ratio of the refractive index of the first layer with respect to the refractive index of the second layer may be close to 1, so that the absolute value of the difference between yellowness YI1 and YI2 may be reduced. Since the refractive index of the first layer is in the above range, the difference from the refractive index of the substrate layer may be reduced, and the reflection of light on the interface of the first layer and the substrate layer may be suppressed.

The thickness of the first layer may also be similar to the first embodiment described above.

### (ii) Material of First Layer

The material of the first layer may be similar to the first embodiment described above.

(iii) Method for Forming First Layer

The method for forming a first layer may also be similar to the first embodiment described above.

### (c) Third Layer

In the present embodiment, a third layer, with a refractive index higher than the refractive index of the first layer and the refractive index of the second, may be placed between the first layer and the second layer. By stacking the first layer, the third layer and the second layer whose refractive indexes differ from each other, in this order, reflection of light may be suppressed by using the light interference effect caused by the thin film and the occurrence of interference fringe due to transmitted light may be suppressed.

In the present embodiment, magnitude relation of the refractive indexes of the first layer, the second layer, and the third layer is: refractive index of second layer<refractive index of first layer<refractive index of third layer. The refractive index of the third layer may be any refractive index as long as it is higher than the refractive index of the first layer and the refractive index of the second layer, and is preferably, for example, 1.55 or more and 2.50 or less, more preferably 1.60 or more and 2.20 or less, and further preferably 1.65 or more and 2.00 or less. When the refractive index of the third layer is in the above range, the reflectance may be easily adjusted by adjusting the refractive index and the thickness of the first layer, second layer, and third layer.

The thickness of the third layer is appropriately adjusted according to the refractive index of the third layer. The thickness of the third layer is preferably, for example, 20 nm or more and 500 nm or less, more preferably 30 nm or more and 300 nm or less, and further preferably 40 nm or more and 200 nm or less. When the thickness of the third layer is in the above range, the reflectance may be easily adjusted by adjusting the refractive index and the thickness of the first layer, second layer, and third layer. Also, when the thickness of the third layer is too thin, the film strength may be deteriorated.

The material of the third layer is not particularly limited as long as it is material capable of obtaining a third layer that satisfies the refractive index and the thickness described above. For example, the third layer may include resin and high refractive index particles with refractive index higher than the resin; may include a high refractive index resin with the refractive index described above; or may include a high refractive index inorganic materials with the refractive index described above.

When the third layer includes resin and high refractive index particles, the high refractive index particles are not particularly limited as long as it has refractive index higher than the refractive index of the resin, and it is capable of obtaining a third layer that satisfies the above refractive index. The high refractive index particles may be either inorganic particles or organic particles.

Examples of the inorganic particles may include zirconium oxide, silicon monoxide, hafnium oxide, tantalum oxide, niobium oxide, cerium oxide, titanium oxide, zinc oxide, aluminum oxide, magnesium oxide, yttrium oxide, lanthanum fluoride, and cerium fluoride.

Also, when the third layer includes the resin and the high refractive index particles, the resin may be similar to the first embodiment.

Also, when the third layer includes the high refractive index resin, the high refractive index resin may be any resin wherein the third layer including the high refractive index resin is able to satisfy the refractive index described above; and examples thereof may include cured resin cured by heat or irradiation of ionizing radiation such as ultraviolet rays or electron beams. Examples of the cured resin may include thermally cured resins and ionizing radiation cured resins. Also, examples of the ionizing radiation cured resin may include ultraviolet cured resins and electron beam cured resins.

Also, when the third layer includes the high refractive index inorganic material, the high refractive index inorganic material may be any inorganic material wherein the third layer including the high refractive index inorganic material is able to satisfy the refractive index described above; and examples thereof may include zirconium oxide, silicon monoxide, hafnium oxide, tantalum oxide, niobium oxide, cerium oxide, titanium oxide, zinc oxide, aluminum oxide, magnesium oxide, yttrium oxide, lanthanum fluoride, and cerium fluoride.

The third layer may include a photopolymerization initiator, when ultraviolet cured resins are used as the resin. Also, the third layer may include various additives according to the desired properties. The additives may be similar to the additives used for the second layer.

The method for forming the third layer is appropriately selected according to the material of the third layer. When the third layer includes the resin and the high refractive index particles, and when the third layer includes the high refractive index resin, examples of a method for forming a third layer may include a method wherein the first layer is coated with a resin composition for a third layer, and cured. Also, when the third layer includes the high refractive index inorganic material, examples of a method for forming a third layer may include vacuum vapor deposition, and sputtering method.

### 3. Substrate Layer

The substrate layer in the present embodiment is a member configured to support the first layer and the second layer, and has transparency.

The substrate layer is not particularly limited as long as it has transparency; and examples thereof may include a resin substrate, and a glass substrate.

### (1) Resin Substrate

The resin constituting the resin substrate is not particularly limited as long as it is able to obtain a resin substrate having transparency; and examples thereof may include a polyimide based resin, a polyamide based resin, and a polyester based resin. Examples of the polyimide based resin may include polyimide, polyamideimide, polyetherimide, and polyesterimide. Examples of the polyester based resin may include polyethylene terephthalate, polypropylene terephthalate, polybutylene terephthalate, and polyethylene naphthalate. Among them, from the viewpoint of having bending resistance, excellent hardness and transparency, the polyimide based resin, the polyamide based resin, or a mixture thereof is preferable, and the polyimide based resin is more preferable.

The polyimide based resin is not particularly limited as long as it is able to obtain a resin substrate having transparency; and among the above, polyimide and polyamideimide are preferably used. Flexibility and bending resistance may be increased, and since the refractive index is relatively high, it makes easier to adjust the reflectivity.

### (a) Polyimide

The polyimide is obtained by reacting a tetracarboxylic acid component and a diamine component. The polyimide is not particularly limited as long as it has transparency and stiffness; and it is preferable to have at least one kind of the structure selected from the group consisting of the structure represented by the following general formula (1) and the following general formula (3), for example, from the viewpoint of having excellent transparency and excellent stiffness.

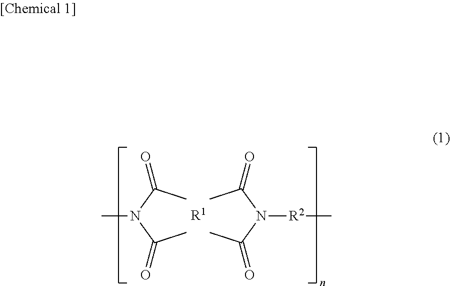

In the general formula (1), R¹ represents a tetravalent group which is a tetracarboxylic acid residue; and R² represents at least one kind of divalent group selected from the group consisting of a trans-cyclohexanediamine residue, a trans-1,4-bismethylenecyclohexanediamine residue, a 4,4′-diaminodiphenylsulfone residue, a 3,4′-diaminodiphenylsulfone residue, and a divalent group represented by the following general formula (2). The “n” represents the number of repeating units, and is 1 or more.

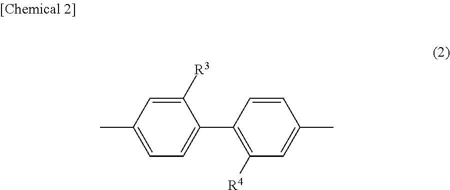

In the general formula (2), R³ and R⁴ each independently represents a hydrogen atom, an alkyl group, or a perfluoroalkyl group.

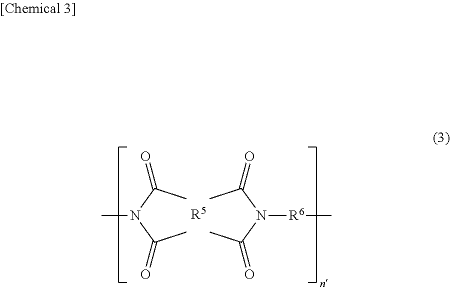

In the general formula (3), R⁵ represents at least one kind of tetravalent group selected from the group consisting of a cyclohexane tetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; and R⁶ represents a divalent group which is a diamine residue. The “n′” represents the number of repeating units, and is 1 or more.

Incidentally, “tetracarboxylic acid residue” refers to a residue obtained by excluding four carboxyl groups from a tetracarboxylic acid; and represents the same structure as a residue obtained by excluding an acid dianhydride structure from a tetracarboxylic acid dianhydride. Also, “diamine residue” refers to a residue obtained by excluding two amino groups from a diamine.

In the general formula (1), R¹ is a tetracarboxylic acid residue, and may be a residue obtained by excluding an acid dianhydride structure from a tetracarboxylic acid dianhydride. Examples of the tetracarboxylic acid dianhydride may include those described in WO 2018/070523. Among them, R¹ in the general formula (1) preferably includes at least one kind selected from the group consisting of a 4,4′-(hexafluoroisopropylidene)diphthalic acid residue, a 3,3′,4,4′-biphenyltetracarboxylic acid residue, pyromellitic acid residue, a 2,3′,3,4′-biphenyltetracarboxylic acid residue, a 3,3′,4,4′-benzophenone tetracarboxylic acid residue, a 3,3′,4,4′-diphenylsulfone tetracarboxylic acid residue, a 4,4′-oxydiphthalic acid residue, a cyclohexane tetracarboxylic acid residue, and a cyclopentane tetracarboxylic acid residue from the viewpoint of improved transparency and improved stiffness. It is further preferable to include at least one kind selected from the group consisting of a 4,4′-(hexafluoroisopropylidene)diphthalic acid residue, a 4,4′-oxydiphthalic acid residue and a 3,3′,4,4′-diphenylsulfone tetracarboxylic acid residue.

In R¹, these preferable residues are preferably included in total of 50 mol % or more, more preferably 70 mol % or more, and further preferably 90 mol % or more.

Also, as R¹, it is also preferable to use a mixture of the followings: a tetracarboxylic acid residue group (Group A) suitable for improving rigidity such as at least one kind selected from the group consisting of a 3,3′,4,4′-biphenyltetracarboxylic acid residue, a 3,3′,4,4′-benzophenone tetracarboxylic acid residue, and a pyromellitic acid residue; and a tetracarboxylic acid residue group (Group B) suitable for improving transparency such as at least one kind selected from the group consisting of a 4,4′-(hexafluoroisopropylidene)diphthalic acid residue, a 2,3′,3,4′-biphenyltetracarboxylic acid residue, a 3,3′,4,4′-diphenylsulfone tetracarboxylic acid residue, a 4,4′-oxydiphthalic acid residue, a cyclohexane tetracarboxylic acid residue, and a cyclopentanetetracarboxylic acid residue.

In this case, in relation to the content ratio of the tetracarboxylic acid residue group suitable for improving the rigidity (Group A) and the tetracarboxylic acid residue group suitable for improving transparency (Group B), with respect to 1 mol of the tetracarboxylic acid residue group suitable for improving transparency (Group B), the tetracarboxylic acid residue group suitable for improving rigidity (Group A) is preferably 0.05 mol or more and 9 mol or less, more preferably 0.1 mol or more and 5 mol or less, and further preferably 0.3 mol or more and 4 mol or less.

Among them, R² in the general formula (1) is preferably at least one kind of divalent group selected from the group consisting of a 4,4′-diaminodiphenylsulfone residue, a 3,4′-diaminodiphenylsulfone residue, and a divalent group represented by the general formula (2); and is further preferably at least one kind of divalent group selected from the group consisting of a 4,4′-diaminodiphenylsulfone residue, a 3,4′-diaminodiphenylsulfone residue, and a divalent group represented by the general formula (2) wherein R³ and R⁴ are a perfluoroalkyl group, from the viewpoint of improved transparency and improved stiffness.

Among them, from the viewpoint of improved transparency and improved stiffness, R⁵ in the general formula (3) preferably includes a 4,4′-(hexafluoroisopropylidene) diphthalic acid residue, a 3,3′,4,4′-diphenylsulfontetracarboxylic acid residue, and oxydiphthalic acid residue.

The R⁵ preferably includes 50 mol % or more, more preferably 70 mol % or more, and further preferably 90 mol % or more of these preferable residues.

The R⁶ in the general formula (3) is a diamine residue, and may be a residue obtained by excluding two amino groups from a diamine. Examples of the diamine may include those described in, for example, WO 2018/070523. Among them, from the viewpoint of improved transparency and improved stiffness, R⁶ in the general formula (3) preferably includes at least one kind of divalent group selected from the group consisting of a 2,2′-bis(trifluoromethyl)benzidine residue, a bis[4-(4-aminophenoxy)phenyl]sulfone residue, a 4,4′-diaminodiphenylsulfone residue, a 2,2-bis[4-(4-aminophenoxy)phenyl]hexafluoropropane residue, a bis[4-(3-aminophenoxy)phenyl]sulfone residue, a 4,4′-diamino-2,2′-bis(trifluoromethyl)diphenylether residue, a 1,4-bis[4-amino-2-(trifluoromethyl)phenoxy]benzene residue, a 2,2-bis[4-(4-amino-2-trifluoromethylphenoxy)phenyl]hexafluoropropane residue, a 4,4′-diamino-2-(trifluoromethyl)diphenyl ether residue, a 4,4′-diaminobenzanilide residue, a N,N′-bis(4-aminophenyl)terephthalamide residue and a 9,9-bis(4-aminophenyl)fluorene residue; and further preferably includes at least one kind of divalent group selected from the group consisting of a 2,2′-bis(trifluoromethyl)benzidine residue, a bis[4-(4-aminophenoxy)phenyl]sulfone residue, and a 4,4′-diaminodiphenylsulfone residue.

In R⁶, these preferable residues are preferably included in total of 50 mol % or more, more preferably 70 mol % or more, and further preferably 90 mol % or more.

Also, as R⁶, it is also preferable to use a mixture of the followings: a diamine residue group (Group C) suitable for improving rigidity such as at least one kind selected from the group consisting of a bis[4-(4-aminophenoxy)phenyl]sulfone residue, a 4,4′-diaminobenzanilide residue, a N,N′-bis(4-aminophenyl)terephthalamide residue, a paraphenylenediamine residue, a metaphenylenediamine residue, and a 4,4′-diaminodiphenylmethane residue; and a diamine residue group (Group D) suitable for improving transparency such as at least one kind selected from the group consisting of a 2,2′-bis(trifluoromethyl)benzidine residue, a 4,4′-diaminodiphenyl sulfone residue, a 2,2-bis[4-(4-aminophenoxy)phenyl]hexafluoropropane residue, a bis[4-(3-aminophenoxy)phenyl]sulfone residue, a 4,4′-diamino-2,2′-bis(trifluoromethyl)diphenylether residue, a 1,4-bis[4-amino-2-(trifluoromethyl)phenoxy]benzene residue, a 2,2-bis[4-(4-amino-2-trifluoromethylphenoxy)phenyl]hexafluoropropane residue, a 4,4′-diamino-2(trifluoromethyl)diphenylether residue, and a 9,9-bis(4-aminophenyl)fluorene residue.

In this case, in relation to the content ratio of the diamine residue group suitable for improving rigidity (Group C) and the diamine residue group suitable for improving transparency (Group D), with respect to 1 mol of the diamine residue group suitable for improving transparency (Group D), the diamine residue group suitable for improving rigidity (Group C) is preferably 0.05 mol or more and 9 mol or less, more preferably 0.1 mol or more and 5 mol or less, and further preferably 0.3 mol or more and 4 mol or less.

In the structure represented by the general formula (1) and the general formula (3), “n” and “n′” each independently represents the number of repeating units, and is 1 or more. The number of repeating units “n” in the polyimide may be appropriately selected according to the structure, and is not particularly limited. The average number of repeating units may be, for example, 10 or more and 2000 or less, and is preferably 15 or more and 1000 or less.

Also, the polyimide may include a polyamide structure in a part thereof. Examples of the polyamide structure that may be included may include a polyamideimide structure including a tricarboxylic acid residue such as trimellitic acid anhydride; and a polyamide structure including a dicarboxylic acid residue such as terephthalic acid.

From the viewpoint of improved transparency and improved surface hardness, at least one of the tetravalent group which is a tetracarboxylic acid residue of R¹ or R⁵, and the divalent group which is a diamine residue of R² or R⁶ preferably includes an aromatic ring; and preferably includes at least one selected from the group consisting of (i) a fluorine atom, (ii) an aliphatic ring, and (iii) a structure wherein aromatic rings are connected to each other by an alkylene group which may be substituted with a sulfonyl group or a fluorine. When the polyimide includes at least one kind selected from a tetracarboxylic acid residue including an aromatic ring, and a diamine residue including an aromatic ring, the molecular skeleton becomes rigid, the orientation property is increased, and the surface hardness is improved; however, the absorption wavelength of the rigid aromatic ring skeleton tends to be shifted to the longer wavelength side, and the transmittance of the visible light region tends to be decreased. Meanwhile, when the polyimide includes (i) a fluorine atom, the transparency is improved since it may make the electronic state in the polyimide skeleton to a state wherein a charge transfer is difficult.

Also, when the polyimide includes (ii) an aliphatic ring, transparency is improved since the transfer of charge in the skeleton may be inhibited by breaking the conjugation of n electrons in the polyimide skeleton. Also, when the polyimide includes (iii) a structure wherein aromatic rings are connected to each other by an alkylene group which may be substituted with a sulfonyl group or a fluorine, transparency is improved since the transfer of charge in the skeleton may be inhibited by breaking the conjugation of n electrons in the polyimide skeleton.

Among them, from the viewpoint of improved transparency and improved surface hardness, at least one of the tetravalent group which is a tetracarboxylic acid residue of R¹ or R⁵, and the divalent group which is a diamine residue of R² or R⁶ preferably includes an aromatic ring and a fluorine atom; and the divalent group which is a diamine residue of R² or R⁶ preferably includes an aromatic ring and a fluorine atom.

Specific examples of such polyimide may include those having a specific structure described in WO 2018/070523.

The polyimide may be synthesized by a known method. Also, a commercially available polyimide may be used. Examples of the commercially available products of polyimide may include Neopulim (registered trademark) from Mitsubishi Gas Chemical Company, Inc.

The weight average molecular weight of the polyimide is preferably, for example, 3000 or more and 500,000 or less, more preferably 5000 or more and 300,000 or less, and further preferably 10,000 or more and 200,000 or less. When the weight average molecular weight is too low, sufficient strength may not be obtained, and when the weight average molecular weight is too high, the viscosity is increased and the solubility is decreased, so that a substrate layer having a smooth surface and uniform thickness may not be obtained in some cases.

Incidentally, the weight average molecular weight of the polyimide may be measured by gel permeation chromatography (GPC). Specifically, the polyimide is used as a N-methylpyrrolidone (NMP) solution having a concentration of 0.1% by mass; a 30 mmol % LiBr-NMP solution with a water content of 500 ppm or less is used as a developing solvent; and measurement is carried out using a GPC device (HLC-8120, used column: GPC LF-804 from SHODEX) from Tosoh Corporation, under conditions of a sample injecting amount of 50 μL, a solvent flow rate of 0.4 mL/min, and at 37° C. The weight average molecular weight is determined on the basis of a polystyrene standard sample having the same concentration as that of the sample.

### (b) Polyamideimide

The polyamideimide is not particularly limited as long as it is able to obtain a resin substrate having transparency; and examples thereof may include those having a first block including a constituent unit derived from dianhydride, and a constituent unit derived from diamine; and a second block including a constituent unit derived from aromatic dicarbonyl compound, and a constituent unit derived from aromatic diamine. In the polyamideimide described above, the dianhydride may include, for example, biphenyltetracarboxylic acid dianhydride (BPDA) and 2-bis(3,4-dicarboxyphenyl)hexafluoropropanedianhydride (6FDA). Also, the diamine may include bistrifluoromethylbenzidine (TFDB). That is, the polyamideimide has a structure wherein a polyamideimide precursor including a first block wherein monomers including dianhydride and diamine are copolymerized; and a second block wherein monomers including an aromatic dicarbonyl compound and an aromatic diamine are copolymerized, is imidized. By including the first block including an imide bond and the second block including an amide bond, the polyamideimide is excellent in not only optical properties but also thermal and mechanical properties.

In particular, by using bistrifluoromethylbenzidine (TFDB) as the diamine forming the first block, thermal stability and optical properties may be improved. Also, by using 2-bis(3,4-dicarboxyphenyl)hexafluoropropane dianhydride (6FDA) and biphenyltetracarboxylic acid dianhydride (BPDA) as the dianhydride forming the first block, birefringence may be improved, and heat resistance may be secured.

The dianhydride forming the first block comprises two kinds of dianhydrides, that is, 6FDA and BPDA. In the first block, a polymer to which TFDB and 6FDA are bonded, and a polymer to which TFDB and BPDA are bonded may be included, based on separate repeating units, respectively segmented; may be regularly arranged within the same repeating unit; and may be included in a completely random arrangement.

Among the monomers forming the first block, BPDA and 6FDA are preferably included as dianhydrides in a molar ratio of 1:3 to 3:1. This is because it is possible not only to secure the optical properties, but also to suppress deterioration of mechanical properties and heat resistance, and it is possible to have excellent birefringence.

The molar ratio of the first block and the second block is preferably 5:1 to 1:1.

When the content of the second block is remarkably low, the effect of improving the thermal stability and mechanical properties due to the second block may not be sufficiently obtained in some cases. Also, when the content of the second block is higher than the content of the first block, although the thermal stability and mechanical properties may be improved, optical properties such as yellowness and transmittance, may be deteriorated, and the birefringence property may also be increased in some cases. Incidentally, the first block and the second block may be random copolymers, and may be block copolymers. The repeating unit of the block is not particularly limited.

Examples of the aromatic dicarbonyl compound forming the second block may include one kind or more selected from the group consisting of terephthaloyl chloride (p-terephthaloyl chloride, TPC), terephthalic acid, iso-phthaloyl dichloride, and 4,4′-benzoyl dichloride (4,4′-benzoyl chloride). One kind or more selected from terephthaloyl chloride (p-terephthaloyl chloride, TPC) and iso-phthaloyl dichloride may be preferably used.

Examples of the diamine forming the second block may include diamines including one kind or more flexible group selected from the group consisting of 2,2-bis(4-(4-aminophenoxy)phenyl)hexafluoropropane (HFBAPP), bis(4-(4-aminophenoxy)phenyl) sulfone (BAPS), bis(4-(3-aminophenoxy)phenyl)sulfone (BAPSM), 4,4′-diaminodiphenyl sulfone (4DDS), 3,3′-diaminodiphenyl sulfone (3DDS), 2,2-bis(4-(4-aminophenoxy)phenylpropane (BAPP), 4,4′-diaminodiphenylpropane (6HDA), 1,3-bis(4-aminophenoxy)benzene (134APB), 1,3-bis(3-aminophenoxy)benzene (133APB), 1,4-bis(4-aminophenoxy)biphenyl (BAPB), 4,4′-bis(4-amino-2-trifluoromethylphenoxy)biphenyl (6FAPBP), 3,3-diamino-4,4-dihydroxydiphenylsulfone (DABS), 2,2-bis(3-amino-4-hydroxyloxyphenyl)propane (BAP), 4,4′-diaminodiphenylmethane (DDM), 4,4′-oxydianiline (4-ODA) and 3,3′-oxydianiline (3-ODA).

When the aromatic dicarbonyl compound is used, it is easy to realize high thermal stability and mechanical properties, but may exhibit high birefringence due to the benzene ring in the molecular structure. Therefore, in order to suppress the decrease in birefringence due to the second block, it is preferable to use a diamine wherein a flexible group is introduced into the molecular structure. Specifically, the diamine is more preferably one kind or more diamine selected from bis(4-(3-aminophenoxy)phenyl)sulfone (BAPSM), 4,4′-diaminodiphenylsulfone (4DDS) and 2,2-bis(4-(4-aminophenoxy)phenyl)hexafluoropropane (HFBAPP). In particular, the longer the length of the flexible group such as BAPSM, and a diamine including a substituent group at meta position, the better the birefringence may be exhibited.

For the polyamideimide precursor including a first block wherein a dianhydride including a biphenyltetracarboxylic acid dianhydride (BPDA) and a 2-bis(3,4-dicarboxyphenyl)hexafluoropropanedianhydride (6FDA), and a diamine including bistrifluoromethylbenzidine (TFDB) are copolymerized; and a second block wherein an aromatic dicarbonyl compound and an aromatic diamine are copolymerized, in the molecular structure, the weight average molecular weight measured by GPC is preferably, for example, 200,000 or more and 215,000 or less, and the viscosity is preferably, for example, 2400 poise or more and 2600 poise or less.

The polyamideimide may be obtained by imidizing a polyamideimide precursor. Also, a polyamideimide film may be obtained using the polyamideimide.

For a method for imidizing the polyamideimide precursor and a method for producing a polyamideimide film, JP-A No. 2018-506611, for example, may be referred.

### (2) Glass Substrate

The glass constituting the glass substrate is not particularly limited as long as it has transparency; and examples thereof may include silicate glass and silica glass. Among them, borosilicate glass, aluminosilicate glass, and aluminoborosilicate glass are preferable, and alkali-free glass is more preferable. Examples of the commercial products of the glass substrate may include ultra-thin plate glass G-Leaf from Nippon Electric Glass Co., Ltd., and ultra-thin film glass from Matsunami Glass Ind., Ltd.

Also, the glass constituting the glass substrate is preferably a chemically strengthened glass. The chemically strengthened glass is preferable since it has excellent mechanical strength and may be made thin accordingly. The chemically strengthened glass is typically a glass wherein mechanical properties are strengthened by a chemical method by partially exchanging ionic species, such as by replacing sodium with potassium, in the vicinity of the surface of glass, and includes a compressive stress layer on the surface.

Examples of the glass constituting the chemically strengthened glass substrate may include aluminosilicate glass, soda-lime glass, borosilicate glass, lead glass, alkali barium glass, and aluminoborosilicate glass.

Examples of the commercial products of the chemically strengthened glass substrate may include Gorilla Glass from Corning Incorporated, Dragontrail from AGC Inc., and chemically strengthened glass from Schott Ag.

### (3) Constitution of Substrate Layer

The substrate layer may double as the first layer described above. When substrate layer doubles as the first layer, for example, it is necessary to have relatively high refractive index, and to improve flexibility and bending resistance, so that polyimide based resin, polyamide based resin, polyester based resin, and so on are preferably used.

The thickness of the substrate layer is not particularly limited as long as it has a thickness capable of having flexibility, and is appropriately selected according to the type of the substrate layer.

The thickness of the resin substrate is preferably, for example, 10 μm or more and 100 μm or less, and more preferably 25 μm or more and 80 μm or less. When the thickness of the resin substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

The thickness of the glass substrate is preferably, for example, 200 μm or less, more preferably 15 μm or more and 100 μm or less, further preferably 20 μm or more and 90 μm or less, and particularly preferably 25 μm or more and 80 μm or less. When the thickness of the glass substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

### 4. Other Layers

The stacked body for a display device in the present embodiment may include another layer, in addition to the substrate layer, the first layer and the second layer described above.

### (1) Hard Coating Layer

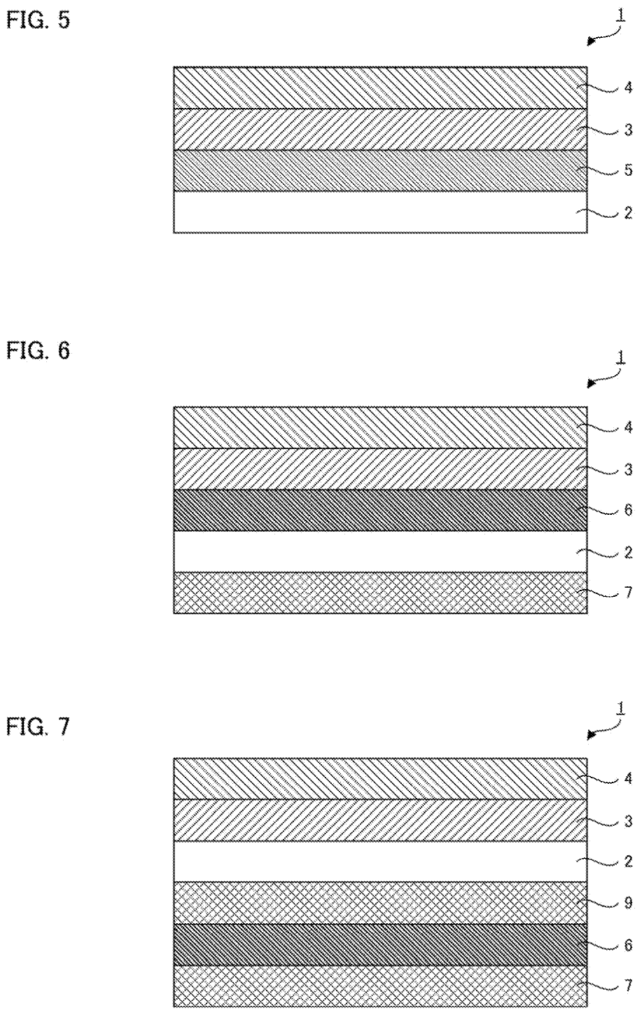

For example, as shown in FIG. 5, the stacked body for a display device in the present embodiment may include a hard coating layer 5 between the substrate layer 2 and the first layer 3. The hard coating layer is a member to enhance the surface hardness. By placing the hard coating layer, load resistance may be improved. Particularly, when the substrate layer is a resin substrate, the load resistance may be effectively improved by placing the hard coating layer.

The refractive index of the hard coating layer is not particularly limited as long as it satisfies the refractive index of the first layer described above, and is preferably, for example, 1.47 or more and 1.80 or less, more preferably 1.50 or more and 1.75 or less, and further preferably 1.53 or more and 1.70 or less. When the refractive index of the hard coating layer is in the above range, the difference from the refractive index of the substrate layer and the difference from the refractive index of the first layer may be reduced, and the reflection of light at the interface of the hard coating layer and the first layer and the reflection of light at the interface of the hard coating layer and the substrate layer may be suppressed.

As a material of the hard coating layer, for example, an organic material, an inorganic material, and an organic-inorganic composite material may be used.

Among the above, the material of the hard coating layer is preferably an organic material. As an organic material, for example, it is preferably a cured resin cured by heat or irradiation of ionizing radiation such as ultraviolet rays or electron beams. The cured resin may be similar to the cured resin used for the first layer and the second layer described above.

The hard coating layer may include a polymerization initiator if necessary. As the polymerization initiator, a radical polymerization initiator, a cation polymerization initiator, and a radical and cation polymerization initiator may be appropriately selected and used. These polymerization initiators are decomposed by at least one kind of light irradiation and heating to generate radicals or cations to cause radical polymerization and cation polymerization to proceed. Incidentally, all of the polymerization initiator may be decomposed and may not be left in the functional layer, in some cases.

The hard coating layer may include a photopolymerization initiator, when ultraviolet cured resins are used as the resin. Also, the hard coating layer may include various additives according to the desired properties. The additives may be similar to the additives used for the first layer and the second layer described above.

The thickness of the hard coating layer may be appropriately selected according to the function of the hard coating layer and the use application of the stacked body for a display device. The thickness of the hard coating layer is preferably, for example, 0.5 μm or more and 50 μm or less, more preferably 1.0 μm or more and 40 μm or less, further preferably 1.5 μm or more and 30 μm or less, and particularly preferably 2.0 μm or more and 20 μm or less. When the thickness of hard coating layer is in the above range, sufficient hardness as the hard coating layer may be obtained.

Examples of a method for forming a hard coating layer may include a method wherein the substrate layer is coated with a resin composition for a hard coating layer, and cured.

### (2) Impact Absorbing Layer

For example, the stacked body for a display device in the present embodiment may include an impact absorbing layer 6 between the substrate layer 2 and the first layer 3 as shown in FIG. 6, or on the substrate layer 2, on the opposite side surface to the first layer 3, for example, as shown in FIG. 7. By placing the impact absorbing layer, when an impact is imparted to the stacked body for a display device, the impact is absorbed so that the impact resistance may be improved. Also, when the substrate layer is a glass substrate, the crack of the glass substrate may be suppressed.

The material of the impact absorbing layer is not particularly limited as long as it is capable of obtaining an impact absorbing layer having an impact absorbing property, and transparency, and examples thereof may include polyethylene terephthalate (PET), polyethylene naphthalate (PEN), urethane resin, epoxy resin, polyimide, polyamideimide, acrylic resin, triacetyl cellulose (TAC), and silicone resin. One kind of these materials may be used alone, and two kinds or more may be used in combination.

The impact absorbing layer may further include an additive if necessary. Examples of the additive may include inorganic particles, organic particles, an ultraviolet absorber, an antioxidant, a light stabilizer, a surfactant, and an adhesive improving agent.

The thickness of the impact absorbing layer may be the thickness capable of absorbing an impact, and is preferably, for example, 5 μm or more and 150 μm or less, more preferably 10 μm or more and 120 μm or less, and further preferably 15 μm or more and 100 μm or less.

As the impact absorbing layer, for example, a resin film may be used. Also, for example, the impact absorbing layer may be formed by coating the substrate layer with a composition for an impact absorbing layer.

### (3) Adhesive Layer for Adhesion

For example, as shown in FIG. 6, the stacked body for a display device in the present embodiment may include adhesive layer for adhesion 7 on the substrate layer 2, on an opposite side surface to the first layer 3. The stacked body for a display device may be adhered to, for example, a display panel via the adhesive layer for adhesion.

The adhesive used for the adhesive layer for adhesion is not particularly limited as long as it is an adhesive having transparency, and is capable of adhering the stacked body for a display device to, for example, a display panel. Examples thereof may include a thermosetting adhesive, an ultraviolet curable adhesive, a two-component curable adhesive, a thermal fusion adhesive, and a pressure-sensitive adhesive (so-called tackiness agent).

Among the above, when the adhesive layer for adhesion 7, the impact absorbing layer 6, and the interlayer adhesive layer 9 described later are placed in the order as shown in FIG. 7, for example, the adhesive layer for adhesion and the interlayer adhesive layer preferably include the pressure-sensitive adhesive, that is, preferably pressure-sensitive adhesive layers. Generally, the pressure-sensitive adhesive layer is relatively a soft layer among the adhesive layers including the adhesives described above. The impact resistance may be improved by including the impact absorbing layer between the pressure-sensitive adhesive layers those are relatively soft. Since the pressure-sensitive adhesive layer is relatively soft so as to be easily deformed, the impact absorbing layer is easily deformed when an impact is applied to the stacked body for a display device because the deformation of the impact absorbing layer is not suppressed by the pressure-sensitive adhesive layer so that higher impact absorbing effect is believed to be exhibited.

The thickness of the adhesive layer for adhesion is preferably, for example, 10 μm or more and 100 μm or less, more preferably 25 μm or more and 80 μm or less, and further preferably 40 μm or more and 60 μm or less. When the thickness of the adhesive layer for adhesion is too thin, the stacked body for a display device and the display panel may not be adhered sufficiently. Also, when the thickness of the adhesive layer for adhesion is too thick, the flexibility may be deteriorated.

As the adhesive layer for adhesion, for example, an adhesive film may be used. Also, for example, the adhesive layer for adhesion may be formed by coating a supporting body or the substrate layer, for example, with an adhesive composition.

### (4) Antifouling Layer

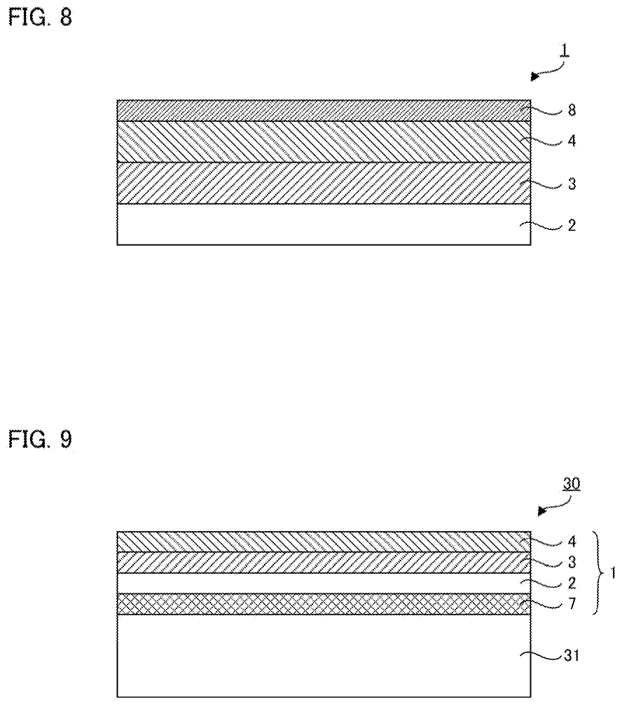

For example, as shown in FIG. 8, the stacked body for a display device in the present embodiment may include an antifouling layer 8 on the second layer 4, on an opposite side surface to the first layer 3. By placing the antifouling layer, antifouling property may be imparted to the stacked body for a display device. Incidentally, in the present embodiment, since the thickness of the antifouling layer is relatively thin as described later, it is inferred that it does not affect the thin film interference.

As the material of the antifouling layer, general antifouling layer materials such as fluorine compounds and silicone compounds may be applied.

In the present embodiment, fluorine compounds are preferable from the viewpoint of providing antifouling property and transparency which makes it possible to wipe fingerprints and dirt adhered to the first display region and the second display region repeatedly, and maintaining the visibility of the image in the usage mode where images of the first display region and second display region are observed in a folded state.

The examples of the fluorine compound may include fluorine compound including a reactive functional group such as a (meta)acrylloyl group, a vinyl group, an epoxy group, an oxetanyl group, and an ethylene unsaturated bond group; fluorine compounds including a reactive functional group and silicon. Examples thereof may include fluorine compounds including a fluoroalkylene group in the main chain; fluorine compounds including a fluoroalkylene group in the main chain and the side chain; fluorine compounds including a fluoroalkyl group; fluorine compound including a siloxane bond; fluorine compounds including a silicone including a reactive functional group; fluorine compounds including a reactive functional group and a perfluoropolyether group; and fluorine compounds including a silane unit including perfluoropolyether group.

Among the above, in the present embodiment, it is preferable to use fluorine compounds including a silane unit including perfluoropolyether group.

The thickness of the antifouling layer is preferably, for example, 1 nm or more and 30 nm or less, more preferably 2 nm or more and 20 nm or less, and further preferably 3 nm or more and 10 nm or less. When the thickness of the antifouling layer is in the above range, the antifouling property and durability may be improved.

A method for forming an antifouling layer may be appropriately selected according to the material of the antifouling layer, and examples thereof may include a method wherein the second layer is coated with a resin composition for an antifouling layer, and cured; a vacuum vapor deposition method; and a sputtering method.

### (5) Interlayer Adhesive Layer

In the stacked body for a display device in the present embodiment, an interlayer adhesive layer may be placed between each layer.

The adhesive used for the interlayer adhesive layer may be similar to the adhesive used for the adhesive layer for adhesion.

The thickness of the interlayer adhesive layer, and the forming method, for example, may be similar to the thickness, and the forming method, for example, of the adhesive layer for adhesion.

### 5. Use Application of Stacked Body for Display Device

The stacked body for a display device in the present embodiment may be used as a front panel placed on the observer side than the display panel in a display device. Among the above, the stacked body for a display device in the present embodiment may be preferably used as a front panel in a flexible display device such as a foldable display, a rollable display, and a bendable display. Particularly, in the stacked body for a display device in the present embodiment, it is suitably used for the front panel in a foldable display, since it improves the visibility in the usage mode where an image is observed with the display device folded.

Also, the stacked body for a display device in the present embodiment may be used as a front panel in a display device such as smart phones, tablet terminals, wearable terminals, personal computers, televisions, digital signages, public information displays (PIDs), and car mounted displays.

### B. Display Device

The display device in the present embodiment comprises: a display panel, and the stacked body for a display device described above placed on an observer side of the display panel.

FIG. 9 is a schematic cross-sectional view illustrating an example of a display device in the present embodiment. As shown in FIG. 9, display device 30 comprises display panel 31, and the stacked body for a display device 1 placed on an observer side of the display panel 31. In the display device 30, the stacked body for a display device 1 and the display panel 31 may be adhered via, for example, the adhesive layer for adhesion 7 of the stacked body for a display device 1.

When the stacked body for a display device in the present embodiment is placed on the surface of the display device, it is placed so that the second layer is on the outer side, and the substrate layer is on the inner side.

The method for placing the stacked body for a display device in the present embodiment on the surface of the display device is not particularly limited, and examples thereof may include a method via an adhesive layer.

Examples of the display panel in the present embodiment may include a display panel used for a display device such as an organic EL display device, and a liquid crystal display device.

The display device in the present embodiment may include a touch-sensitive panel member between the display panel and the stacked body for a display device.

Among the above, the display device in the present embodiment is preferably a flexible display device such as a foldable display, a rollable display, and a bendable display.

Also, the display device in the present embodiment is preferably foldable. That is, the display device in the present embodiment is preferably a foldable display. The stacked body for a display device in the present embodiment is excellent in visibility in the usage mode where an image is observed with the display device folded, so that it is suitable for a foldable display.

### II. Second Embodiment

Secondly, a stacked body for a display device and a display device in the second embodiment are hereinafter described.

### A. Stacked Body for Display Device

The stacked body for a display device in the present embodiment comprises a substrate layer; and a functional layer, wherein a luminous reflectance of regular reflection light, when light is entered to a functional layer side surface of the stacked body for a display device with incident angle of 60°, is 10.0% or less; and after a surface modification of a functional layer side surface of the stacked body for a display device, a maximum load at which the functional layer is not peeled off, when a steel wool test is carried out, is 1.0 kg/cm² or more and 2.0 kg/cm² or less, wherein, in the steel wool test, the functional layer side surface of the stacked body for a display device is rubbed with a #0000 steel wool, for 100 strokes, applying a predetermined load.

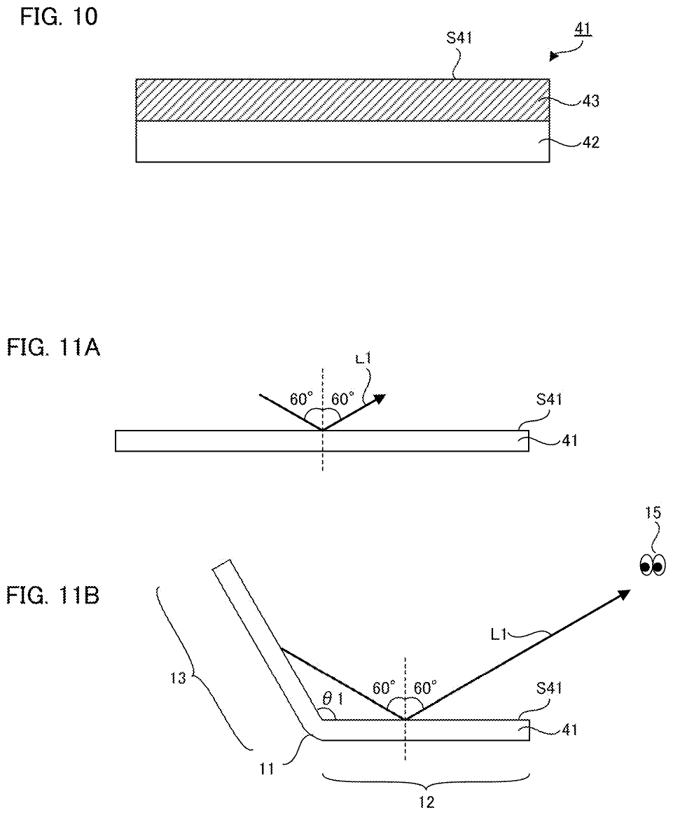

FIG. 10 is a schematic cross-sectional view illustrating an example of a stacked body for a display device in the present embodiment. As shown in FIG. 10, the stacked body for a display device 41 comprises a substrate layer 42, and a functional layer 43. Also, as illustrated in FIG. 11A, the luminous reflectance of regular reflection light L1, when light is entered to a functional layer side surface S41 of the stacked body for a display device 41 with incident angle of 60°, is a predetermined value or less. Also, although not shown in the figures, after a surface modification of a functional layer 43 side surface S41 of the stacked body for a display device 41, a maximum load at which the functional layer 43 is not peeled off, when a steel wool test is carried out, is in a predetermined range, wherein, in the steel wool test, the functional layer 43 side surface S41 of the stacked body for a display device 41 is rubbed with a #0000 steel wool, for 100 strokes, applying a predetermined load.

In the present embodiment, as an indicator to evaluate the hardness and close adhesiveness of the functional layer, the maximum load at which the functional layer is not peeled off, when the steel wool test is carried out on the functional layer side surface of the stacked body for a display device, after surface modification, is used. When the hardness of the functional layer is low, or when the close adhesiveness of the functional layer is low, the maximum load tends to decrease. Meanwhile, when the hardness of the functional layer is high, or when the close adhesiveness of the functional layer is high, the maximum load tends to increase. If the close adhesiveness of the functional layer is insufficient, when the stacked body for a display device is folded repeatedly, the bent portion may be lifted. Meanwhile when the hardness of the functional layer is too high, or when the close adhesiveness of the functional layer is excessive, a crack or a fracture may occur in the bent portion, when the stacked body for a display device is folded repeatedly.

In the present embodiment, since the maximum load at which the functional layer is not peeled off, when a steel wool test is carried out on the functional layer side surface of the stacked body for a display device, after surface modification, is a predetermined value or more, when the stacked body for a display device is folded repeatedly, the bent portion may be suppressed from being lifted. Also, since the maximum load at which the functional layer is not peeled off, when a steel wool test is carried out on the functional layer side surface of the stacked body for a display device, after surface modification, is a predetermined value or less, occurrence of a crack or a fracture in the bent portion may be suppressed. Therefore, when the stacked body for a display device is used for a flexible display, it is possible to improve the visibility of images and characters in the bent portion.

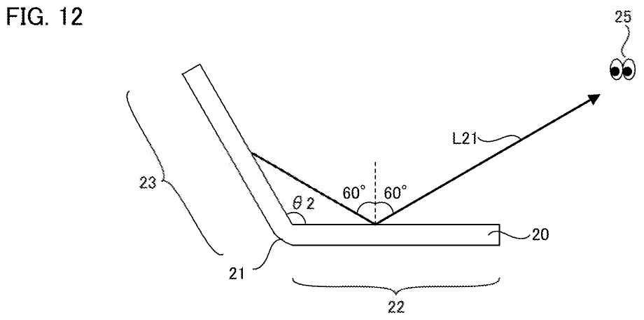

Here, for a foldable display, for example, usage mode where an image is observed in a folded state, is assumed. As shown in FIG. 12 for example, in such the usage mode, the foldable display 20 will have the first display region 22 and the second display region 23 with the bent portion 21 on the boundary thereof. In such case, images and characters displayed in the second display region 23 may be reflected in the first display region 22, and images and characters displayed in the first display region 22 may be reflected in the second display region 23, resulting in a problem of a decrease in the visibility of images and characters. This is not limited to foldable displays, and the same problem occurs when an image is observed in a folded state on a flexible display.

Meanwhile, in the present embodiment, since the luminous reflectance of the regular reflection light L1 when light is entered to the functional layer side surface S41 of the stacked body for a display device 41 with an incident angle of 60° is the predetermined value or less, when the stacked body for a display device is used for a flexible display, images and characters displayed in one display region may be suppressed from being reflected in the other display region, when an image is observed in a folded state on a flexible display.

For example, when an image is observed in a folded state on a foldable display, the angle θ2 between the first display region 22 and the second display region 23, as illustrated in FIG. 12, is likely to be set to be greater than 90° and less than 180° from the viewpoint of the visibility of the displayed images and characters, and specifically, it may be set to approximately 120°. When the stacked body for a display device is placed on the observer 25 side surface of such a foldable display 20, for example, as shown in FIG. 11B, the stacked body for a display device 41 will have the first region 12 and the second region 13 with the bent portion 11 on the boundary thereof, and the angle θ1 between the first region 12 and the second region 13 will be similar to the angle θ2.

For example, in FIG. 11B, when the luminous reflectance of the regular reflection light L1 when light is entered to the functional layer side surface S41 of the stacked body for a display device 41 with an incident angle of 60° is the predetermined value or less, in the foldable display 20 illustrated in FIG. 12, the light from the second display region 23 corresponding to the second region 13 of the stacked body for a display device 41 may be suppressed from being reflected in the first display region 22 corresponding to the first region 12 of the stacked body for a display device 41. Therefore, when the stacked body for a display device in the present embodiment is used for a flexible display, images and characters displayed in one display region may be suppressed from being reflected in the other display region, when the image is observed in a folded state on a flexible display. Therefore, it is possible to improve the visibility in the usage mode where an image is observed with the display device folded.

Incidentally, in the present embodiment, as shown in FIG. 12 for example, when an image is observed in a folded state on the foldable display 20, as described above, the luminous reflectance of regular reflection light, when the incident angle is 60°, is employed in view of the followings: the angle θ2 between the first display region 22 and the second display region 23 is likely to be set to be greater than 90° and less than 180° from the viewpoint of the visibility of the displayed images and characters, and specifically, it may be set to approximately 120°; when an image is observed with the foldable display 20 folded, the observer 25 tends to observe the image displayed in the first display region 22 and the second display region 23 by moving only the line of sight without changing the observation position; and even on an identical surface, the reflection increases as the incident angle increases. The luminous reflectance of regular reflection light, when the incident angle is 60°, represents the luminous reflectance when light from one display region is reflected in the other display region, when an image is observed with the flexible display folded.

Incidentally, in FIG. 12, the sign L21 indicates the light emitted from the second display region 23 and reflected in the first display region 22.

Therefore, when the stacked body for a display device in the present embodiment is used for a display device, among them, for a flexible display, it is possible to improve the visibility in the usage mode where an image is observed with the display device folded as well as to improve the visibility of images and characters in the bent portion.

Each constitution of the stacked body for a display device in the present embodiment is hereinafter described.

### 1. Properties of Stacked Body for Display Device

In the present embodiment, the luminous reflectance of regular reflection light, when light is entered to a functional layer side surface of the stacked body for a display device with incident angle of 60°, is 10.0% or less, preferably 9.5% or less, and more preferably 9.0% or less. Since the luminous reflectance of regular reflection light when the incident angle is 60° is in the above range, when the stacked body for a display device in the present embodiment is used for a flexible display, images and characters displayed in one display region may be suppressed from being reflected in the other display region, when the image is observed in a folded state on a flexible display. The lower the luminous reflectance of regular reflection light when the incident angle is 60°, the better, so that the lower limit is not particularly limited; and for example, the lower limit may be 0.1% or more. The luminous reflectance of regular reflection light when the incident angle is 60° is preferably 0.1% or more and 10.0% or less, more preferably 0.5% or more and 9.5% or less, and further preferably 1.0% or more and 9.0% or less.

Also, the luminous reflectance of regular reflection light, when light is entered to the functional layer side surface of the stacked body for a display device with incident angle of 5°, is preferably, for example, 0.1% or more and 4.0% or less, more preferably 0.5% or more and 3.5% or less, and further preferably 1.0% or more and 3.0% or less. Since the luminous reflectance of regular reflection light when the incident angle is 5° is in the above range, when the image is observed in a state where the stacked body for a display device in the present embodiment is not folded, that is, for example, in a state where angle θ2 in FIG. 12 is 180°, the difference of the image color in one display region and the other display region may be decreased so that the color change may be suppressed, while suppressing the observer oneself being reflected in the display region.

Here, the luminous reflectance may be determined according to JIS Z8722:2009. The specific method is similar to the method described in “A. Stacked body for display device 1. Properties of stacked body for display device” in the first embodiment described above.

Examples of the way to reduce the luminous reflectance of the regular reflection light, when light is entered to the functional layer side surface of the stacked body for a display device with incident angle of 60°, may include (1-1) to set the refractive index of the functional layer relatively low; (1-2) to make the functional layer a multilayer wherein films having different refractive index are stacked; and (1-3) to adjust the refractive index of the functional layer, and to adjust the refractive index of the layer in contact with the substrate layer side surface of the functional layer.

When (1-1) the refractive index of the functional layer is set relatively low, the difference between the refractive index of the functional layer and the refractive index of air may be reduced, since the refractive index of the functional layer is relatively low, the reflection of light on the functional layer side surface of the stacked body for a display device may be suppressed, thereby reducing luminous reflectance of regular reflection light when the incident angle is 60°. Examples of the method to set the refractive index of the functional layer relatively low may include a method to compound a low refractive index inorganic material with low refractive index into the functional layer; or to compound a resin and a low refractive index particle with refractive index lower than the resin, into the functional layer.

Also, when (1-2) making the functional layer a multilayer wherein films having different refractive index are stacked, since the functional layer is a multilayer wherein films having different refractive index are stacked, light reflection may be suppressed by utilizing the light interference caused by the thin film, thereby decreasing the luminous reflectance of regular reflection light when the incident angle is 60°.

Also, when (1-3) adjusting the refractive index of the functional layer, and the refractive index of the layer in contact with the substrate layer side surface of the functional layer, by adjusting the refractive index of the functional layer, and the refractive index of the layer in contact with the substrate layer side surface of the functional layer, light reflection may be suppressed by utilizing the light interference caused by the thin film, thereby decreasing the luminous reflectance of regular reflection light when the incident angle is 60°. In this case, examples of the layer in contact with the substrate layer side surface of the functional layer may include a substrate layer. Also, for example, when a second functional layer is placed between the substrate layer and the functional layer, the second functional layer may be a layer in contact with the substrate layer side surface of the functional layer. Also, for example, when a hard coating layer is placed between the substrate layer and the functional layer, the hard coating layer may be a layer in contact with the substrate layer side surface of the functional layer.

Also, in the present embodiment, after a surface modification of a functional layer side surface of the stacked body for a display device, a maximum load at which the functional layer is not peeled off, when a steel wool test is carried out, is 1.0 kg/cm² or more, preferably 1.1 kg/cm² or more, and more preferably 1.3 kg/cm² or more. Since the maximum load is in the above range, when the stacked body for a display device is folded repeatedly, the bent portion may be suppressed from being lifted. Also, the maximum load is 2.0 kg/cm² or less, preferably 1.9 kg/cm² or less, and more preferably 1.7 kg/cm² or less.

Since the maximum load is in the above range, when the stacked body for a display device is folded repeatedly, occurrence of a crack or a fracture in the bent portion may be suppressed. The maximum load is 1.0 kg/cm² or more and 2.0 kg/cm² or less, preferably 1.1 kg/cm² or more and 1.9 kg/cm² or less, and more preferably 1.3 kg/cm² or more and 1.7 kg/cm² or less.

Incidentally, in the present embodiment, when carrying out a steel wool test on the functional layer side surface of the stacked body for a display device, a surface modification is carried out on the functional layer side surface of the stacked body for a display device, before the steel wool test. This is to align the surface condition of the functional layer side surface of the stacked body for a display device, regardless of the configuration of the stacked body for a display device. By carrying out the surface modification, the surface condition may be aligned to a condition with higher surface tension, and the close adhesiveness of functional layer with different surface condition may be appropriately evaluated. Also, it is preferable to carry out the steel wool test immediately after the surface modification has been carried out on the stacked body for a display device, since the effect of the surface modification may diminish over time, depending on the method of the surface modification.

Here, examples of a method for a surface modification may include a corona discharge treatment. The specific conditions for the corona discharge treatment are shown below.
Output voltage: 14 kV
Distance from the functional layer side surface of the stacked body for a display device to the electrode of the corona discharge treatment device: 2 mm
Moving speed of the corona discharge treatment device stage: 30 mm/sec

Also, for example, the corona discharge surface modification device “Corona Scanner ASA-4” from Shinko Electric & Instrumentation Co., Ltd. may be used as a corona discharge treatment device.

Also, the method for a surface modification may be, for example, a surface treatment such that the contact angle of the functional layer side surface of the stacked body for a display device, with respect to water, is 30° or more and 80° or less. Examples of such surface treatment may include a corona discharge treatment and a plasma treatment.

Incidentally, the contact angle of the functional layer side surface of the stacked body for a display device, with respect to water, may be determined by θ/2 method. Specifically, at 20° C. and 50% RH, 2 μL of pure water is dripped onto the functional layer side surface of the stacked body for a display device, and the static contact angle, of 5 seconds after the droplets reach the surface, is determined. For example, a fully automatic contact angle meter “DropMaster 700” from Kyowa Interface Science Co., Ltd. may be used as a contact angle meter.

Also, the steel wool test may be carried out by the following method. That is, using #0000 steel wool, the steel wool is fixed to a 1 cm×1 cm jig, the functional layer side surface of the stacked body for a display device is rubbed for 100 strokes under conditions of applied load of 100 g/cm² or more, traveling speed of 100 mm/sec and traveling distance of 50 mm. In the test, the load is increased by 100 g/cm² from 100 g/cm² to determine the maximum load at which the functional layer is not peeled off. Also, as the #0000 steel wool, Bonstar #0000 from Nippon Steel Wool Co., Ltd. may be used. Also, as a tester, for example, Color Fastness Rubbing Tester AB-301 from Tester Sangyo Co., Ltd. may be used. Incidentally, the steel wool test is carried out under the condition wherein a stacked body for a display device having a size of, for example, 5 cm×10 cm is fixed on a glass plate with cellophane tape so that there is no bend or wrinkle.

Examples of a method to make the maximum load at which the functional layer is not peeled off, when the predetermined steel wool test is carried out after a surface modification is carried out on the functional layer side surface of the stacked body for a display device, in a predetermined range may include a method wherein the hardness and close adhesiveness of the functional layer is adjusted. Examples of the method for adjusting the hardness and close adhesiveness of the functional layer may include placing a second functional layer between the substrate layer and the functional layer; and adjusting the thickness of the functional layer. Also, as the method for adjusting the hardness and close adhesiveness of the functional layer, the following methods may be combined: placing a second functional layer between the substrate layer and the functional layer; adjusting the thickness of the functional layer; applying surface treatment to the layer in contact with the substrate layer side surface of the functional layer; and adjusting the material of the functional layer.

In a case wherein a second functional layer is placed between the substrate layer and the functional layer, for example, if the substrate layer is a resin substrate and the functional layer is an inorganic film, although the hardness of the functional layer (inorganic film) is high, the close adhesiveness of the functional layer (inorganic film) to the substrate layer (resin substrate) tends to be low, and the maximum load tends to be low; however, by placing the second functional layer between the substrate layer and the functional layer, and compounding resin and inorganic particles in the second functional layer, the close adhesiveness of the functional layer may be improved compared to the above, so that the maximum load may be increased to be in the predetermined range. Also, for example, in a case wherein the substrate layer is a glass substrate and the functional layer is an inorganic film, although the hardness of the functional layer (inorganic film) is high, the close adhesiveness of the functional layer (inorganic film) to the substrate layer (glass substrate) tends to be too high, and the maximum load tends to be too high; however, by placing the second functional layer between the substrate layer and the functional layer, and compounding resin and inorganic particles in the second functional layer, the close adhesiveness of the functional layer may be moderately reduced compared to the above, so that the maximum load may be reduced moderately to be in the predetermined range.

Also, in a case wherein the thickness of the functional layer is adjusted, if the thickness of the functional layer is thin, the hardness of the functional layer is lower and the close adhesiveness of the functional layer is lower; meanwhile, when the thickness of the functional layer is thick, the hardness of the functional layer tends to increase and the close adhesiveness of the functional layer tends to increase.

Also, in a case wherein applying surface treatment to the layer in contact with the substrate layer side surface of the functional layer; and adjusting the material of the functional layer, are combined, the close adhesiveness of the functional layer may be increased, so that the maximum load may be increased to be in the predetermined range, for example, by setting the hardness of the functional layer high by adjusting the material of the functional layer, as well as applying a surface treatment to the layer in contact with the substrate layer side surface of the functional layer. In this case, examples of the layer in contact with the substrate layer side surface of the functional layer may include a substrate layer. Also, for example, when a second functional layer is placed between the substrate layer and the functional layer, the second functional layer may be a layer in contact with the substrate layer side surface of the functional layer. Also, for example, when a hard coating layer is placed between the substrate layer and the functional layer, the hard coating layer may be a layer in contact with the substrate layer side surface of the functional layer.

The total light transmittance, haze, and bending resistance of the stacked body for a display device in the present embodiment are similar to those described in the column of “A. Stacked body for a display device 1. Properties of stacked body for display device” in the first embodiment above, the explanation is omitted herein.

### 2. Functional Layer

The functional layer in the present embodiment is a layer placed on one surface of the substrate layer.

In the present embodiment, the functional layer may function as a low reflection film. The functional layer may be a single layer, and may be a multilayer. The present embodiment is hereinafter described by dividing thereof into the following cases: a case wherein the functional layer is a single layer, and a case wherein the functional layer is a multilayer.

### (1) Case Wherein Functional Layer is Single Layer

When the functional layer is a single layer, the refractive index of the functional layer is preferably, for example, 1.40 or more and 1.50 or less. Here, as described later, for example, a resin substrate or a glass substrate may be used as the substrate layer; the refractive index of general resin is approximately 1.5, and the refractive index of general glass is also approximately 1.5. Since the refractive index of the functional layer is in the above range, the difference from the refractive index of air may be reduced, and the reflection of light on the functional layer side surface of the stacked body for a display device may be suppressed. Also, since the refractive index of the functional layer is in the above range, the difference between the refractive index of the functional layer and the refractive index of the substrate layer may be increased, and the reflection of light on the functional layer side surface may be suppressed by the thin film interference between the regular reflection light from the interface between the functional layer and the substrate layer, and the regular reflection light of the functional layer side surface. Therefore, the luminous reflectance of regular reflection light when the incident angle is 60° may be decreased.

When the functional layer is a single layer, the refractive index of the functional layer is preferably, for example, 1.40 or more, more preferably 1.43 or more, and further preferably 1.45 or more. Since the refractive index of the functional layer is in the above range, the difference between the refractive index of the functional layer and the refractive index of the substrate layer, and the difference between the refractive index of the functional layer and the refractive index of the layer in contact with the substrate layer side surface of the functional layer may be increased, and the reflection of light may be suppressed by using the light interference caused by the thin film. Also, when the functional layer is a single layer, the refractive index of the functional layer is preferably, for example, 1.50 or less, more preferably 1.49 or less, and further preferably 1.48 or less. Since the refractive index of the functional layer is in the above range, the difference from the refractive index of air may be reduced, and the reflection of light on the functional layer side surface of the stacked body for a display device may be suppressed. When the functional layer is a single layer, the refractive index of the functional layer is preferably, for example, 1.40 or more and 1.50 or less, more preferably 1.43 or more and 1.49 or less, and further preferably 1.45 or more and 1.48 or less.

Here, the refractive index of each layer is the refractive index with respect to light with a wavelength of 550 nm. Examples of the method for measuring the refractive index may include a method measuring with an ellipsometer. Examples of the ellipsometer may include “UVSEL” from Jobin Yvon and “DF1030R” from Techno-Synergy, Inc.

Also, the thickness of the functional layer is appropriately adjusted according to the refractive index of the functional layer. When the functional layer is a single layer, the thickness of the functional layer is preferably, for example, 50 nm or more, more preferably 60 nm or more, and further preferably 70 nm or more. When the thickness of the functional layer is too thin, the hardness and close adhesiveness of the functional layer decreases, so that the maximum load at which the functional layer is not peeled off when the steel wool test is carried out after the surface modification described above is too low, and a lift may occur in the bent portion when folded repeatedly. Also, when the functional layer is a single layer, the thickness of the functional layer is preferably, for example, 140 nm or less, more preferably 130 nm or less, and further preferably 120 nm or less. When the thickness of the functional layer is too thick, the close adhesiveness of the functional layer is excessive, so that, when the steel wool test is carried out after the surface modification described above, the maximum load at which the functional layer is not peeled off is too high, and a crack or a fracture may occur in the bent portion, when folded repeatedly. When the functional layer is a single layer, the thickness of the functional layer is preferably, for example, 50 nm or more and 140 nm or less, more preferably 60 nm or more and 130 nm or less, and further preferably 70 nm or more and 120 nm or less.

Here, the thickness of the functional layer is a value obtained by measuring from the thickness directional cross-section of the stacked body for a display device by observing with a transmission electron microscope (TEM), a scanning electron microscope (SEM) or a scanning transmission electron microscope (STEM), and may be the average value of the thickness of arbitrary selected 10 points. Incidentally, the same may be applied to the measuring methods of the thickness of other layers included in the stacked body for a display device.

The material of the functional layer is not particularly limited as long as it is material satisfying the maximum load at which the functional layer is not peeled off when the steel wool test is carried out after the surface modification described above, and it is capable of obtaining a functional layer that satisfies the above refractive index. The functional layer may be, for example, any one of an inorganic film and an organic-inorganic mixed film. When the functional layer is an inorganic film, the functional layer may include, for example, a low refractive index inorganic material with the refractive index described above. Also, when the functional layer is an organic-inorganic mixed film, the functional layer may include, for example, resin and low refractive index particles with refractive index lower than the resin.

Among the above, the functional layer is preferably an inorganic film. Compared to an organic-inorganic mixed film or an organic film, the hardness of the inorganic film tends to be high, so that a functional layer satisfying the maximum load at which the functional layer is not peeled off when the steel wool test is carried out after the surface modification described above, may be easily obtained.

When the functional layer includes the low refractive index inorganic material, the low refractive index inorganic material is not particularly limited as long as the functional layer including the low refractive index inorganic material satisfies the maximum load at which the functional layer is not peeled off when the steel wool test is carried out after the surface modification described above, and it is inorganic material capable of satisfying the above refractive index; and examples thereof may include silicon dioxide (silica), magnesium fluoride, lithium fluoride, calcium fluoride and barium fluoride. Among the above, silicone dioxide (silica) is preferable.

Also, when the functional layer includes resin and low refractive index particles, the low refractive index particles are not particularly limited as long as it has refractive index lower than the refractive index of the resin, and it is capable of obtaining a functional layer that satisfies the above refractive index.

The low refractive index particles may be either inorganic particles or organic particles. Examples of the inorganic particles may include inorganic particles such as silicon dioxide (silica), magnesium fluoride, lithium fluoride, calcium fluoride and barium fluoride. Among the above, the silica particles are preferable.

Also, the low refractive index particles may be any one of, for example, solid particles, hollow particles, porous particles, and hollow particles and porous particles are preferable for their low refractive index. Examples of the hollow particles and porous particles may include porous silica particles, hollow silica particles, porous polymer particles, and hollow polymer particles.

Also, the low refractive index particles may be subjected to a surface treatment. By subjecting the low refractive index particles to a surface treatment, affinity with resins and solvents is improved, ensures uniform dispersion of the low refractive index particles, and prevents aggregation between the low refractive index particles so that the decrease in transparency of the functional layer, the applicability of the resin composition for a functional layer, and the film strength may be suppressed.

Examples of the surface treatment method may include a surface treatment using silane coupling agents. The specific silane coupling agent may be similar to the silane coupling agents disclosed in Japanese Patent Application Laid-Open (JP-A) No. 2013-142817, for example.

Also, the low refractive index particles may be reactive particles with a polymerizable functional group on its surface. Examples of the low refractive index particles those are the reactive particles may include those used for the low refractive index layer described in Japanese Patent Application Laid-Open (JP-A) No. 2013-142817.

The average particle size of the low refractive index particles may be the thickness of the functional layer or less, and it may be for example, 200 nm or less, and may be 100 nm or less. Also, the average particle size of the low refractive index particles may be, for example, 5 nm or more, may be 10 nm or more, may be 30 nm or more, and may be 50 nm or more. When the average particle size of the low refractive index particles is in the above range, good dispersion condition of the low refractive index particles may be obtained without deteriorating the transparency of the functional layer. Incidentally, when the average particle size of the low refractive index particles is in the above range, the average particle size may be either the primary particle size or the secondary particle size, and the low refractive index particles may be connected in the form of chain.

Here, the average particle size of the low refractive index particles is the average value of 20 particles observed by transmission electron microscopy (TEM) images of the cross-section of the functional layer.

The shape of the low refractive index particles is not particularly limited, and examples thereof may include spherical shape, chain shape, and needle shape.

Also, when the functional layer includes resin and low refractive index particles, the resin is not particularly limited as long as it is resin capable of obtaining a functional layer satisfying the maximum load at which the functional layer is not peeled off when the steel wool test is carried out after the surface modification described above; among the above, a cured resin cured by heat or irradiation of ionizing radiation such as ultraviolet rays or electron beams is preferable. Examples of the cured resin may include thermally cured resins and ionizing radiation cured resins. Also, examples of the ionizing radiation cured resin may include ultraviolet cured resins and electron beam cured resins. Among them, ionizing radiation cured resins are preferable. This is because the surface hardness of the functional layer may be increased.

Here, “ionizing radiation cured resin” in the present specification means resin cured by irradiation of ionizing radiation. Also, “ionizing radiation” refers to, among electromagnetic waves and charged particle beams, one having energy quantum capable of polymerizing or cross-linking molecules; and examples may include, in addition to ultraviolet rays and electron beams, electromagnetic waves such as X-rays and γ-rays; and charged particle beams such as α-rays and ion rays.

Examples of the ionizing radiation cured resins may include compounds with one or two or more unsaturated bonds such as compounds with an acrylate based functional group. Examples of the compound with a single unsaturated bond may include ethyl(meth)acrylate, ethylhexyl(meth)acrylate, styrene, methylstyrene, and N-vinylpyrrolidone. Examples of the compound with two or more unsaturated bonds may include polyfunctional compounds such as polymethylol propanetri(meth)acrylate, hexanediol(meth)acrylate, tripropylene glycoldi(meth)acrylate, diethylene glycol di(meth)acrylate, pentaerythritol tri(meth)acrylate, dipentaerythritol hexa(meth)acrylate, 1,6-hexanediol di(meth)acrylate, and neopentylglycol di(meth)acrylate; and reaction products of the above polyfunctional compounds with (meth)acrylate (for example, poly(meth)acrylate esters of polyvalent alcohols). Incidentally, “(meth)acrylate” refers to methacrylate and acrylate.

Also, as the ionizing radiation cured resin, relatively low molecular weight resins with an unsaturated double bond such as polyester resins, polyether resins, acrylic resins, epoxy resins, urethane resins, alkyd resins, spiro acetal resins, polybutadiene resins, and polythiol polyene resins may also be used. Further, the low refractive index resin described later may be used as the resin.

The content of the resin and the low refractive index particles in the functional layer is appropriately set so as to satisfy the maximum load at which the functional layer is not peeled off when the steel wool test is carried out after the surface modification described above, and the refractive index of the functional layer as a whole satisfies the above refractive index.

The functional layer may include a photopolymerization initiator, when ultraviolet cured resins are used as the resin. Also, when the functional layer includes resin and low refractive index particles, the functional layer may include various additives according to the desired properties. Examples of the additive may include ultraviolet absorbers, antioxidants, photostabilizers, infrared absorbers, dispersing aids, weather improvement agents, abrasion improvement agents, antistatic agents, polymerization inhibitors, crosslinkers, adhesive enhancers, leveling agents, thixotropy imparting agents, coupling agents, plasticizers, antifoaming agents, and fillers.

The method for forming the functional layer is appropriately selected according to the material of the functional layer. When the functional layer includes the low refractive index inorganic material, examples of a method for forming a functional layer may include vacuum vapor deposition, and sputtering method. Also, when the functional layer includes resin and low refractive index particles, examples of a method for forming a functional layer may include a method wherein the substrate layer is coated with a resin composition for a functional layer, and cured.

### (2) Case Wherein Functional Layer is Multilayer

When the functional layer is a multilayer, the functional layer may include, for example, in order from the substrate layer side, a high refractive index film and a low refractive index film; a low refractive index film, a high refractive index film, and a low refractive index film; or a high refractive index film, a low refractive index film, a high refractive index film and a low refractive index film.

When the functional layer is a multilayer, the number of layers may be two or more layers, and among them, it is preferably two layers. When the number of layers is increased, the thickness of the functional layer is thick, and the hardness of the functional layer increases, so that the maximum load at which the functional layer is not peeled off when the steel wool test is carried out after the surface modification described above may be too high.

Also, when the functional layer is a multilayer, the functional layer usually includes a low refractive index film on the outermost surface on opposite side to the substrate layer. The refractive index of the low refractive index film may be similar to the refractive index of the functional layer when the functional layer is a single layer.

Also, when the functional layer is a multilayer, and includes the low refractive index film and the high refractive index film, the refractive index of the high refractive index film may be any refractive index higher than the refractive index of the low refractive index film, and is preferably, for example, 1.55 or more and 3.00 or less, more preferably 1.60 or more and 2.50 or less, and further preferably 1.65 or more and 2.00 or less. When the refractive index of the high refractive index film is in the above range, the reflectance may be easily adjusted by adjusting the refractive index and the thickness of each layer constituting the functional layer.

Also, When the functional layer is a multilayer, the thickness of the functional layer is preferably, for example, 70 nm or more, more preferably 80 nm or more, and further preferably 90 nm or more. When the thickness of the functional layer is too thin, the hardness and close adhesiveness of the functional layer decreases, so that the maximum load at which the functional layer is not peeled off when the steel wool test is carried out after the surface modification described above is too low, and a lift may occur in the bent portion when folded repeatedly. Also, the thickness of the functional layer is preferably, for example, 140 nm or less, more preferably 130 nm or less, and further preferably 120 nm or less. When the thickness of the functional layer is too thick, the close adhesiveness of the functional layer is excessive, so that the maximum load at which the functional layer is not peeled off when the steel wool test is carried out after the surface modification described above is too high, and a crack or a fracture may occur in the bent portion, when folded repeatedly. When the functional layer is a multilayer, the thickness of the functional layer is preferably, for example, 70 nm or more and 140 nm or less, more preferably 80 nm or more and 130 nm or less, and further preferably 90 nm or more and 120 nm or less.

Incidentally, when the functional layer is a multilayer, the thickness of the functional layer described above refers to the thickness of the functional layer as a whole.

The thickness of each film constituting the functional layer is appropriately adjusted according to the refractive index of each film.

The thickness of the low refractive index film is preferably, for example, 5 nm or more and 140 nm or less, more preferably 20 nm or more and 130 nm or less, and further preferably 40 nm or more and 120 nm or less. When the thickness of the low refractive index film is too thin, the hardness and close adhesiveness of the functional layer decreases, so that the maximum load at which the functional layer is not peeled off when the steel wool test is carried out after the surface modification described above is too low, and a lift may occur in the bent portion when folded repeatedly. Also, when the thickness of the low refractive index film is too thick, the close adhesiveness of the functional layer is excessive, so that the maximum load at which the functional layer is not peeled off when the steel wool test is carried out after the surface modification described above is too high, and a crack or a fracture may occur in the bent portion, when folded repeatedly.

The thickness of the high refractive index film is preferably, for example, 5 nm or more and 140 nm or less, more preferably 20 nm or more and 130 nm or less, and further preferably 40 nm or more and 120 nm or less. When the thickness of the high refractive index film is too thin, the hardness and close adhesiveness of the functional layer decreases, so that the maximum load at which the functional layer is not peeled off when the steel wool test is carried out after the surface modification described above is too low, and a lift may occur in the bent portion when folded repeatedly. When the thickness of the high refractive index film is too thick, the close adhesiveness of the functional layer is excessive, so that the maximum load at which the functional layer is not peeled off when the steel wool test is carried out after the surface modification described above is too high, and a crack or a fracture may occur in the bent portion, when folded repeatedly.

The material of the low refractive index film is not particularly limited as long as it is material capable of obtaining a functional layer satisfying the maximum load at which the functional layer is not peeled off when the steel wool test is carried out after the surface modification described above, and it is capable of obtaining a low refractive index film that satisfies the above refractive index. The low refractive index film may be, for example, any one of an inorganic film and an organic-inorganic mixed film.

When the low refractive index film is an inorganic film, the low refractive index film may include, for example, a low refractive index inorganic material with the refractive index described above. Also, when the low refractive index film is an organic-inorganic mixed film, the low refractive index film may include, for example, resin and low refractive index particles with refractive index lower than the resin.

Among the above, the low refractive index film is preferably an inorganic film. Compared to an organic-inorganic mixed film or an organic film, the hardness of the inorganic film tends to be high, so that a functional layer satisfying the maximum load at which the functional layer is not peeled off when the steel wool test is carried out after the surface modification described above, may be easily obtained.

When the low refractive index film includes the low refractive index inorganic material, the low refractive index inorganic material may be similar to the low refractive index inorganic material used when the functional layer is a single layer, and is an inorganic film.

Also, when the low refractive index film includes the resin and the low refractive index particles, the resin and the low refractive index particles may be respectively similar to the resin and the low refractive index particles used when the functional layer is a single layer, and is an organic-inorganic mixed film.

The material of the high refractive index film is not particularly limited as long as it is material capable of obtaining a functional layer satisfying the maximum load at which the functional layer is not peeled off when the steel wool test is carried out after the surface modification described above, and it is capable of obtaining a high refractive index film that satisfies the above refractive index. The high refractive index film may be, for example, any one of an inorganic film and an organic-inorganic mixed film.

When the high refractive index film is an inorganic film, the high refractive index film may include, for example, a high refractive index inorganic material with the refractive index described above. Also, when the high refractive index film is an organic-inorganic mixed film, the high refractive index film may include, for example, resin and high refractive index particles with refractive index higher than the resin.

When the high refractive index film includes the high refractive index inorganic material, the high refractive index inorganic material is not particularly limited as long as it is inorganic material wherein the high refractive index film including the high refractive index inorganic material is able to satisfy the refractive index described above; and examples thereof may include zirconium oxide, silicon monoxide, hafnium oxide, tantalum oxide, niobium oxide, cerium oxide, titanium oxide, zinc oxide, aluminum oxide, magnesium oxide, yttrium oxide, lanthanum fluoride, and cerium fluoride.

Also, when the high refractive index film includes resin and high refractive index particles, the high refractive index particles are not particularly limited as long as it has refractive index higher than the refractive index of the resin, and it is capable of obtaining a high refractive index film that satisfies the above refractive index. The high refractive index particles may be either inorganic particles or organic particles. Examples of the inorganic particles may include zirconium oxide, silicon monoxide, hafnium oxide, tantalum oxide, niobium oxide, cerium oxide, titanium oxide, zinc oxide, aluminum oxide, magnesium oxide, yttrium oxide, lanthanum fluoride, and cerium fluoride.

The average particle size of the high refractive index particles may be the thickness of the high refractive index film or less, and it may be similar to the average particle size of low refractive index particles.

The shape of the high refractive index particles is not particularly limited, and examples thereof may include spherical shape, chain shape, and needle shape.

Also, when the high refractive index film includes the resin and the high refractive index particles, the resin may be similar to the resin used when the functional layer is a single layer, and is an organic-inorganic mixed film.

The content of the resin and the high refractive index particles in the high refractive index film is appropriately set so as to satisfy the maximum load at which the functional layer is not peeled off when the steel wool test is carried out after the surface modification described above, and the refractive index of the functional layer as a whole satisfies the above refractive index.

The low refractive index film and the high refractive index film may include a photopolymerization initiator, when ultraviolet cured resins are used as the resin. Also, when the low refractive index film includes resin and low refractive index particles, and when the high refractive index film includes resin and high refractive index particles, various additives may be included according to the desired properties. The additives may be similar to the additives used when the functional layer is a single layer.

The method for forming the low refractive index film and the high refractive index film is appropriately selected according to the material of the low refractive index film and the material of the high refractive index film. Also, when the low refractive index film includes the low refractive index inorganic material, and when the high refractive index film includes the high refractive index inorganic material, examples of a method for forming a low refractive index film and a high refractive index film may include vacuum vapor deposition, and sputtering method. When the low refractive index film includes the resin and the low refractive index particles, and when the high refractive index film includes the resin and the high refractive index particles, examples of a method for forming a low refractive index film and a high refractive index film may include a method wherein the substrate layer is coated with a resin composition for a low refractive index film or a resin composition for a high refractive index film, and cured.

### 3. Second Functional Layer

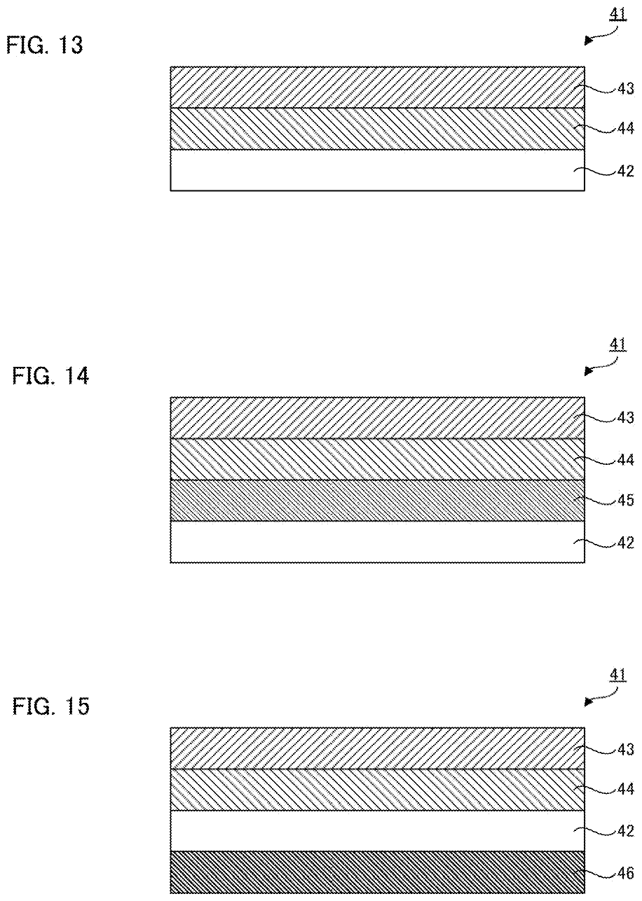

For example, as shown in FIG. 13, the stacked body for a display device in the present embodiment preferably includes a second functional layer 44 between the substrate layer 42 and the functional layer 43. By placing the second functional layer between the substrate layer and the functional layer, the close adhesiveness of the functional layer may be adjusted, so that the maximum load at which the functional layer is not peeled off when the steel wool test is carried out after the surface modification described above, may be controlled.

The refractive index of the second functional layer is preferably, for example, 1.55 or more and 2.00 or less, more preferably 1.60 or more and 1.90 or less, and further preferably 1.65 or more and 1.80 or less. When the refractive index of the second functional layer is in the above range, the reflectance may be easily adjusted by adjusting the refractive index and the thickness of the functional layer and the second functional layer. Also, when the refractive index of the second functional layer is too low, the difference between the refractive index of the second functional layer and the refractive index of the functional layer is small, and the effect of suppressing light reflection using the light interference caused by the thin film may not be obtained sufficiently.

Also, the thickness of the second functional layer is preferably, for example, 50 nm or more and 10 μm or less, more preferably 60 nm or more and 7 μm or less, and further preferably 70 nm or more and 5 μm or less. When the thickness of the second functional layer is in the above range, the close adhesiveness of the functional layer may be adjusted without deteriorating flexibility or bending resistance. Also, when the thickness of the second functional layer is too thick, the flexibility or the bending resistance may be deteriorated.

When the functional layer is an inorganic film, the second functional layer is preferably an organic-inorganic mixed film. For example, when the substrate layer is a resin substrate and the functional layer is an inorganic film, although the hardness of the functional layer (inorganic film) is high, the close adhesiveness of the functional layer (inorganic film) to the substrate layer (resin substrate) tends to be low, and the maximum load tends to be low; however, by placing the second functional layer between the substrate layer and the functional layer, and using the organic-inorganic mixed film as the second functional layer, the close adhesiveness of the functional layer may be improved compared to the above, so that the maximum load may be increased to be in the predetermined range. Also, for example, in a case wherein the substrate layer is a glass substrate and the functional layer is an inorganic film, although the hardness of the functional layer (inorganic film) is high, the close adhesiveness of the functional layer (inorganic film) to the substrate layer (glass substrate) tends to be too high, and the maximum load tends to be too high; however, by placing the second functional layer between the substrate layer and the functional layer, and using the organic-inorganic mixed film as the second functional layer, the close adhesiveness of the functional layer may be moderately reduced compared to the above, so that the maximum load may be reduced moderately to be in the predetermined range.

When the second functional layer is an organic-inorganic mixed film, the second functional layer may include resin and inorganic particles.

When the second functional layer includes resin and inorganic particles, the inorganic particles are not particularly limited as long as they are capable of obtaining a second functional layer that satisfies the above refractive index. Examples of the inorganic particles may include high refractive index particles such as zirconium oxide, silicon monoxide, hafnium oxide, tantalum oxide, niobium oxide, cerium oxide, titanium oxide, zinc oxide, aluminum oxide, magnesium oxide, yttrium oxide, lanthanum fluoride, and cerium fluoride; and low refractive index particles such as silicon dioxide (silica), magnesium fluoride, lithium fluoride, calcium fluoride and barium fluoride. Among the above, the zirconium oxide is preferable as the high refractive index particles, and the silicon dioxide (silica) is preferable as the low refractive index particles.

Also, the inorganic particles may be subjected to a surface treatment. By subjecting the inorganic particles to a surface treatment, affinity with resins and solvents is improved, ensures uniform dispersion of the inorganic particles, and prevents aggregation between the inorganic particles so that the decrease in transparency of the second functional layer, the applicability of the resin composition for a second functional layer, and the film strength may be suppressed. The surface treatment method may be similar to the surface treatment method of the low refractive index particles used for the functional layer described above.

Also, the inorganic particles may be reactive particles with a polymerizable functional group on its surface.

The average particle size of the inorganic particles may be the thickness of the second functional layer or less, and it may be for example, 300 nm or less, may be 200 nm or less, may be 150 nm or less, and may be 100 nm or less. Also, the average particle size of the inorganic particles may be, for example, 5 nm or more, may be 10 nm or more, may be 30 nm or more, and may be 50 nm or more. When the average particle size of the inorganic particles is in the above range, good dispersion condition of the inorganic particles may be obtained without deteriorating the transparency of the second functional layer. Incidentally, when the average particle size of the inorganic particles is in the above range, the average particle size may be either the primary particle size or the secondary particle size, and the inorganic particles may be connected in the form of chain. Incidentally, the method for measuring the average particle size of the inorganic particles may be similar to the method for measuring the average particle size of the low refractive index particles used for the functional layer described above.

The shape of the inorganic particles is not particularly limited, and examples thereof may include spherical shape, chain shape, and needle shape.

Also, when the second functional layer includes the resin and the inorganic particles, the resin may be similar to the resin used for the functional layer.

The content of the resin and the inorganic particles in the second functional layer is appropriately set so as to satisfy the maximum load at which the functional layer is not peeled off when the steel wool test is carried out after the surface modification described above, and the refractive index of the second functional layer as a whole satisfies the above refractive index.

The second functional layer may include a photopolymerization initiator, when ultraviolet cured resins are used as the resin. Also, when the second functional layer includes resin and inorganic particles, various additives may be included according to the desired properties. The additives may be similar to the additives used for the functional layer described above.

Also, it is preferable that the functional layer side surface of the second functional layer is subjected to a surface treatment. The close adhesiveness between the second functional layer and the functional layer may be increased, and the maximum load at which the functional layer is not peeled off when the steel wool test is carried out after the surface modification described above, may be appropriately increased.

The surface treatment method is not particularly limited as long as it is a surface treatment method capable of improving the close adhesiveness between the second functional layer and the functional layer; and examples thereof may include a corona discharge treatment, a plasma treatment, an ozone treatment, a glow discharge treatment, and an oxidation treatment.

The surface treatment conditions are appropriately set so as to satisfy the maximum load at which the functional layer is not peeled off when the steel wool test is carried out after the surface modification described above. For example, when the output is too low, the close adhesiveness between the second functional layer and the functional layer may be insufficient, so that the maximum load at which the functional layer is not peeled off when the steel wool test is carried out after the surface modification described above may be too low, and a lift may occur in the bent portion when folded repeatedly. Also, when the output is too high, the close adhesiveness between the second functional layer and the functional layer may be excessive, so that the maximum load at which the functional layer is not peeled off when the steel wool test is carried out after the surface modification described above is too high, and a crack or a fracture may occur in the bent portion, when folded repeatedly. Also, for example, when the surface treatment time is too short, the close adhesiveness between the second functional layer and the functional layer may be insufficient, so that the maximum load at which the functional layer is not peeled off when the steel wool test is carried out after the surface modification described above is too low, and a lift may occur in the bent portion when folded repeatedly. Also, when the surface treatment time is too long, the close adhesiveness between the second functional layer and the functional layer may be excessive, so that the maximum load at which the functional layer is not peeled off when the steel wool test is carried out after the surface modification described above is too high, and a crack or a fracture may occur in the bent portion, when folded repeatedly.

The method for forming a second functional layer is appropriately selected according to the material of the functional layer. When the second functional layer includes resin and inorganic particles, examples of a method for forming a second functional layer may include a method wherein the substrate layer is coated with a resin composition for a second functional layer, and cured.

### 4. Substrate Layer

The substrate layer in the present embodiment is a member configured to support the functional layer, and has transparency.

The substrate layer is not particularly limited as long as it has transparency; and examples thereof may include a resin substrate, and a glass substrate.

The details of the resin substrate and the glass substrate used in the present embodiment are similar to those described in the column of “A. Stacked body for a display device 3. Substrate layer” in the first embodiment above, and the explanation is omitted herein.

The thickness of the substrate layer is not particularly limited as long as it has a thickness capable of having flexibility, and is appropriately selected according to the type of the substrate layer.

The thickness of the resin substrate is preferably, for example, 10 μm or more and 100 μm or less, and more preferably 25 μm or more and 80 μm or less. When the thickness of the resin substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

The thickness of the glass substrate is preferably, for example, 200 μm or less, more preferably 15 μm or more and 100 μm or less, further preferably 20 μm or more and 90 μm or less, and particularly preferably 25 μm or more and 80 μm or less. When the thickness of the glass substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

### 5. Other Layers

The stacked body for a display device in the present embodiment may include another layer, in addition to the substrate layer and the functional layer described above.

### (1) Hard Coating Layer

The stacked body for a display device in the present embodiment may include a hard coating layer between the substrate layer and the functional layer. For example, as shown in FIG. 14, when the second functional layer is placed between the substrate layer and the functional layer, as described above, a hard coating layer 45 may be included between the substrate layer 42 and the second functional layer 44. The hard coating layer is a member to enhance the surface hardness. By placing the hard coating layer, scratch resistance may be improved. Particularly, when the substrate layer is a resin substrate, the scratch resistance may be effectively improved by placing the hard coating layer.

The refractive index of the hard coating layer is preferably, for example, 1.70 or less, more preferably 1.45 or more and 1.67 or less, further preferably 1.48 or more and 1.65 or less, particularly preferably 1.50 or more and 1.60 or less. When the refractive index of the hard coating layer is in the above range, the surface hardness may be improved without deteriorating flexibility or bending resistance.

The details of the material of the hard coating layer are similar to those described in the column of “A. Stacked body for a display device 4. Other layers (1) Hard coating layer” in the first embodiment above, and the explanation is omitted herein.

Examples of a method for forming a hard coating layer may include a method wherein the substrate layer is coated with a resin composition for a hard coating layer, and cured.

### (2) Impact Absorbing Layer

For example, as shown in FIG. 15, the stacked body for a display device in the present embodiment may include an impact absorbing layer 46 on the substrate layer 42, on an opposite side surface to the functional layer 43. By placing the impact absorbing layer, when an impact is imparted to the stacked body for a display device, the impact is absorbed so that the impact resistance may be improved. Also, when the substrate layer is a glass substrate, the crack of the glass substrate may be suppressed.

Details of the impact absorbing layer are similar to those described in the column of “A. Stacked body for a display device 4. Other layers (2) Impact absorbing layer” above, and the explanation is omitted herein.

### (3) Adhesive Layer for Adhesion

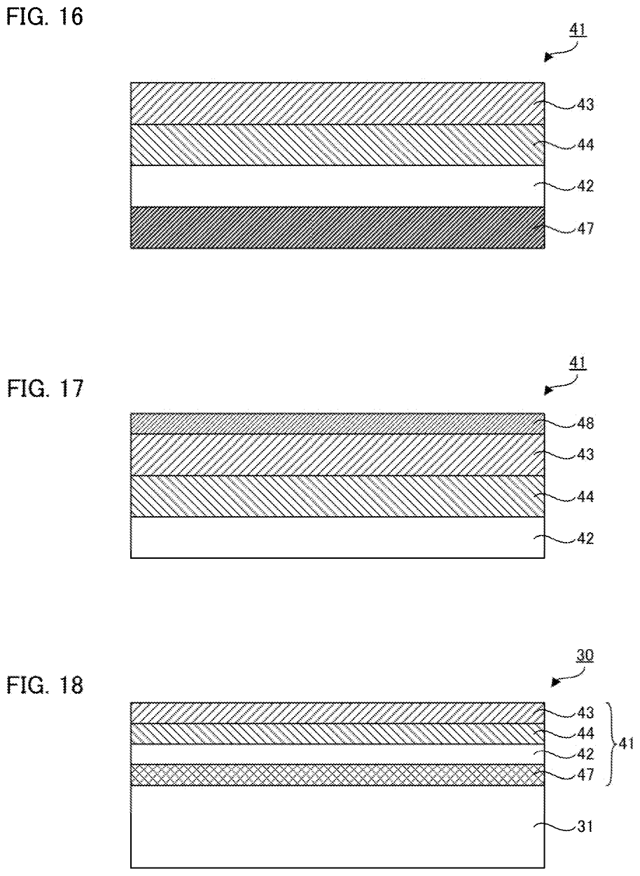

For example, as shown in FIG. 16, the stacked body for a display device in the present embodiment may include adhesive layer for adhesion 47 on the substrate layer 42, on an opposite side surface to the functional layer 43. The stacked body for a display device may be adhered to, for example, a display panel via the adhesive layer for adhesion.

The adhesive used for the adhesive layer for adhesion is not particularly limited as long as it is an adhesive having transparency, and is capable of adhering the stacked body for a display device to, for example, a display panel. Examples thereof may include a thermosetting adhesive, an ultraviolet curable adhesive, a two-component curable adhesive, a thermal fusion adhesive, and a pressure-sensitive adhesive (so-called tackiness agent).

The thickness of the adhesive layer for adhesion is preferably, for example, 10 μm or more and 100 μm or less, more preferably 25 μm or more and 80 μm or less, and further preferably 40 μm or more and 60 μm or less. When the thickness of the adhesive layer for adhesion is too thin, the stacked body for a display device and the display panel may not be adhered sufficiently. Also, when the thickness of the adhesive layer for adhesion is too thick, the flexibility may be deteriorated.

As the adhesive layer for adhesion, for example, an adhesive film may be used. Also, for example, the adhesive layer for adhesion may be formed by coating a supporting body or the substrate layer, for example, with an adhesive composition.

### (4) Antifouling Layer

For example, as shown in FIG. 17, the stacked body for a display device in the present embodiment may include an antifouling layer 48 on the functional layer 43, on an opposite side surface to the substrate layer 42. By placing the antifouling layer, antifouling property may be improved to the stacked body for a display device. Incidentally, in the present embodiment, since the thickness of the antifouling layer is relatively thin as described later, it is inferred that it does not affect the thin film interference.

As the material of the antifouling layer, general antifouling layer materials may be applied. Specifically, it is similar to those described in “A. Stacked body for a display device 4. Other layers (4) Antifouling layer”, so the explanation here is omitted.

The thickness of the antifouling layer is preferably, for example, 1 nm or more and 30 nm or less, more preferably 2 nm or more and 20 nm or less, and further preferably 3 nm or more and 10 nm or less. When the thickness of the antifouling layer is in the above range, the antifouling property and durability may be improved.

Examples of the method for forming an antifouling layer may include a method wherein the functional layer is coated with a resin composition for an antifouling layer, and cured; a vacuum deposition method; and a sputtering method.

### (5) Interlayer Adhesive Layer

In the stacked body for a display device in the present embodiment, an interlayer adhesive layer may be placed between each layer.

The adhesive used for the interlayer adhesive layer may be similar to the adhesive used for the adhesive layer for adhesion.

The thickness of the interlayer adhesive layer, and the forming method, for example, may be similar to the thickness and the forming method, for example, of the adhesive layer for adhesion.

### 6. Use Application of Stacked Body for Display Device

The stacked body for a display device in the present embodiment may be used as a front panel placed on the observer side than the display panel in a display device. Among the above, the stacked body for a display device in the present embodiment may be preferably used as a front panel in a flexible display device such as a foldable display, a rollable display, and a bendable display. Particularly, in the stacked body for a display device in the present embodiment, it may be suitably used for the front panel in a foldable display, since it may improve the visibility in the bent portion and may improve the visibility in the usage mode where an image is observed with the display device folded.

Also, the stacked body for a display device in the present embodiment may be used as a front panel in a display device such as smart phones, tablet terminals, wearable terminals, personal computers, televisions, digital signages, public information displays (PIDs), and car mounted displays.

### B. Display Device

The display device in the present embodiment comprises: a display panel, and the stacked body for a display device described above placed on an observer side of the display panel.

FIG. 18 is a schematic cross-sectional view illustrating an example of a display device in the present embodiment. As shown in FIG. 18, display device 30 comprises display panel 31, and the stacked body for a display device 41 placed on an observer side of the display panel 31. In the display device 30, the stacked body for a display device 41 and the display panel 31 may be adhered via, for example, the adhesive layer for adhesion 47 of the stacked body for a display device 41.

When the stacked body for a display device in the present embodiment is placed on the surface of the display device, it is placed so that the functional layer is on the outer side, and the substrate layer is on the inner side.

The method for placing the stacked body for a display device in the present embodiment on the surface of the display device is not particularly limited, and examples thereof may include a method via an adhesive layer.

Examples of the display panel in the present embodiment may include a display panel used for a display device such as an organic EL display device, and a liquid crystal display device.

The display device in the present embodiment may include a touch-sensitive panel member between the display panel and the stacked body for a display device.

Among the above, the display device in the present embodiment is preferably a flexible display device such as a foldable display, a rollable display, and a bendable display.

Also, the display device in the present embodiment is preferably foldable. That is, the display device in the present embodiment is preferably a foldable display. The display device in the present embodiment is excellent in visibility in the bent portion and visibility in the usage mode where an image is observed with the display device folded, so that it is suitable as a foldable display.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

The present disclosure is hereinafter explained in further details with reference to Examples and Comparative Examples of the first embodiment and the second embodiment, respectively.

### I. Examples of First Embodiment

Firstly, Examples 1 to 18 and Comparative Examples 1 to 8 of the first embodiment are hereinafter described.

### Example 1

### (1) Formation of First Layer

Firstly, a resin composition for a functional layer 1 was obtained by compounding each component so as to be the composition shown below.

### (Composition of Resin Composition for Functional Layer 1)

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 85 parts by mass
Pentaerythritol tetraacrylate (product name “ATM-4E” from Shin-Nakamura Chemical Co., Ltd.): 15 parts by mass
Methyl isobutyl ketone: 200 parts by mass

Then, using a polyimide film (product name “Neopulim” from Mitsubishi Gas Chemical Company, Inc.) having a thickness of 50 μm as a substrate layer, a coating film was formed on the substrate layer by applying the resin composition for a functional layer 1 with a bar coater. Thereafter, the coating film was heated at 70° C. for 1 minute to evaporate the solvent in the coating film, and the coating film was cured by irradiating ultraviolet rays with an ultraviolet ray irradiation device (light source H bulb from Fusion UV Systems Japan K.K) under the condition of an oxygen concentration of 200 ppm or less so that the integrated light amount was 40 mJ/cm² to form a first layer with a thickness of 3 μm.

### (2) Formation of Second Layer

Firstly, a resin composition for a functional layer 2 was obtained by compounding each component so as to be the composition shown below.

### <Composition of Resin Composition for Functional Layer 2>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 72 parts by mass
Polyfunctional acrylate (product name “M-510”, from Toagosei Co., Ltd.): 28 parts by mass
Low refractive index particles (hollow silica, average primary particle size 50 nm, from JGC Catalysts and Chemicals): 70 parts by mass (solid content 100% conversion value)
Methyl isobutyl ketone: 220 parts by mass

Then, a coating film was formed on the first layer by applying the resin composition for a functional layer 2 with a bar coater. Thereafter, the coating film was heated at 70° C. for 1 minute to evaporate the solvent in the coating film, and the coating film was cured by irradiating ultraviolet rays with an ultraviolet ray irradiation device (light source H bulb from Fusion UV Systems Japan K.K.) under the condition of an oxygen concentration of 200 ppm or less so that the integrated light amount was 400 mJ/cm² to form a second layer with a thickness of 3 μm.

### (3) Formation of Antifouling Layer

The surface of the second layer was modified by plasma treatment for one minute at an output of 200 W.

Then, an antifouling layer with a thickness of 7 nm was formed on the surface modified second layer by forming a film of a fluorine compound (product name “Optool UD120” from Daikin Industries) by vacuum vapor deposition method using vacuum vapor deposition device (from ULVAC, Inc.).

### Example 2

A stacked body was produced in the same manner as in Example 1 except that, the thickness of the second layer was 10 μm.

### Example 3

A stacked body was produced in the same manner as in Example 1 except that the second layer was formed using the following resin composition for a functional layer 3.

### <Composition of Resin Composition for Functional Layer 3>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 63 parts by mass
Polyfunctional acrylate (product name “M-510”, from Toagosei Co., Ltd.): 37 parts by mass
Low refractive index particles (hollow silica, average primary particle size 50 nm, from JGC Catalysts and Chemicals): 130 parts by mass (solid content 100% conversion value)
Methyl isobutyl ketone: 220 parts by mass

### Example 4

A stacked body was produced in the same manner as in Example 1 except that the first layer was formed using the following resin composition for a functional layer 4.

### <Composition of Resin Composition for Functional Layer 4>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 89 parts by mass
Pentaerythritol tetraacrylate (product name “ATM-4E” from Shin-Nakamura Chemical Co., Ltd.): 11 parts by mass
High refractive index particles (zirconia, average primary particle size 20 nm, from CIK Nano Tek Corporation): 170 parts by mass (solid content 100% conversion value)
Methyl isobutyl ketone: 240 parts by mass

### Example 5

In this Example, the substrate layer doubled as the first layer. As the substrate layer which doubles the first layer, a polyimide film (product name “Neopulim” from Mitsubishi Gas Chemical Company, Inc.) having a thickness of 50 μm) was used.

The surface of the first layer was modified by plasma treatment for two minutes at an output of 300 W.

Then, a second layer with a thickness of 90 nm was formed on the surface modified first layer by forming a film of a silicon dioxide (silica) by vacuum vapor deposition method using vacuum vapor deposition device (from ULVAC, Inc.).

Then, in the same manner as in Example 1, an antifouling layer was formed on the second layer to produce a stacked body.

### Example 6

In this Example, the substrate layer doubled as the first layer. A stacked body was produced in the same manner as in Example 5 except that, as the substrate layer which doubles the first layer, a polyamide film (product name “Mictron” from Toray Industries, Inc.) having a thickness of 30 μm) was used.

### Example 7

### (1) Formation of First Layer

In the same manner as in Example 1, a first layer was formed on the substrate layer.

### (2) Formation of Second Layer

In the same manner as in Example 5, a second layer was formed on the first layer.

### (3) Formation of Antifouling Layer

In the same manner as in Example 1, an antifouling layer was formed on the second layer.

### Example 8

A stacked body was produced in the same manner as in Example 7 except that, the thickness of the first layer was 1 μm.

### Example 9

A stacked body was produced in the same manner as in Example 7 except that the first layer was formed using the following resin composition for a functional layer 5.

### <Composition of Resin Composition for Functional Layer 5>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 87 parts by mass
Pentaerythritol tetraacrylate (product name “ATM-4E” from Shin-Nakamura Chemical Co., Ltd.): 13 parts by mass
High refractive index particles (zirconia, average primary particle size 20 nm, from CIK Nano Tek Corporation): 90 parts by mass (solid content 100% conversion value)
Methyl isobutyl ketone: 240 parts by mass

### Example 10

A stacked body was produced in the same manner as in Example 9 except that, the thickness of the second layer was 60 nm.

### Example 11

A stacked body was produced in the same manner as in Example 7 except that the first layer with a thickness of 90 nm was formed using the following resin composition for a functional layer 6.

### <Composition of Resin Composition for Functional Layer 6>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 87 parts by mass
Pentaerythritol tetraacrylate (product name “ATM-4E” from Shin-Nakamura Chemical Co., Ltd.): 13 parts by mass
High refractive index particles (zirconia, average primary particle size 20 nm, from CIK Nano Tek Corporation): 90 parts by mass (solid content 100% conversion value)
Methyl isobutyl ketone: 320 parts by mass

### Example 12

A stacked body was produced in the same manner as in Example 11 except that, the thickness of the first layer was 70 nm.

### Example 13

In this Example, the substrate layer doubled as the first layer. As the substrate layer which doubles the first layer, a polyamideimide film (product name “CPI” from Kolon Global Corp.) having a thickness of 50 μm) was used.

Then, a second layer was formed on the first layer in the same manner as in Example 1 except that the second layer with a thickness of 90 nm was formed using the following resin composition for a functional layer 7.

### <Composition of Resin Composition for Functional Layer 7>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 63 parts by mass
Polyfunctional acrylate (product name “M-510”, from Toagosei Co., Ltd.): 37 parts by mass
Low refractive index particles (hollow silica, average primary particle size 50 nm, from JGC Catalysts and Chemicals): 90 parts by mass (solid content 100% conversion value)
Methyl isobutyl ketone: 320 parts by mass

### Example 14

In this Example, the substrate layer doubled as the first layer. A stacked body was produced in the same manner as in Example 13 except that the second layer was formed using the following resin composition for a functional layer 8.

### <Composition of Resin Composition for Functional Layer 8>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 70 parts by mass
Polyfunctional acrylate (product name “M-510”, from Toagosei Co., Ltd.): 30 parts by mass
Low refractive index particles (hollow silica, average primary particle size 50 nm, from JGC Catalysts and Chemicals): 190 parts by mass (solid content 100% conversion value)
Methyl isobutyl ketone: 340 parts by mass

### Example 15

### (1) Formation of First Layer

In the same manner as in Example 1, a first layer was formed on the substrate layer.

### (2) Formation of Second Layer

In the same manner as in Example 13, a second layer was formed on the first layer.

### (3) Formation of Antifouling Layer

In the same manner as in Example 1, an antifouling layer was formed on the second layer.

### Example 16

A stacked body was produced in the same manner as in Example 15 except that the second layer was formed using the following resin composition for a functional layer 9.

### <Composition of Resin Composition for Functional Layer 9>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 72 parts by mass
Polyfunctional acrylate (product name “M-510”, from Toagosei Co., Ltd.): 28 parts by mass
Low refractive index particles (hollow silica, average primary particle size 50 nm, from JGC Catalysts and Chemicals): 220 parts by mass (solid content 100% conversion value)
Methyl isobutyl ketone: 340 parts by mass

### Example 17

### (1) Formation of First Layer

In the same manner as in Example 11, a first layer was formed on the substrate layer.

### (2) Formation of Second Layer

In the same manner as in Example 15, a second layer was formed on the first layer.

### (3) Formation of Antifouling Layer

In the same manner as in Example 1, an antifouling layer was formed on the second layer.

### Example 18

In this Example, the substrate layer doubled as the first layer. As the substrate layer which doubles the first layer, a polyamideimide film (product name “CPI” from Kolon Global Corp.) having a thickness of 50 μm) was used.

Then, a second layer was formed on the first layer in the same manner as in Example 1 except that, the thickness of the second layer was 15 μm.

### Comparative Example 1

The substrate layer used in Example 13 was used as a stacked body in Comparative Example 1.

### Comparative Example 2

In this Example, the substrate layer doubled as the first layer. A stacked body was produced in the same manner as in Example 18 except that the second layer with a thickness of 3 μm was formed using the following resin composition for a functional layer 10.

### <Composition of Resin Composition for Functional Layer 10>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 72 parts by mass
Polyfunctional acrylate (product name “M-510”, from Toagosei Co., Ltd.): 28 parts by mass
Low refractive index particles (hollow silica, average primary particle size 50 nm, from JGC Catalysts and Chemicals): 10 parts by mass (solid content 100% conversion value)
Methyl isobutyl ketone: 200 parts by mass

### Comparative Example 3

In this Example, the substrate layer doubled as the first layer. A stacked body was produced in the same manner as in Example 18 except that the second layer with a thickness of 3 μm was formed using the following resin composition for a functional layer 11.

### <Composition of Resin Composition for Functional Layer 11>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 88 parts by mass
Polyfunctional acrylate (product name “M-510”, from Toagosei Co., Ltd.): 12 parts by mass
Low refractive index particles (hollow silica, average primary particle size 50 nm, from JGC Catalysts and Chemicals): 280 parts by mass (solid content 100% conversion value)
Methyl isobutyl ketone: 250 parts by mass

### Comparative Example 4

A stacked body was produced in the same manner as in Example 1 except that the first layer was formed using the following resin composition for a functional layer 12.

### <Composition of Resin Composition for Functional Layer 12>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 20 parts by mass
Pentaerythritol tetraacrylate (product name “ATM-4E” from Shin-Nakamura Chemical Co., Ltd.): 80 parts by mass
Low refractive index particles (hollow silica, average primary particle size 50 nm, from JGC Catalysts and Chemicals): 30 parts by mass (solid content 100% conversion value)
Methyl isobutyl ketone: 200 parts by mass

### Comparative Example 5

### (1) Formation of First Layer

A first layer was formed on the substrate layer in the same manner as in Example 1 except that the following resin composition for a functional layer 13 was used.

### <Composition of Resin Composition for Functional Layer 13>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 92 parts by mass
Pentaerythritol tetraacrylate (product name “ATM-4E” from Shin-Nakamura Chemical Co., Ltd.): 8 parts by mass
High refractive index particles (zirconia, average primary particle size 20 nm, from CIK Nano Tek Corporation): 230 parts by mass (solid content 100% conversion value)
Methyl isobutyl ketone: 280 parts by mass

### (2) Formation of Second Layer

In the same manner as in Example 14, a second layer was formed on the first layer.

### (3) Formation of Antifouling Layer

In the same manner as in Example 1, an antifouling layer was formed on the second layer.

### Comparative Example 6

### (1) Formation of First Layer

In the same manner as in Example 9, a first layer was formed on the substrate layer.

### (2) Formation of Second Layer

A second layer was formed on the first layer in the same manner as in Example 13 except that, the thickness was 40 nm.

### (3) Formation of Antifouling Layer

In the same manner as in Example 1, an antifouling layer was formed on the second layer.

### Comparative Example 7

### (1) Formation of First Layer

A first layer was formed on the substrate layer in the same manner as in Example 1 except that the following resin composition for a functional layer 14 was used.

### <Composition of Resin Composition for Functional Layer 14>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 92 parts by mass
Pentaerythritol tetraacrylate (product name “ATM-4E” from Shin-Nakamura Chemical Co., Ltd.): 8 parts by mass
High refractive index particles (zirconia, average primary particle size 20 nm, from CIK Nano Tek Corporation): 200 parts by mass (solid content 100% conversion value)
Methyl isobutyl ketone: 270 parts by mass

### (2) Formation of Second Layer

In the same manner as in Example 16, a second layer was formed on the first layer.

### (3) Formation of Antifouling Layer

In the same manner as in Example 1, an antifouling layer was formed on the second layer.

### Comparative Example 8

### (1) Formation of First Layer

A first layer was formed on the substrate layer in the same manner as in Example 1 except that the following resin composition for a functional layer 15 was used.

### <Composition of Resin Composition for Functional Layer 15>

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 46 parts by mass
Pentaerythritol tetraacrylate (product name “ATM-4E” from Shin-Nakamura Chemical Co., Ltd.): 54 parts by mass
Methyl isobutyl ketone: 200 parts by mass

### (2) Formation of Second Layer

In the same manner as in Example 13, a second layer was formed on the first layer.

### (3) Formation of Antifouling Layer

In the same manner as in Example 1, an antifouling layer was formed on the second layer.

### [Evaluation]

### (1) Luminous Reflectance

The luminous reflectance was determined according to JIS Z8722:2009. Tristimulus values X, Y and Z in the XYZ colorimetric system were determined from the reflected spectrum obtained when light, in a wavelength range of 380 nm or more and 780 nm or less, is incident on the second layer side surface of the stacked body, in conditions of a viewing angle of 2 degrees, and standard light C, and the value of Y was regarded as the luminous reflectance. Using a spectrophotometer “UV-2600” from Shimadzu Corporation, the conditions in the luminous reflectance measurement were as follows. Incidentally, when measuring the luminous reflectance of the stacked body, black vinyl tape with a width larger than the measured spot area (product name “Yamato Vinyl Tape NO200-19-21” from Yamato Co. Ltd., 19 mm width) was adhered to the backside of the stacked body, before measuring, in order to prevent backside reflection.

### (Measurement Conditions)

Viewing angle: 2°
Illuminant: C
Light source: tungsten halogen lamp
Measurement wavelength: 0.5 nm interval in the range of 380 nm or more and 780 nm or less
Scan speed: fast
Slit width: 5.0 nm
S/R switch: standard
Auto Zero: carried out at 550 nm after baseline scan

### (2) Yellowness

The yellowness (YI) was determined according to JIS K7373:2006. Specifically, based on the transmittance measured using an ultraviolet-visible and near-infrared spectrophotometer (“V-7100” from JASCO Corporation) by a spectrophotometric colorimetry; using a deuterium lamp and a tungsten halogen lamp; with 0.5 nm interval in the range of 300 nm or more and 780 nm or less; in conditions of a viewing angle of 2 degrees, and standard light C, the tristimulus values X, Y and Z in the XYZ colorimetric system were determined, and the yellowness was calculated from the following formula, from the values of X, Y, and Z. Also, the following conditions were used for measuring the yellowness.

$$YI = 100 ( 1.2769 X - 1.0592 Z ) / Y$$

### (Measurement Conditions)

Viewing angle: 2°
Illuminant: C Light source: deuterium lamp and tungsten halogen lamp
Wavelength range: 0.5 nm interval in the range of 300 nm or more and 780 nm or less
Scan speed: fast
Slit width: 5.0 nm
S/R switch: standard
Auto Zero: carried out at 550 nm after baseline scan

### (3) Dynamic Bending Property

The following dynamic bending test was carried out to the stacked body to evaluate the bending resistance. Firstly, a stacked body having a size of 50 mm×200 mm was prepared. Then, to a durability tester (product name “DLDMLH-FS” from Yuasa Co., Ltd.), as shown in FIG. 4A, short side portion 1C and short side portion 1D, opposing to the short side portion 1C, of the stacked body for a display device 1 were respectively fixed by parallelly arranged fixing portions 51. Then, as shown in FIG. 4B, by moving the fixing portions 51 so as to be closer to each other, the stacked body for a display device 1 was deformed so as to be folded. Further, as shown in FIG. 4C, after moving the fixing portions 51 to the position wherein distance “d” between the two opposing short side portions 1C and 1D of the stacked body for a display device 1 fixed by the fixing portions 51 was a predetermined value, the deformation of the stacked body for a display device 1 was dissolved by moving the fixing portions 51 in opposite directions. As shown in FIGS. 4A to 4C, by moving the fixing portions 51, the stacked body for a display device 1 was folded into 180° repeatedly. When doing so, the distance “d” between the two opposing short side portions 1C and 1D of the stacked body for a display device 1 was 10 mm. Also, when the stacked body was folded so that the second layer faces inward, it was regarded as an incurve, and when the stacked body was folded so that the second layer faces outward, it was regarded as an outcurve. The results of the dynamic bending test were evaluated based on the following criteria.
A: no crack or fracture occurred in the stacked body even for 300,000 times
B: a crack or a fracture occurred in the stacked body up to 300,000 times

### (4) Visibility

After carrying out the dynamic bending test on the stacked body, the stacked body was adhered to the surface of the foldable display (“Think Pad X1 Fold” from Lenovo) so that the bent portion position and the bent direction of the stacked body, and the bent portion position and bent direction of the foldable display were aligned, and the second layer side surface of the stacked body was on the surface, and the visibility was checked. In doing so, the angle θ2 of the foldable display 20 as shown in FIG. 3, for example, was set to 120°. Also, the observation direction was set at 60° with respect to the normal line of the surface of the first display region 22 of the foldable display 20, and 15° with respect to the normal line of the surface of the second display region 23.

For the visibility of the first display region 22 of the foldable display 20 as shown in FIG. 3, for example, characters were displayed, and whether the characters were visible or not was checked.

Also, for the visibility of the first display region 22 and second display region 23 of the foldable display 20 as shown in FIG. 3, for example, an image was displayed, and whether there is an uncomfortable feeling or not, when observing the first display region 22, and then, observing the second display region 23 by moving only the line of sight, was checked.

Also, for the visibility of the bent portion 21 of the foldable display 20 as shown in FIG. 3, for example, an image was displayed, and whether there is an uncomfortable feeling or not, when observing the bent portion 21 and other regions, was checked.

The visibility of the first display region, the visibility of the first display region and the second display region, and the visibility of the bent portion were checked respectively, and the overall evaluation was carried out based on the following criteria.

A: 10 out of 10 people were able to observe all of the first display region, the first display region and second display region, and the bent portion without any problem.

B: 7 or more and 9 or less out of 10 people were able to observe all of the first display region, the first display region and second display region, and the bent portion without any problem.

C: 4 or more and 6 or less out of 10 people were able to observe all of the first display region, the first display region and second display region, and the bent portion without any problem.

D: less than 4 out of 10 people were able to observe all of the first display region, the first display region and second display region, and the bent portion without any problem.

TABLE 1

| | | | | | | Luminous | | Yellowness (YI) | | | | | |
|---|---|---|---|---|---|---|---|---|---|---|---|---|---|
| | First layer | | Second layer | | Refractive | reflectance | | YI2 | YI1 | | Dynamic | | Visibility |
| | | Refrac- | | Refrac- | index ratio | 5° | 60° | (15° | (60° | | bending property | | Overall |
| | Thick- | tive | Thick- | tive | (1st layer/ | reflec- | reflec- | trans- | trans- | | In- | Out- | eval- |
| | ness | index | ness | index | 2nd layer) | tion | tion | mission) | mission) | \|ΔYI\| | curve | curve | uation |
| Exam- | 3 μm | 1.54 | 3 μm | 1.47 | 1.05 | 3.6 | 9.8 | −0.2 | −1.1 | 0.9 | A | A | A |
| ple1 | | | | | | | | | | | | | |
| Exam- | 3 μm | 1.54 | 10 μm | 1.47 | 1.05 | 3.5 | 9.8 | −0.2 | −1.1 | 0.9 | A | A | A |
| ple2 | | | | | | | | | | | | | |
| Exam- | 3 μm | 1.54 | 3 μm | 1.43 | 1.08 | 3.1 | 9.2 | 0.1 | −1.3 | 1.4 | A | A | A |
| ple3 | | | | | | | | | | | | | |
| Exam- | 3 μm | 1.68 | 3 μm | 1.47 | 1.14 | 3.6 | 9.8 | 0.3 | −1.9 | 2.2 | A | A | B |
| ple4 | | | | | | | | | | | | | |
| Exam- | 50 μm | 1.60 | 90 nm | 1.47 | 1.09 | 1.9 | 8.0 | −0.4 | −1.6 | 1.2 | A | A | A |
| ple5 | | | | | | | | | | | | | |
| Exam- | 30 μm | 1.72 | 90 nm | 1.47 | 1.17 | 1.4 | 6.8 | 1.3 | −1.2 | 2.5 | A | A | B |
| ple6 | | | | | | | | | | | | | |
| Exam- | 3 μm | 1.54 | 90 nm | 1.47 | 1.05 | 3.1 | 9.4 | −0.3 | −1.4 | 1.1 | A | A | A |
| ple7 | | | | | | | | | | | | | |
| Exam- | 1 μm | 1.54 | 90 nm | 1.47 | 1.05 | 3.0 | 9.4 | −0.3 | −1.4 | 1.1 | A | A | A |
| ple8 | | | | | | | | | | | | | |
| Exam- | 3 μm | 1.60 | 90 nm | 1.47 | 1.09 | 2.4 | 8.3 | −0.3 | −1.5 | 1.2 | A | A | A |
| ple9 | | | | | | | | | | | | | |
| Exam- | 3 μm | 1.60 | 60 nm | 1.47 | 1.09 | 2.8 | 8.5 | −0.1 | −1.7 | 1.6 | A | A | A |
| ple10 | | | | | | | | | | | | | |
| Exam- | 90 nm | 1.60 | 90 nm | 1.47 | 1.09 | 2.6 | 8.8 | −0.2 | −1.5 | 1.3 | A | A | A |
| ple11 | | | | | | | | | | | | | |
| Exam- | 70 nm | 1.60 | 90 nm | 1.47 | 1.09 | 2.9 | 8.8 | −0.3 | −1.2 | 0.9 | A | A | A |
| ple12 | | | | | | | | | | | | | |
| Exam- | 50 μm | 1.68 | 90 nm | 1.47 | 1.14 | 1.7 | 8.2 | 0.3 | −1.8 | 2.1 | A | A | B |
| ple13 | | | | | | | | | | | | | |
| Exam- | 50 μm | 1.68 | 90 nm | 1.42 | 1.18 | 1.2 | 7.1 | 1.1 | −1.5 | 2.6 | A | A | B |
| ple14 | | | | | | | | | | | | | |
| Exam- | 3 μm | 1.54 | 90 nm | 1.47 | 1.05 | 3.4 | 9.7 | −0.4 | −1.5 | 1.1 | A | A | A |
| ple15 | | | | | | | | | | | | | |
| Exam- | 3 μm | 1.54 | 90 nm | 1.40 | 1.10 | 1.6 | 7.5 | 1.0 | −0.8 | 1.8 | A | A | A |
| ple16 | | | | | | | | | | | | | |
| Exam- | 90 nm | 1.60 | 90 nm | 1.47 | 1.09 | 2.8 | 8.8 | −0.2 | −1.5 | 1.3 | A | A | A |
| ple17 | | | | | | | | | | | | | |
| Exam- | 50 μm | 1.68 | 15 μm | 1.47 | 1.14 | 2.9 | 9.2 | 2.6 | 0.2 | 2.4 | A | B | C |
| ple18 | | | | | | | | | | | | | |
| Comp. | 50 μm | 1.68 | — | — | — | 5.6 | 11.9 | −0.1 | −1.3 | 1.2 | A | A | C |
| Ex. 1 | | | | | | | | | | | | | |
| Comp. | 50 μm | 1.68 | 3 μm | 1.52 | 1.11 | 4.3 | 10.5 | 1.5 | 1.0 | 0.5 | A | A | C |
| Ex. 2 | | | | | | | | | | | | | |
| Comp. | 50 μm | 1.68 | 3 μm | 1.38 | 1.22 | 2.4 | 9.1 | 1.5 | −2.6 | 4.1 | A | B | D |
| Ex. 3 | | | | | | | | | | | | | |
| Comp. | 3 μm | 1.50 | 3 μm | 1.47 | 1.02 | 3.4 | 10.1 | −0.2 | −1.3 | 1.1 | A | A | C |
| Ex. 4 | | | | | | | | | | | | | |
| Comp. | 3 μm | 1.72 | 90 nm | 1.42 | 1.21 | 0.9 | 8.7 | 1.8 | −1.5 | 3.3 | A | B | D |
| Ex. 5 | | | | | | | | | | | | | |
| Comp. | 3 μm | 1.60 | 40 nm | 1.47 | 1.09 | 4.4 | 10.6 | −0.3 | −1.2 | 0.9 | A | A | C |
| Ex. 6 | | | | | | | | | | | | | |
| Comp. | 3 μm | 1.70 | 90 nm | 1.40 | 1.21 | 1.1 | 8.1 | 0.5 | −2.6 | 3.1 | A | A | C |
| Ex. 7 | | | | | | | | | | | | | |
| Comp. | 3 μm | 1.53 | 90 nm | 1.47 | 1.04 | 3.5 | 10.2 | −0.2 | −1.2 | 1.0 | A | A | C |
| Ex. 8 | | | | | | | | | | | | | |

For the stacked body in Examples 1 to 18, since the luminous reflectance of regular reflection light, when the incident angle was 60° was the predetermined value or less, and the absolute value of a difference, between yellowness YI1 of transmitted light in 60° direction and yellowness YI2 of transmitted light in 15° direction, was the predetermined value or less, the visibility of the first display region, and the visibility of the first display region and the second display region were excellent, and the visibility in the usage mode where an image was observed with the foldable display folded, was excellent. Meanwhile, for the stacked body in Comparative Examples 1 to 8, since the luminous reflectance of regular reflection light when the incident angle was 60°, or the absolute value of a difference, between yellowness YI1 of transmitted light in 60° direction and yellowness YI2 of transmitted light in 15° direction, was not in the predetermined range, the visibility of the first display region, or the visibility of the first display region and the second display region was poor, and the visibility in the usage mode where an image was observed with the foldable display folded, was inferior.

Also, for the stacked body in Examples 1 to 17, since the thickness of the second layer was in the predetermined range, the dynamic bending property was excellent and the visibility in the bent portion was excellent.

### II. Examples of Second Embodiment

Secondary, Examples 1 to 10 and Comparative Examples 1 to 8 of the second embodiment are described.

### Example 1

### (1) Formation of Hard Coating Layer

Firstly, a resin composition for a functional layer 1 was obtained by compounding each component so as to be the composition shown below.

### <Composition of Resin Composition for Functional Layer 1>

Polymerization initiator (1-hydroxycyclohexylphenyl ketone, product name “Omnirad184” from IGM Resins B. V.): 3 parts by mass
Urethane acrylate (product name “UV-7000B” from Mitsubishi Chemical Corporation): 100 parts by mass
Silica particle (average primary particle size: 12 nm, from Nissan Chemical Corporation): 35 parts by mass (solid content 100% conversion value)
Methyl isobutyl ketone: 220 parts by mass

Then, using a polyimide film (product name “Neopulim” from Mitsubishi Gas Chemical Company, Inc.) having a thickness of 50 μm as a substrate layer, a coating film was formed on the substrate layer by applying the resin composition for a functional layer 1 with a bar coater. Thereafter, the coating film was heated at 70° C. for 1 minute to evaporate the solvent in the coating film, and the coating film was cured by irradiating ultraviolet rays with an ultraviolet ray irradiation device (light source H bulb from Fusion UV Systems Japan K.K) under the condition of an oxygen concentration of 200 ppm or less so that the integrated light amount was 40 mJ/cm² to form a hard coating layer with a thickness of 3 μm.

### (2) Formation of Second Functional Layer

A resin composition for a functional layer 2 was obtained by compounding each component so as to be the composition shown below.

### <Composition of Resin Composition for Functional Layer 2>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 70 parts by mass
Pentaerythritol acrylate (product name “A-TMM-3” from Shin-Nakamura Chemical Co., Ltd.): 30 parts by mass
High refractive index particles (zirconium oxide, average primary particle size 11 nm, from Nippon Shokubai Co., Ltd.): 100 parts by mass (solid content 100% conversion value)
Methyl isobutyl ketone: 230 parts by mass

Then, a coating film was formed on the hard coating layer by applying the resin composition for a functional layer 2 with a bar coater. Thereafter, the coating film was heated at 70° C. for 1 minute to evaporate the solvent in the coating film, and the coating film was cured by irradiating ultraviolet rays with an ultraviolet ray irradiation device (light source H bulb from Fusion UV Systems Japan K.K) under the condition of an oxygen concentration of 200 ppm or less so that the integrated light amount was 400 mJ/cm² to form a second functional layer with a thickness of 3 μm.

### (3) Formation of Functional Layer

The surface of the second functional layer was modified by plasma treatment for 180 seconds at an output of 200 W. Then, a functional layer with a thickness of 90 nm was formed on the surface modified second functional layer by forming a film of low refractive index inorganic material (silicon dioxide (silica)) by vacuum vapor deposition method using vacuum vapor deposition device (from ULVAC, Inc.).

### (4) Formation of Antifouling Layer

The surface of the functional layer was modified by plasma treatment for 60 seconds at an output of 200 W. Then, an antifouling layer with a thickness of 7 nm was formed on the surface modified functional layer by forming a film of a fluorine compound (product name “Optool UD120” from Daikin Industries) by vacuum vapor deposition method using vacuum vapor deposition device (from ULVAC, Inc.).

### Example 2

A stacked body was produced in the same manner as in Example 1 except that the second functional layer was formed using the following resin composition for a functional layer 3.

### <Composition of Resin Composition for Functional Layer 3>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 83 parts by mass
Pentaerythritol acrylate (product name “A-TMM-3” from Shin-Nakamura Chemical Co., Ltd.): 17 parts by mass
High refractive index particles (zirconium oxide, average primary particle size 11 nm, from Nippon Shokubai Co., Ltd.): 180 parts by mass (solid content 100% conversion value)
Methyl isobutyl ketone: 250 parts by mass

### Example 3

A stacked body was produced in the same manner as in Example 1 except that the second functional layer was formed using the following resin composition for a functional layer 4.

### <Composition of Resin Composition for Functional Layer 4>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 70 parts by mass
Pentaerythritol acrylate (product name “A-TMM-3” from Shin-Nakamura Chemical Co., Ltd.): 30 parts by mass
High refractive index particles (zirconium oxide, average primary particle size 11 nm, from Nippon Shokubai Co., Ltd.): 70 parts by mass (solid content 100% conversion value)
Methyl isobutyl ketone: 230 parts by mass

### Example 4

A stacked body was produced in the same manner as in Example 1 except that the second functional layer with a thickness of 70 nm was formed using the following resin composition for a functional layer 5.

### <Composition of Resin Composition for Functional Layer 5>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 70 parts by mass
Pentaerythritol acrylate (product name “A-TMM-3” from Shin-Nakamura Chemical Co., Ltd.): 30 parts by mass
High refractive index particles (zirconium oxide, average primary particle size 11 nm, from Nippon Shokubai Co., Ltd.): 100 parts by mass (solid content 100% conversion value)
Methyl isobutyl ketone: 320 parts by mass

### Example 5

A stacked body was produced in the same manner as in Example 1 except that, the thickness of the second functional layer was 1 μm.

### Example 6

A stacked body was produced in the same manner as in Example 1 except that, the thickness of the second functional layer was 10 μm.

### Example 7

A stacked body was produced in the same manner as in Example 1 except that, the thickness of the functional layer was 120 nm.

### Example 8

A stacked body was produced in the same manner as in Example 1 except that, the thickness of the functional layer was 60 nm.

### Example 9

A stacked body was produced in the same manner as in Example 1 except that a functional layer including a high refractive index film and a low refractive index film was formed as follows.

Firstly, the surface of the second functional layer was modified by plasma treatment for 180 seconds at an output of 200 W. Then, a high refractive index film with a thickness of 10 nm was formed on the surface modified second functional layer by forming a film of high refractive index inorganic material (zirconium oxide) by vacuum vapor deposition method using vacuum vapor deposition device (from ULVAC, Inc.).

Then, the surface of the high refractive index film was modified by plasma treatment for 120 seconds at an output of 200 W. Then, a low refractive index film with a thickness of 110 nm was formed on the surface modified high refractive index film by forming a film of low refractive index inorganic material (silicon dioxide (silica)) by vacuum vapor deposition method using vacuum vapor deposition device (from ULVAC, Inc.).

### Example 10

A stacked body was produced in the same manner as in Example 4 except that, the thickness of the second functional layer was 140 nm.

### Comparative Example 1

A stacked body was produced in the same manner as in Example 1 except that the second functional layer was formed using the following resin composition for a functional layer 6.

### <Composition of Resin Composition for Functional Layer 6>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 40 parts by mass
Pentaerythritol acrylate (product name “A-TMM-3” from Shin-Nakamura Chemical Co., Ltd.): 60 parts by mass
Low refractive index particles (hollow silica, average primary particle size 50 nm, from JGC Catalysts and Chemicals): 35 parts by mass (solid content 100% conversion value)
Methyl isobutyl ketone: 220 parts by mass

### Comparative Example 2

A stacked body was produced in the same manner as in Example 1 except that, in the formation of the second functional layer, the surface treatment condition was changed to the output of 100 W.

### Comparative Example 3

A stacked body was produced in the same manner as in Example 1 except that, in the formation of the second functional layer, the surface treatment condition was changed to the output of 400 W.

### Comparative Example 4

A stacked body was produced in the same manner as in Example 1 except that a functional layer including a high refractive index film and a low refractive index film was formed as follows.

Firstly, the surface of the second functional layer was modified by plasma treatment for 180 seconds at an output of 200 W. Then, a high refractive index film with a thickness of 80 nm was formed on the surface modified second functional layer by forming a film of high refractive index inorganic material (zirconium oxide) by vacuum vapor deposition method using vacuum vapor deposition device (from ULVAC, Inc.).

Then, the surface of the high refractive index film was modified by plasma treatment for 120 seconds at an output of 200 W. Then, a low refractive index film with a thickness of 90 nm was formed on the surface modified high refractive index film by forming a film of low refractive index inorganic material (silicon dioxide (silica)) by vacuum vapor deposition method using vacuum vapor deposition device (from ULVAC, Inc.).

### Comparative Example 5

A stacked body was produced in the same manner as in Example 1 except that, the thickness of the functional layer was 150 nm.

### Comparative Example 6

A stacked body was produced in the same manner as in Example 1 except that, the thickness of the functional layer was 40 nm.

### Comparative Example 7

A stacked body was produced in the same manner as in Example 1 except that second functional layer and a functional layer were formed as follows.

### (1) Formation of Second Functional Layer

A second functional layer was in the same manner as in Example 1 except that the following resin composition for a functional layer 7 was used.

### <Composition of Resin Composition for Functional Layer 7>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 70 parts by mass
Pentaerythritol acrylate (product name “A-TMM-3” from Shin-Nakamura Chemical Co., Ltd.): 30 parts by mass
High refractive index particles (titanium oxide, average primary particle size 5 nm, from Resino Color Industry Co., Ltd.): 270 parts by mass (solid content 100% conversion value)
Methyl isobutyl ketone: 250 parts by mass

### (2) Formation of Functional Layer

The surface of the second functional layer was modified by plasma treatment for 180 seconds at an output of 400 W. Then, a functional layer with a thickness of 90 nm was formed on the surface modified second functional layer by forming a film of low refractive index inorganic material (silicon dioxide (silica)) by vacuum vapor deposition method using vacuum vapor deposition device (from ULVAC, Inc.).

### Comparative Example 8

A stacked body was produced in the same manner as in Example 1 except that a second functional layer was formed and a functional layer including a high refractive index film and a low refractive index film was formed as follows.

### (1) Formation of Second Functional Layer

A second functional layer was formed in the same manner as in Example 1 except that the following resin composition for a functional layer 8 was used.

### <Composition of Resin Composition for Functional Layer 8>

Polymerization initiator (1-hydroxycyclohexylphenyl ketone, product name “Omnirad184” from IGM Resins B. V.): 3 parts by mass
Urethane acrylate (product name “EBECRYL8209” from Daicel-Allnex Ltd.): 100 parts by mass
Low refractive index particles (hollow silica, average primary particle size 50 nm, from JGC Catalysts and Chemicals): 40 parts by mass (solid content 100% conversion value)
Methyl isobutyl ketone: 220 parts by mass

### (2) Formation of Functional Layer

The surface of the second functional layer was modified by plasma treatment for 180 seconds at an output of 200 W. Then, a first high refractive index film with a thickness of 30 nm was formed on the surface modified second functional layer by forming a film of high refractive index inorganic material (zirconium oxide) by vacuum vapor deposition method using vacuum vapor deposition device (from ULVAC, Inc.).

Then, the surface of the first high refractive index film was modified by plasma treatment for 150 seconds at an output of 200 W. Then, a first low refractive index film with a thickness of 20 nm was formed on the surface modified first high refractive index film by forming a film of low refractive index inorganic material (silicon dioxide (silica)) by vacuum vapor deposition method using vacuum vapor deposition device (from ULVAC, Inc.).

Then, the surface of the first low refractive index film was modified by plasma treatment for 120 seconds at an output of 200 W. Then, a second high refractive index film with a thickness of 30 nm was formed on the surface modified first low refractive index film by forming a film of high refractive index inorganic material (zirconium oxide) by vacuum vapor deposition method using vacuum vapor deposition device (from ULVAC, Inc.).

Then, the surface of the second high refractive index film was modified by plasma treatment for 90 seconds at an output of 200 W. Then, a second low refractive index film with a thickness of 90 nm was formed on the surface modified second high refractive index film by forming a film of low refractive index inorganic material (silicon dioxide (silica)) by vacuum vapor deposition method using vacuum vapor deposition device (from ULVAC, Inc.).

### [Evaluation]

### (1) Luminous Reflectance

The luminous reflectance was determined according to JIS Z8722:2009. Tristimulus values X, Y and Z in the XYZ colorimetric system were determined from the reflected spectrum obtained when light, in a wavelength range of 380 nm or more and 780 nm or less, is incident on the functional layer side surface of the stacked body, in conditions of a viewing angle of 2 degrees, and standard light C, and the value of Y was regarded as the luminous reflectance. Using a spectrophotometer “UV-2600” from Shimadzu Corporation, the conditions in the luminous reflectance measurement were as follows. Incidentally, when measuring the luminous reflectance of the stacked body, black vinyl tape with a width larger than the measured spot area (product name “Yamato Vinyl Tape NO200-19-21” from Yamato Co. Ltd., 19 mm width) was adhered to the backside of the stacked body, before measuring, in order to prevent backside reflection.

### (Measurement Conditions)

Viewing angle: 2°
Illuminant: C
Light source: tungsten halogen lamp
Measurement wavelength: 0.5 nm interval in the range of 380 nm or more and 780 nm or less
Scan speed: fast
Slit width: 5.0 nm
S/R switch: standard
Auto Zero: carried out at 550 nm after baseline scan
   (2) Maximum Load at which Functional Layer is not Peeled Off when Steel Wool Test is Carried Out after Surface Modification

Firstly, using a corona discharge surface modification device “Corona Scanner ASA-4” from Shinko Electric & Instrumentation Co., Ltd., a stacked body was installed on the stage of the corona scanner with the antifouling layer side surface facing upward, and a corona discharge treatment was carried out on the entire surface of the antifouling layer side surface of the stacked body under the following conditions.
Output voltage: 14 kV
Distance from the antifouling layer side surface of the stacked body for a display device to the electrode of the corona discharge treatment device: 2 mm
Moving speed of the corona scanner stage: 30 mm/sec

Then, using a color fastness rubbing tester AB-301 from Tester Sangyo Co., Ltd., a stacked body having a size of 5 cm×10 cm was fixed on a glass plate with cellophane tape so that there is no bend or wrinkle. Then, using #0000 steel wool (Bonstar #0000 from Nippon Steel Wool Co., Ltd.), the steel wool was fixed to a 1 cm×1 cm jig, the antifouling layer side surface of the stacked body for a display device was rubbed for 100 strokes under conditions of load of 100 g/cm² or more, traveling speed of 100 mm/sec and traveling distance of 50 mm. Thereafter, the load was increased by 100 g/cm² from 100 g/cm² to determine the maximum load at which the functional layer was not peeled off.

### (3) Dynamic Bending Property

The following dynamic bending test was carried out to the stacked body to evaluate the bending resistance. Firstly, a stacked body having a size of 50 mm×200 mm was prepared. Then, as shown in FIG. 4A, short side portion 1C and short side portion 1D, opposing to the short side portion 1C, of the stacked body for a display device 1 (41) were respectively fixed by parallelly arranged fixing portions 51. Then, as shown in FIG. 4B, by moving the fixing portions 51 so as to be closer to each other, the stacked body for a display device 1 (41) was deformed so as to be folded. Further, as shown in FIG. 4C, after moving the fixing portions 51 to the position wherein distance “d” between the two opposing short side portions 1C and 1D of the stacked body for a display device 1 (41) fixed by the fixing portions 51 was a predetermined value, the deformation of the stacked body for a display device 1 (41) was dissolved by moving the fixing portions 51 in opposite directions. As shown in FIGS. 4A to 4C, by moving the fixing portions 51, the stacked body for a display device 1 was folded into 180° repeatedly. When doing so, the distance “d” between the two opposing short side portions 1C and 1D of the stacked body for a display device 1 (41) was 10 mm. Also, when the stacked body was folded so that the functional layer faced inward, it was regarded as an incurve, and when the stacked body was folded so that the functional layer faced outward, it was regarded as an outcurve. The results of the dynamic bending test were evaluated based on the following criteria.
A: no crack or fracture occurred in the stacked body even for 300,000 times
B: a crack or a fracture occurred in the stacked body up to 300,000 times

### (4) Visibility

After carrying out the dynamic bending test on the stacked body, the stacked body was adhered to the surface of the foldable display (“Think Pad X1 Fold” from Lenovo) so that the bent portion position and the bent direction of the stacked body, and the bent portion position and bent direction of the foldable display were aligned, and the functional layer side surface of the stacked body was on the surface, and the visibility was checked. In doing so, the angle θ2 of the foldable display 20 as shown in FIG. 12, for example, was set to 120°.

For the visibility of the first display region 22 of the foldable display 20 as shown in FIG. 12, for example, characters were displayed, and whether the characters were visible or not was checked.

Also, for the visibility of the bent portion 21 of the foldable display 20 as shown in FIG. 12, for example, an image was displayed, and whether there is an uncomfortable feeling or not, when observing the bent portion 21 and other regions, was checked.

The visibility was respectively evaluated according to the following criteria.

A: 10 out of 10 people were able to observe without any problem.

B: 7 or more and 9 or less out of 10 people were able to observe without any problem.

C: 4 or more and 6 or less out of 10 people were able to observe without any problem.

D: less than 4 out of 10 people were able to observe without any problem.

TABLE 2

| | Second functional layer | | | | | | | Luminous | | | | | Visi- | |
|---|---|---|---|---|---|---|---|---|---|---|---|---|---|---|
| | | | Surface | Functional layer | | | | reflectance (%) | | Maxi- | Dynamic | | bility | Visi- |
| | Refrac- | | treatment | Number | | Refrac- | | 5° | 60° | mum | bending property | | in first | bility |
| | tive | Thick- | (plasma | of | Mate- | tive | Thick- | reflec- | reflec- | load | In- | Out- | display | in bent |
| | index | ness | treatment) | layers | rial | index | ness | tion | tion | (kg/cm²) | curve | curve | region | portion |
| Exam- | 1.60 | 3 μm | Output: | 1 | SiO₂ | 1.47 | 90 nm | 2.3 | 8.1 | 1.6 | A | A | A | A |
| ple1 | | | 200 W, | | | | | | | | | | | |
| | | | 180 sec | | | | | | | | | | | |
| Exam- | 1.69 | 3 μm | Output: | 1 | SiO₂ | 1.47 | 90 nm | 1.6 | 7.5 | 1.4 | A | A | A | A |
| ple2 | | | 200 W, | | | | | | | | | | | |
| | | | 180 sec | | | | | | | | | | | |
| Exam- | 1.57 | 3 μm | Output: | 1 | SiO₂ | 1.47 | 90 nm | 2.7 | 8.9 | 1.7 | A | A | A | A |
| ple3 | | | 200 W, | | | | | | | | | | | |
| | | | 180 sec | | | | | | | | | | | |
| Exam- | 1.60 | 70 nm | Output: | 1 | SiO₂ | 1.47 | 90 nm | 2.8 | 9.1 | 1.2 | A | A | B | B |
| ple4 | | | 200 W, | | | | | | | | | | | |
| | | | 180 sec | | | | | | | | | | | |
| Exam- | 1.60 | 1 μm | Output: | 1 | SiO₂ | 1.47 | 90 nm | 2.4 | 8.6 | 1.7 | A | A | A | A |
| ple5 | | | 200 W, | | | | | | | | | | | |
| | | | 180 sec | | | | | | | | | | | |
| Exam- | 1.60 | 10 μm | Output: | 1 | SiO₂ | 1.47 | 90 nm | 2.4 | 8.5 | 1.1 | A | A | A | A |
| ple6 | | | 200 W, | | | | | | | | | | | |
| | | | 180 sec | | | | | | | | | | | |
| Exam- | 1.60 | 3 μm | Output: | 1 | SiO₂ | 1.47 | 120 nm | 2.9 | 8.7 | 1.3 | A | A | A | A |
| ple7 | | | 200 W, | | | | | | | | | | | |
| | | | 180 sec | | | | | | | | | | | |
| Exam- | 1.60 | 3 μm | Output: | 1 | SiO₂ | 1.47 | 60 nm | 2.2 | 7.9 | 1.7 | A | A | A | A |
| ple8 | | | 200 W, | | | | | | | | | | | |
| | | | 180 sec | | | | | | | | | | | |
| Exam- | 1.60 | 3 μm | Output: | 2 | ZrO₂/ | 2.00/ | 10 nm/ | 1.6 | 7.1 | 1.2 | A | A | A | A |
| ple9 | | | 200 W, | | SiO₂ | 1.47 | 110 nm | | | | | | | |
| | | | 180 sec | | | | | | | | | | | |
| Exam- | 1.60 | 140 nm | Output: | 1 | SiO₂ | 1.47 | 90 nm | 2.9 | 9.3 | 1.5 | A | A | B | B |
| ple10 | | | 200 W, | | | | | | | | | | | |
| | | | 180 sec | | | | | | | | | | | |
| Comp. | 1.50 | 3 μm | Output: | 1 | SiO₂ | 1.47 | 90 nm | 3.8 | 10.3 | 1.3 | A | A | C | C |
| Ex. 1 | | | 200 W, | | | | | | | | | | | |
| | | | 180 sec | | | | | | | | | | | |
| Comp. | 1.60 | 3 μm | Output: | 1 | SiO₂ | 1.47 | 90 nm | 2.3 | 8.2 | 0.7 | A | B | A | D |
| Ex. 2 | | | 100 W, | | | | | | | | | | | |
| | | | 180 sec | | | | | | | | | | | |
| Comp. | 1.60 | 3 μm | Output: | 1 | SiO₂ | 1.47 | 90 nm | 2.3 | 8.1 | 2.7 | A | B | A | D |
| Ex. 3 | | | 400 W, | | | | | | | | | | | |
| | | | 180 sec | | | | | | | | | | | |
| Comp. | 1.60 | 3 μm | Output: | 2 | ZrO₂/ | 2.00/ | 80 nm/ | 2.8 | 8.5 | 2.6 | A | B | A | D |
| Ex. 4 | | | 200 W, | | SiO₂ | 1.47 | 90 nm | | | | | | | |
| | | | 180 sec | | | | | | | | | | | |
| Comp. | 1.60 | 3 μm | Output: | 1 | SiO₂ | 1.47 | 150 nm | 1.7 | 7.4 | 2.4 | A | B | A | D |
| Ex. 5 | | | 200 W, | | | | | | | | | | | |
| | | | 180 sec | | | | | | | | | | | |
| Comp. | 1.60 | 3 μm | Output: | 1 | SiO₂ | 1.47 | 40 nm | 4.2 | 10.5 | 0.8 | A | B | C | D |
| Ex. 6 | | | 200 W, | | | | | | | | | | | |
| | | | 180 sec | | | | | | | | | | | |
| Comp. | 1.85 | 3 μm | Output: | 1 | SiO₂ | 1.47 | 90 nm | 0.8 | 7.1 | 0.9 | A | B | A | D |
| Ex. 7 | | | 400 W, | | | | | | | | | | | |
| | | | 180 sec | | | | | | | | | | | |
| Comp. | 1.50 | 3 μm | Output: | 4 | ZrO₂/ | 2.00/ | 30 nm/ | 0.6 | 7.8 | 2.5 | A | B | A | D |
| Ex. 8 | | | 200 W, | | SiO₂/ | 1.47/ | 20 nm/ | | | | | | | |
| | | | 180 sec | | ZrO₂/ | 2.00/ | 30 nm/ | | | | | | | |
| | | | | | SiO₂ | 1.47 | 90 nm | | | | | | | |

For the stacked body in Examples 1 to 10, since the luminous reflectance of regular reflection light, when the incident angle was 60° was the predetermined value or less, and the maximum load at which the functional layer was not peeled off, when a steel wool test was carried out, after surface modification, was in the predetermined range, the visibility of the first display region was excellent, and the visibility in the usage mode where an image was observed with the foldable display folded, was excellent, as well as the dynamic bending property was excellent, and the visibility in the bent portion was excellent.

Meanwhile, for the stacked body in Comparative Example 1, the luminous reflectance of regular reflection light, when the incident angle was 60°, was high, and the visibility of the first display region was poor. This is because the difference in the refractive index between the functional layer and the second functional layer was small, and the reflection suppression effect was low.

For the functional layer in Comparative Example 2, since the output of the surface treatment (plasma treatment) on the second functional layer was low, the close adhesiveness between the second functional layer and the functional layer was insufficient, so that the maximum load at which the functional layer was not peeled off when the steel wool test was carried out after the surface modification described above, was low, the dynamic bending property was inferior, and the visibility in the bent portion was poor.

For the stacked body in Comparative Example 3, since the output of the surface treatment (plasma treatment) on the second functional layer was high, the close adhesiveness between the second functional layer and the functional layer was excessive, so that the maximum load at which the functional layer was not peeled off when the steel wool test was carried out after the surface modification described above, was high, so that the dynamic bending property was inferior, and the visibility in the bent portion was poor.

For the stacked body in Comparative Example 4, the maximum load at which the functional layer was not peeled off when the steel wool test was carried out after the surface modification described above, was high, the dynamic bending property was inferior, and the visibility in the bent portion was poor.

This is because, although the functional layer was constituted with two layers, the overall thickness of the functional layer was thick, so that the close adhesiveness of the functional layer was excessive and was inferior in bending property.

For the stacked body in Comparative Example 5, the maximum load at which the functional layer was not peeled off when the steel wool test was carried out after the surface modification described above, was high, the dynamic bending property was inferior, and the visibility in the bent portion was poor.

This is because, since the thickness of the functional layer was thick, the close adhesiveness of the functional layer was excessive and was inferior in bending property.

For the stacked body in Comparative Example 6, the luminous reflectance of regular reflection light, when the incident angle was 60°, was high, and the visibility of the first display region was inferior. This is because the thickness of the functional layer was thin, and the reflection suppression effect was low. Also, for the stacked body in Comparative Example 6, the maximum load at which the functional layer was not peeled off when the steel wool test was carried out after the surface modification described above, was low, the dynamic bending property was inferior, and the visibility in the bent portion was poor. This is because, since the thickness of the functional layer was thin, the hardness of the functional layer was low, and the close adhesiveness of the functional layer was insufficient.

For the stacked body in Comparative Example 7, although the output of the surface treatment (plasma treatment) on the second functional layer was high, since the content of the inorganic particles in the second functional layer was high, the close adhesiveness of functional layer was insufficient, so that the maximum load at which the functional layer was not peeled off when the steel wool test was carried out after the surface modification described above, was low, the dynamic bending property was inferior, and the visibility in the bent portion was poor.

For the stacked body in Comparative Example 8, the maximum load at which the functional layer was not peeled off when the steel wool test was carried out after the surface modification described above, was high, the dynamic bending property was inferior, and the visibility in the bent portion was poor.

This is because, since the functional layer was constituted with many layers, the overall thickness of the functional layer was thick, so that the close adhesiveness of the functional layer was excessive and was inferior in bending property.

### REFERENCE SIGNS LIST

1, 41: stacked body for a display device
2, 42: substrate layer
3: first layer
4: second layer
5, 45: hard coating layer
6, 46: impact absorbing layer
7, 47: adhesive layer for adhesion
8, 48: antifouling layer
30: display device
31: display panel
43: functional layer
44: second functional layer

1. A stacked body for a display device comprising a substrate layer, a first layer, and a second layer, in this order;
wherein a luminous reflectance of regular reflection light, when light is entered to a second layer side surface of the stacked body for a display device with incident angle of 60°, is 10.0% or less; and
an absolute value of a difference, between yellowness YI1 of transmitted light in 60° direction with respect to a normal line to the second layer side surface of the stacked body for a display device and yellowness YI2 of transmitted light in 15° direction with respect to a normal line to the second layer side surface of the stacked body for a display device, is 3.0 or less.

2. The stacked body for a display device according to claim 1, wherein a thickness of the second layer is 1 μm or more and 10 μm or less; and a refractive index of the second layer is 1.40 or more and 1.50 or less.

3. The stacked body for a display device according to claim 1, wherein a thickness of the second layer is 50 nm or more and 1 μm or less; and a ratio of a refractive index of the first layer with respect to a refractive index of the second layer is 1.05 or more and 1.20 or less.

4. The stacked body for a display device according to any one of claims 1 to 3, wherein the substrate layer doubles as the first layer.

5. The stacked body for a display device according to any one of claims 1 to 4, wherein a hard coating layer is included between the substrate layer and the first layer.

6. The stacked body for a display device according to any one of claims 1 to 5, wherein an impact absorbing layer is included on the substrate layer, on an opposite surface side to the first layer, or between the substrate layer and the first layer.

7. The stacked body for a display device according to any one of claims 1 to 6, wherein an adhesive layer for adhesion is included on the substrate layer, on an opposite surface side to the first layer.

8. The stacked body for a display device according to any one of claims 1 to 7, wherein an antifouling layer is included on the second layer, on an opposite surface side to the first layer.

9. A stacked body for a display device comprising a substrate layer; and a functional layer,
wherein a luminous reflectance of regular reflection light, when light is entered to a functional layer side surface of the stacked body for a display device with incident angle of 60°, is 10.0% or less; and
after a surface modification of a functional layer side surface of the stacked body for a display device, a maximum load at which the functional layer is not peeled off, when a steel wool test is carried out, is 1.0 kg/cm² or more and 2.0 kg/cm² or less, wherein, in the steel wool test, the functional layer side surface of the stacked body for a display device is rubbed with a #0000 steel wool, for 100 strokes, applying a predetermined load.

10. The stacked body for a display device according to claim 9, wherein the functional layer is an inorganic film.

11. The stacked body for a display device according to claim 10, wherein the inorganic film includes silicon dioxide.

12. The stacked body for a display device according to any one of claims 9 to 11, wherein a thickness of the functional layer is 50 nm or more and 140 nm or less.

13. The stacked body for a display device according to any one of claims 9 to 12, wherein a refractive index of the functional layer is 1.40 or more and 1.50 or less.

14. The stacked body for a display device according to any one of claims 9 to 13, wherein a second functional layer is included between the substrate layer and the functional layer; and the second functional layer includes resin and an inorganic particle.

15. The stacked body for a display device according to claim 14, wherein a thickness of the second functional layer is 50 nm or more and 10 μm or less.

16. The stacked body for a display device according to claim 14 or 15, wherein a refractive index of the second functional layer is 1.55 or more and 2.00 or less.

17. The stacked body for a display device according to any one of claims 9 to 16, wherein a hard coating layer is included between the substrate layer and the functional layer.

18. The stacked body for a display device according to any one of claims 9 to 17, wherein an impact absorbing layer is included on the substrate layer, on an opposite surface side to the functional layer.

19. The stacked body for a display device according to any one of claims 9 to 18, wherein an adhesive layer for adhesion is included on the substrate layer, on an opposite surface side to the functional layer.

20. The stacked body for a display device according to any one of claims 9 to 19, wherein an antifouling layer is included on the functional layer, on an opposite surface side to the substrate layer.

21. A display device comprising:
a display panel, and
the stacked body for a display device according to any one of claims 1 to 20 placed on an observer side of the display panel.
